(19) United States
(12) Patent Application Publication
(10) Pub. No.: US 2026/0072954 A1
(43) Pub. Date: Mar. 12, 2026

(54) USER INTERFACES AND TECHNIQUES FOR INTERACTIONS

(71) Applicant: Apple Inc., Cupertino, CA (US)

(72) Inventors: Agatha Y. YU, Oakland, CA (US); Anthony D'AURIA, San Francisco, CA (US); Hans C. LEE, San Martin, CA (US); Jamie L. MYROLD, Chicago, IL (US); Ji Chen Jason YUAN, Cupertino, CA (US); Shmuel SEGAL, Castro Valley, CA (US); Stephen B. LYNCH, Portola Valley, CA (US); Tuhin KUMAR, San Francisco, CA (US); Victor C. HWANG, San Francisco, CA (US)

(21) Appl. No.: 19/387,303

(22) Filed: Nov. 12, 2025

Related U.S. Application Data
(63) Continuation of application No. PCT/US2024/048440, filed on Sep. 25, 2024.
(60) Provisional application No. 63/541,843, filed on Sep. 30, 2023.
(60) Provisional application No. 63/541,827, filed on Sep. 30, 2023.
(60) Provisional application No. 63/541,829, filed on Sep. 30, 2023.

(51) Int. Cl. G06F 16/3329; G06F 16/34; H04L 51/02

(52) U.S. Cl. CPC G06F 16/3329; G06F 16/345; H04L 51/02

(57) ABSTRACT

The present disclosure generally relates to user interfaces.

### CROSS-REFERENCE TO RELATED APPLICATIONS

This application is a continuation of International Patent Application Serial No. PCT/US2024/048440, entitled “USER INTERFACES AND TECHNIQUES FOR INTERACTIONS,” filed Sep. 25, 2024, which claims priority to U.S. Provisional Patent Application Ser. No. 63/541,843, filed Sep. 30, 2023, to U.S. Provisional Patent Application Ser. No. 63/541,827, filed Sep. 30, 2023, and to U.S. Provisional Patent Application Ser. No. 63/541,829, filed Sep. 30, 2023. The content of these applications are hereby incorporated by reference in their entirety.

### BACKGROUND

Computer systems are often used during interactions. Such interactions include lectures, conversations, and meetings. Users often use computer systems to control user interfaces. Such controls of user interfaces include interactive content. Computer systems often display multiple media objects simultaneously. Each displayed media object occupies a portion of a user interface and therefore can interfere with another displayed media object.

### SUMMARY

Existing techniques for controlling a computer system based on interactions using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods and interfaces for controlling a computer system based on interactions and for displaying an overlay. Such methods and interfaces optionally complement or replace other methods for controlling a computer system based on interactions and for displaying an overlay. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for controlling a computer system based on interactions.

In some embodiments, a method that is performed at a computer system that is in communication with a movement component is described. In some embodiments, the method comprises: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a non-transitory computer-readable storage medium storing one or more programs configured to be executed by one or more processors of a computer system that is in communication with a movement component is described. In some embodiments, the one or more programs includes instructions for: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a transitory computer-readable storage medium storing one or more programs configured to be executed by one or more processors of a computer system that is in communication with a movement component is described. In some embodiments, the one or more programs includes instructions for: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a computer system that is in communication with a movement component is described. In some embodiments, the computer system that is in communication with a movement component comprises one or more processors and memory storing one or more programs configured to be executed by the one or more processors. In some embodiments, the one or more programs includes instructions for: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a computer system that is in communication with a movement component is described. In some embodiments, the computer system that is in communication with a movement component comprises means for performing each of the following steps: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a computer program product is described. In some embodiments, the computer program product comprises one or more programs configured to be executed by one or more processors of a computer system that is in communication with a movement component. In some embodiments, the one or more programs include instructions for: while the computer system, via the movement component, is in a first position in an environment, detecting an occurrence of a first interaction; and in response to detecting the first interaction: in accordance with a determination that the first interaction is a first type of interaction, moving, via the movement component, to a second position in the environment different from the first position in the environment; and in accordance with a determination that the first interaction is a second type of interaction different from the first type of interaction, forgoing moving, via the movement component, to the second position.

In some embodiments, a method that is performed at a computer system that is in communication with a display component and a microphone is described. In some embodiments, the method comprises: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a non-transitory computer-readable storage medium storing one or more programs configured to be executed by one or more processors of a computer system that is in communication with a display component and a microphone is described. In some embodiments, the one or more programs includes instructions for: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a transitory computer-readable storage medium storing one or more programs configured to be executed by one or more processors of a computer system that is in communication with a display component and a microphone is described. In some embodiments, the one or more programs includes instructions for: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a computer system that is in communication with a display component and a microphone is described. In some embodiments, the computer system that is in communication with a display component and a microphone comprises one or more processors and memory storing one or more programs configured to be executed by the one or more processors. In some embodiments, the one or more programs includes instructions for: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a computer system that is in communication with a display component and a microphone is described. In some embodiments, the computer system that is in communication with a display component and a microphone comprises means for performing each of the following steps: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a computer program product is described. In some embodiments, the computer program product comprises one or more programs configured to be executed by one or more processors of a computer system that is in communication with a display component and a microphone. In some embodiments, the one or more programs include instructions for: while displaying, via the display component, a user interface, detecting, via the microphone, first voice input; in response to detecting the first voice input, displaying, via the display component, a first set of one or more words corresponding to the first voice input in a first manner; while displaying the first set of one or more words corresponding to the first voice input, detecting, via the microphone, a second voice input; and in response to detecting the second voice input: in accordance with a determination that the second voice input includes a new word and that the new word corresponding to the second voice input should be added to the first set of one or more words, displaying, via the display component, the new word corresponding to the second voice input with display of the first set of one or more words in the first manner; and in accordance with a determination that the second voice input includes the new word corresponding to the second voice input and that the new word corresponding to the second voice input should not be added to the first set of one or more words, displaying, via the display component, a second set of one or more words that includes the new word corresponding to the second voice input in the first manner while ceasing to display the first set of one or more words in the first manner, wherein the second set of one or more words is different from the first set of one or more words.

In some embodiments, a method that is performed at a computer system that is in communication with a display component and one or more input devices is described. In some embodiments, the method comprises: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a non-transitory computer-readable storage medium storing one or more programs configured to be executed by one or more processors of a computer system that is in communication with a display component and one or more input devices is described. In some embodiments, the one or more programs includes instructions for: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a transitory computer-readable storage medium storing one or more programs configured to be executed by one or more processors of a computer system that is in communication with a display component and one or more input devices is described. In some embodiments, the one or more programs includes instructions for: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a computer system that is in communication with a display component and one or more input devices is described. In some embodiments, the computer system that is in communication with a display component and one or more input devices comprises means for performing each of the following steps: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: detecting, via the one or more input devices, an input corresponding to a user; and in conjunction with detecting the input corresponding to the user, displaying, via the display component, a representation of a first portion of content related to the input and a representation of a second portion of content related to the input, including: in accordance with a determination that the first portion of content is in a first category of content and the second portion of content is in the first category of content, visually grouping the representation of the first portion of content and the representation of the second portion of content; and in accordance with a determination that the first portion of content is in the first category of content and the second portion of content is in a second category of content different from the first category of content, forgoing visually grouping the representation of the first portion of content and the representation of the second portion of content.

In some embodiments, a method that is performed at a computer system that is in communication with a display component and one or more input devices is described. In some embodiments, the method comprises: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a non-transitory computer-readable storage medium storing one or more programs configured to be executed by one or more processors of a computer system that is in communication with a display component and one or more input devices is described. In some embodiments, the one or more programs includes instructions for: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a transitory computer-readable storage medium storing one or more programs configured to be executed by one or more processors of a computer system that is in communication with a display component and one or more input devices is described. In some embodiments, the one or more programs includes instructions for: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a computer system that is in communication with a display component and one or more input devices is described. In some embodiments, the computer system that is in communication with a display component and one or more input devices comprises means for performing each of the following steps: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: detecting, via the one or more input devices, a request corresponding to a previous interaction; and in response to detecting the request corresponding to the previous interaction, displaying, via the display component, a user interface that includes: a first representation of a first application corresponding to the previous interaction; a first representation of a first response to the request, wherein the first response is from the previous interaction; and a second representation of a second response to the request, wherein the second response is from the previous interaction, and wherein the first representation of the first response is different from the second representation of the second response.

In some embodiments, a method that is performed at a computer system that is in communication with a display component is described. In some embodiments, the method comprises: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a non-transitory computer-readable storage medium storing one or more programs configured to be executed by one or more processors of a computer system that is in communication with a display component is described. In some embodiments, the one or more programs includes instructions for: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a transitory computer-readable storage medium storing one or more programs configured to be executed by one or more processors of a computer system that is in communication with a display component is described. In some embodiments, the one or more programs includes instructions for: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a computer system that is in communication with a display component is described. In some embodiments, the computer system that is in communication with a display component comprises one or more processors and memory storing one or more programs configured to be executed by the one or more processors. In some embodiments, the one or more programs includes instructions for: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a computer system that is in communication with a display component is described. In some embodiments, the computer system that is in communication with a display component comprises means for performing each of the following steps: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a computer program product is described. In some embodiments, the computer program product comprises one or more programs configured to be executed by one or more processors of a computer system that is in communication with a display component. In some embodiments, the one or more programs include instructions for: detecting a first request corresponding to a previous interaction to the previous interaction; and in response to detecting the request corresponding to the previous interaction: in accordance with a determination that the request does not correspond to new content, displaying, via the display component, a first summary of the previous interaction that includes a first set of one or more representations corresponding to the previous interaction in a first orientation relative to a second set of one or more representations corresponding to the previous interaction; and in accordance with a determination that the request includes new content, displaying, via the display component, a second summary of the previous interaction that includes the first set of one or more representations corresponding to the previous interaction in a second orientation relative to the second set of one or more representations, wherein the second orientation is different from the first orientation.

In some embodiments, a method that is performed at a computer system that is in communication with one or more output devices including a display component and one or more input devices is described. In some embodiments, the method comprises: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a non-transitory computer-readable storage medium storing one or more programs configured to be executed by one or more processors of a computer system that is in communication with one or more output devices including a display component and one or more input devices is described. In some embodiments, the one or more programs includes instructions for: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a transitory computer-readable storage medium storing one or more programs configured to be executed by one or more processors of a computer system that is in communication with one or more output devices including a display component and one or more input devices is described. In some embodiments, the one or more programs includes instructions for: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a computer system that is in communication with one or more output devices including a display component and one or more input devices is described. In some embodiments, the computer system that is in communication with one or more output devices including a display component and one or more input devices comprises one or more processors and memory storing one or more programs configured to be executed by the one or more processors. In some embodiments, the one or more programs includes instructions for: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a computer system that is in communication with one or more output devices including a display component and one or more input devices is described. In some embodiments, the computer system that is in communication with one or more output devices including a display component and one or more input devices comprises means for performing each of the following steps: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a computer program product is described. In some embodiments, the computer program product comprises one or more programs configured to be executed by one or more processors of a computer system that is in communication with one or more output devices including a display component and one or more input devices. In some embodiments, the one or more programs include instructions for: displaying, via the display component, visual content that includes a first group of one or more items, a second group of one or more items different from the first group of items, and an avatar closer to the first group of items than the second group of items; while displaying the visual content that includes the first group of items, the second group of items, and the avatar closer to the first group of items than the second group of items, outputting, via the one or more output devices, content corresponding to the first group of items; while outputting the content corresponding to the first group of items and displaying the avatar closer to the first group of items than the second group of items, detecting that content corresponding to the second group of items will be output; and in response to detecting that content corresponding to the second group of items will be output, displaying, via the display component, the avatar positioned closer to the second group of items than the first group of items.

In some embodiments, a method that is performed at a computer system that is in communication with a display component and one or more input devices is described. In some embodiments, the method comprises: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a non-transitory computer-readable storage medium storing one or more programs configured to be executed by one or more processors of a computer system that is in communication with a display component and one or more input devices is described. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a transitory computer-readable storage medium storing one or more programs configured to be executed by one or more processors of a computer system that is in communication with a display component and one or more input devices is described. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer system that is in communication with a display component and one or more input devices is described. In some embodiments, the computer system that is in communication with a display component and one or more input devices comprises means for performing each of the following steps: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: while displaying, via the display component, a first user interface object, detecting, via the one or more input devices, an input corresponding to subject matter; and in response to detecting the input corresponding to the subject matter: in accordance with a determination that a respective portion of the input is associated with a level of confidence corresponding to the input that is below a threshold, forgoing increasing the size of the first user interface object; and in accordance with a determination that the respective portion of the input is associated with a level of confidence corresponding to the input that is above the threshold, increasing the size of the first user interface object.

In some embodiments, a method that is performed at a computer system that is in communication with a display component and one or more input devices is described. In some embodiments, the method comprises: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a non-transitory computer-readable storage medium storing one or more programs configured to be executed by one or more processors of a computer system that is in communication with a display component and one or more input devices is described. In some embodiments, the one or more programs includes instructions for: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a transitory computer-readable storage medium storing one or more programs configured to be executed by one or more processors of a computer system that is in communication with a display component and one or more input devices is described. In some embodiments, the one or more programs includes instructions for: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a computer system that is in communication with a display component and one or more input devices is described. In some embodiments, the computer system that is in communication with a display component and one or more input devices comprises one or more processors and memory storing one or more programs configured to be executed by the one or more processors. In some embodiments, the one or more programs includes instructions for: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a computer system that is in communication with a display component and one or more input devices is described. In some embodiments, the computer system that is in communication with a display component and one or more input devices comprises means for performing each of the following steps: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a computer program product is described. In some embodiments, the computer program product comprises one or more programs configured to be executed by one or more processors of a computer system that is in communication with a display component and one or more input devices. In some embodiments, the one or more programs include instructions for: detecting, via the one or more input devices, a request to display an animation; in response to detecting the request to display the animation, initiating, via the display component, playback of the animation; while playing back the animation and displaying, via the display component, an overlay at a first location, detecting that an object in the animation will be displayed within a distance of the first location while displaying a first frame of the animation; and in response to detecting that the object in the animation will be displayed within the distance of the first location while displaying the first frame of the animation, displaying, via the display component, the overlay at a second location different from the first location, wherein the second location was selected after initiating playback of the animation.

In some embodiments, a method that is performed at a computer system that is in communication with one or more input devices and one or more output devices is described. In some embodiments, the method comprises: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

In some embodiments, a computer system that is in communication with one or more input devices and one or more output devices is described. In some embodiments, the computer system that is in communication with a display component and one or more input devices comprises one or more processors and memory storing one or more programs configured to be executed by the one or more processors. In some embodiments, the one or more programs includes instructions for: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

In some embodiments, a computer system that is in communication with one or more input devices and one or more output devices is described. In some embodiments, the computer system that is in communication with a display component and one or more input devices comprises means for performing each of the following steps: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an input corresponding to a request to review one or more previous interactions with an agent; and in response to detecting the input corresponding to the request to review one or more previous interactions with the agent: in accordance with a determination that a first set of one or more criteria is satisfied, outputting, via the one or more output devices, a first representation of a first previous interaction with the agent; and in accordance with a determination that a second set of one or more criteria is satisfied, forgoing outputting, via the one or more output devices, the first representation of the first previous interaction with the agent.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of electronic device 200 in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6D illustrate exemplary user interfaces for participating in an interaction in accordance with some embodiments.

FIG. 7 is a flow diagram illustrating methods for moving positions in accordance with some embodiments.

FIG. 8 is a flow diagram illustrating methods for displaying content in accordance with some embodiments.

FIGS. 9A-9J illustrate exemplary user interfaces for controlling user interfaces in accordance with some embodiments.

FIG. 10 is a flow diagram illustrating methods for grouping content in accordance with some embodiments.

FIG. 11 is a flow diagram illustrating methods for displaying a response in response to a request corresponding to a previous interaction in accordance with some embodiments.

FIG. 12 is a flow diagram illustrating methods for displaying a summary of previous interactions in accordance with some embodiments.

FIG. 13 is a flow diagram illustrating methods for increasing the size of an object in accordance with some embodiments.

FIG. 14 is a flow diagram illustrating methods for displaying an avatar closer to a group of items in accordance with some embodiments.

FIGS. 15A-15D illustrate exemplary user interfaces for displaying an overlay in accordance with some embodiments.

FIG. 16 is a flow diagram illustrating methods for displaying an overlay in accordance with some embodiments.

### DETAILED DESCRIPTION

The description to follow sets forth exemplary methods, components, parameters, and the like. While specific examples are set out below, it should be recognized that such examples should not be understood as limiting the scope of the present disclosure to the explicit descriptions of the examples set forth herein but instead should be understood as providing illustrative examples.

Each of the identified modules and applications herein corresponds to a set of executable instructions for performing one or more functions described above and the methods described in this application (e.g., the computer-implemented methods and other information processing methods described herein). These modules (e.g., sets of instructions) optionally need not be implemented as separate software programs (such as computer programs (e.g., including instructions)), procedures, or modules, and thus various subsets of these modules are, optionally, combined or otherwise rearranged in various embodiments. For example, a video player module is, optionally, combined with a music player module into a single module. In some embodiments, memory optionally stores a subset of the modules and data structures identified above. Furthermore, memory optionally stores additional modules and data structures not described above.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device interfaces more efficient (e.g., by helping the user to provide proper inputs and reducing user mistakes when operating/interacting with the device) through various techniques, including by providing improved feedback (e.g., visual, haptic, audible, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

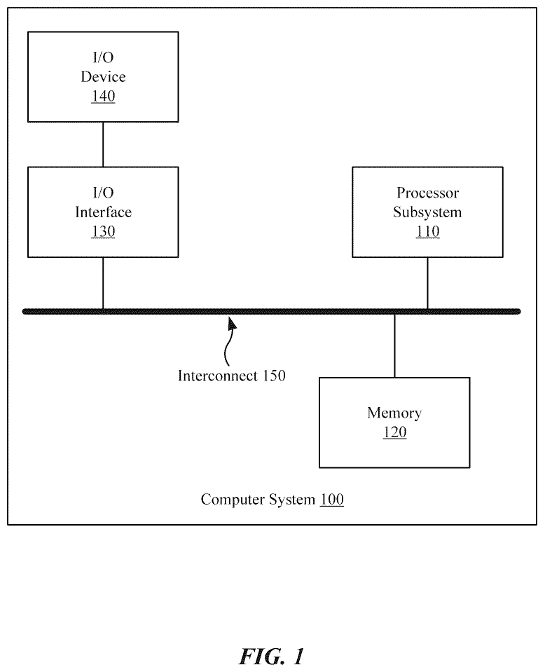

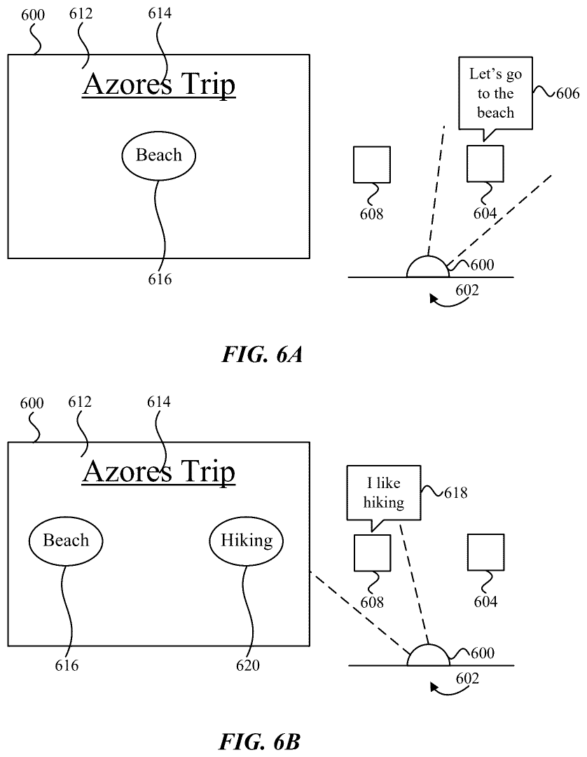

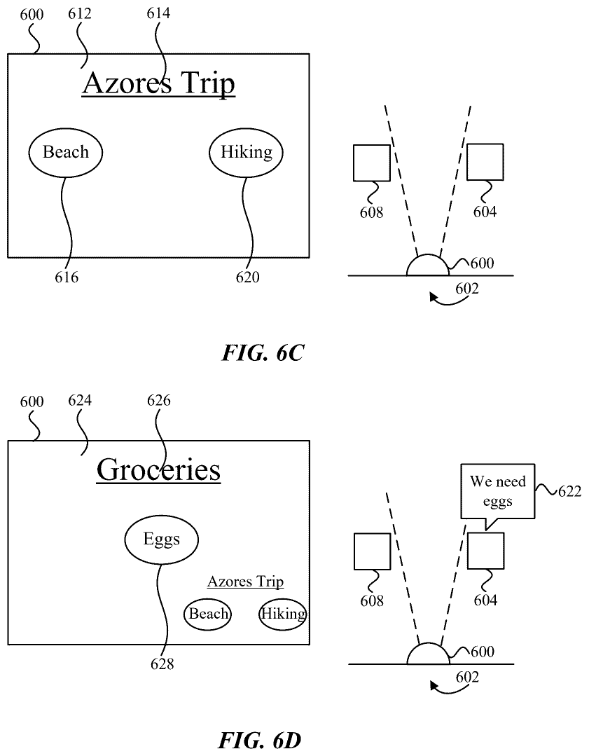

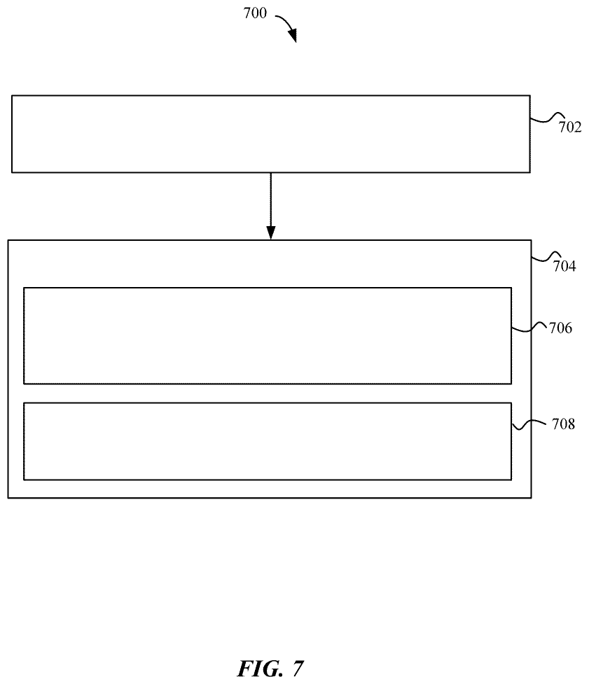

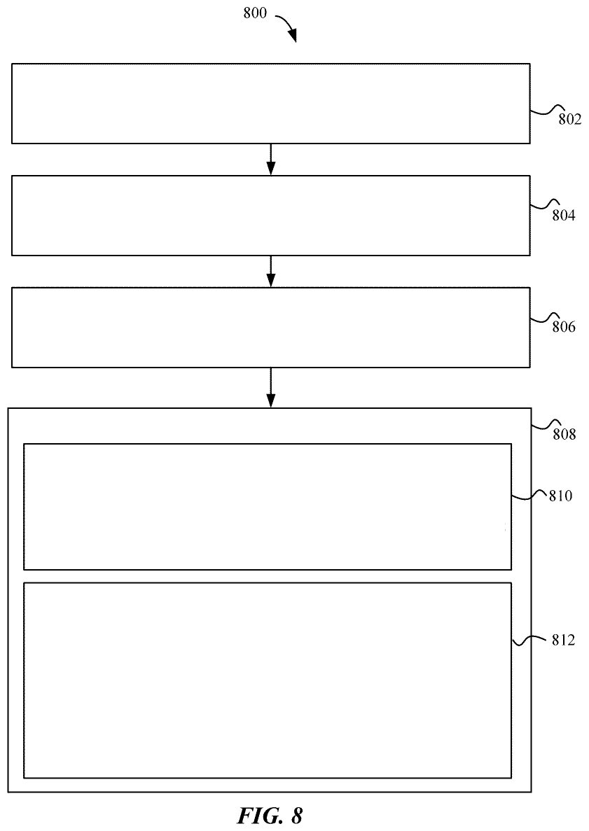

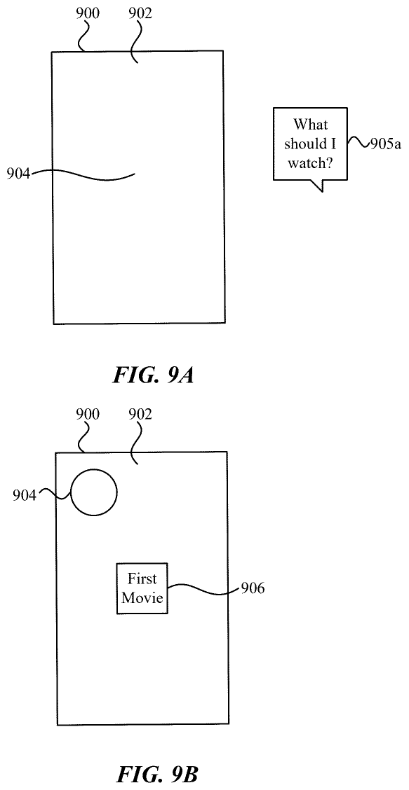

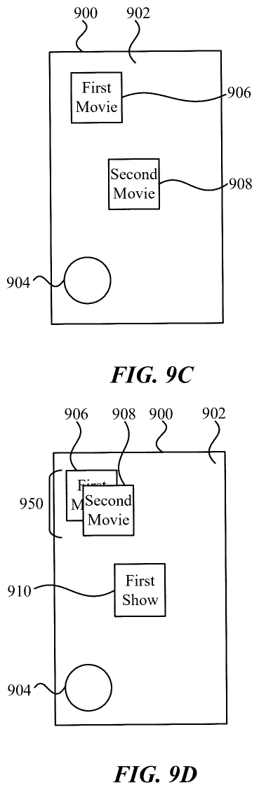

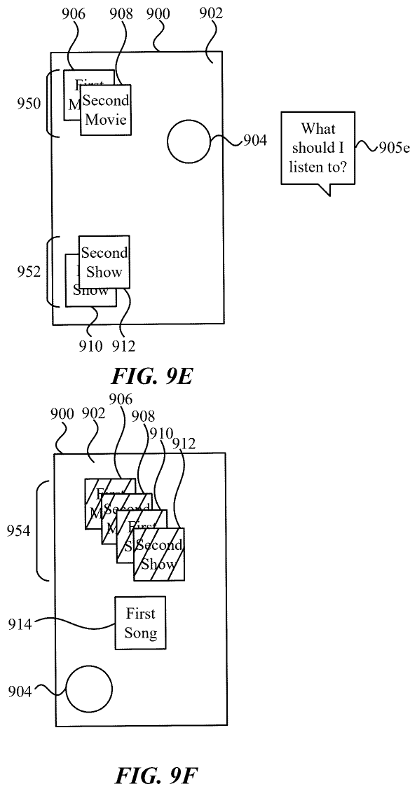

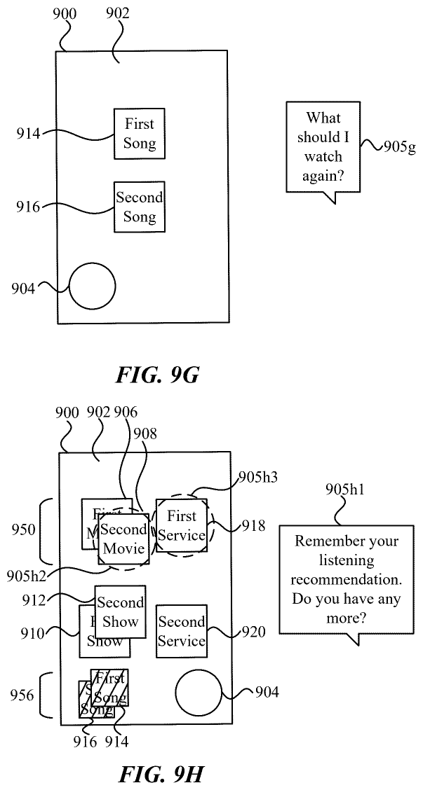

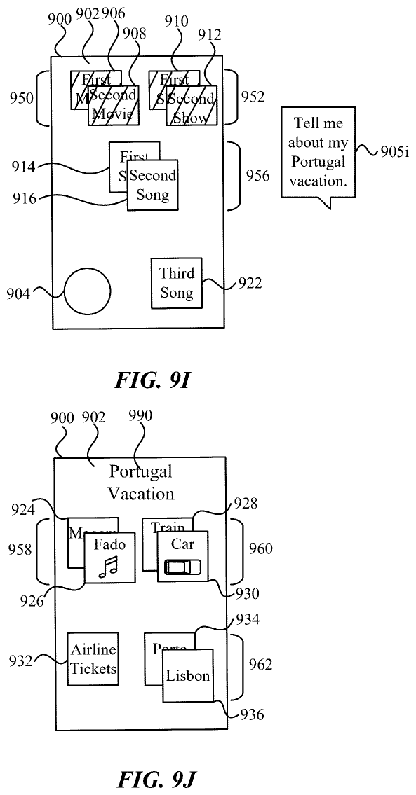

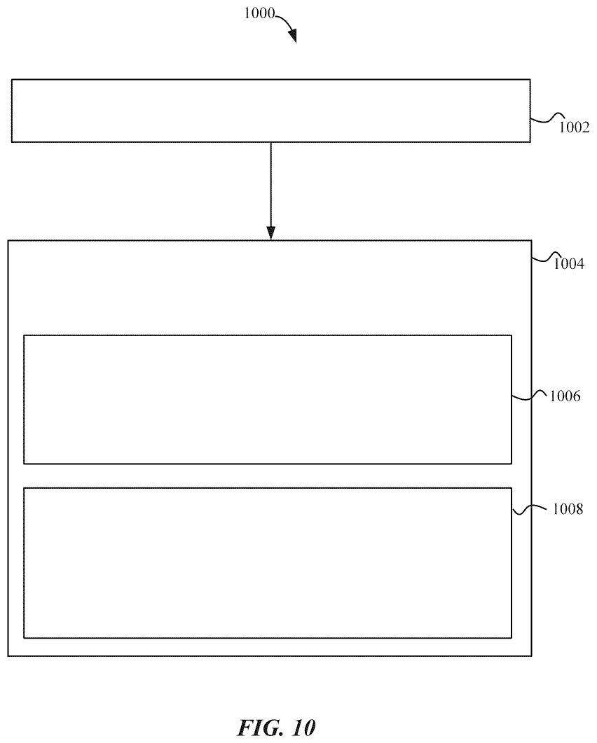

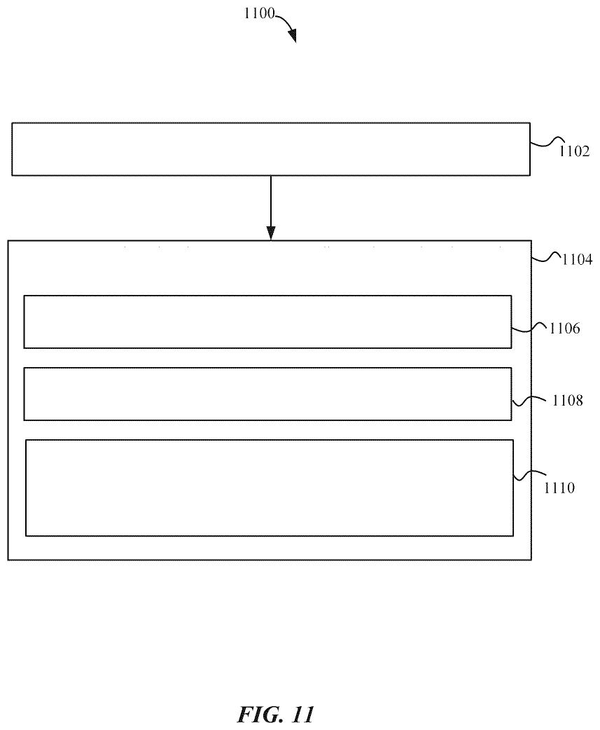

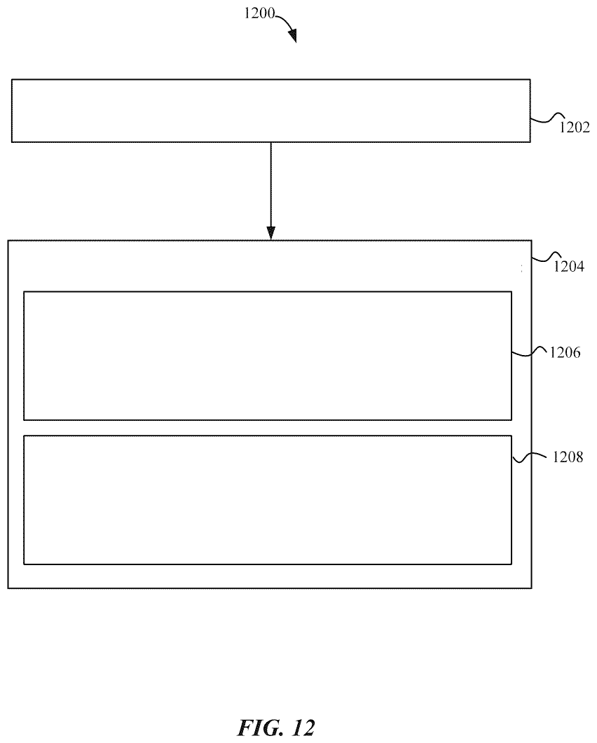

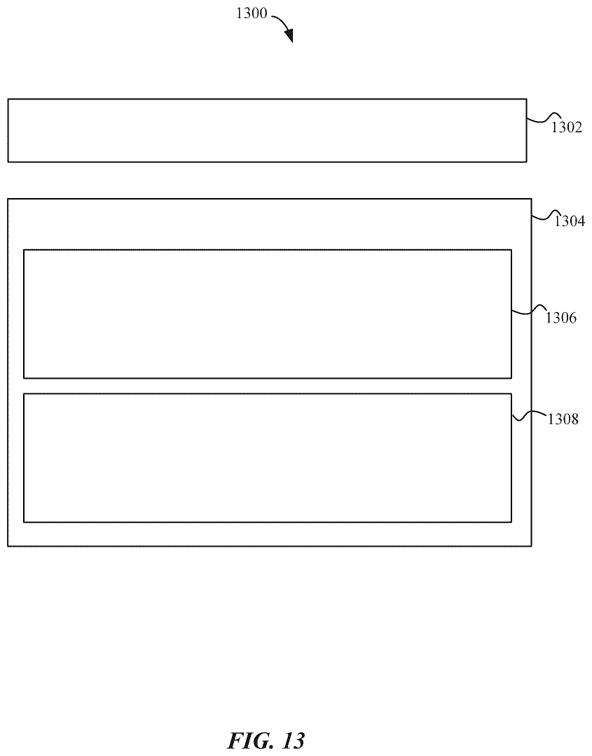

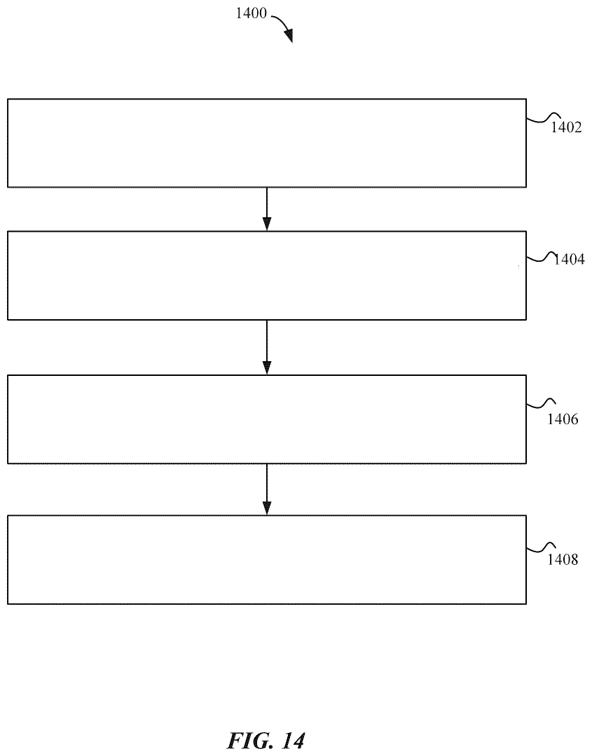

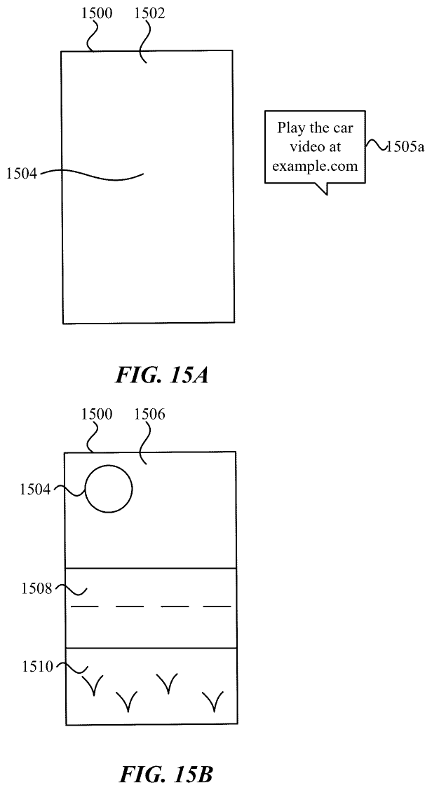

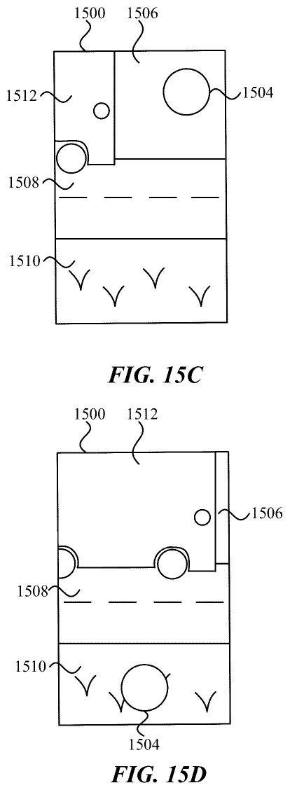

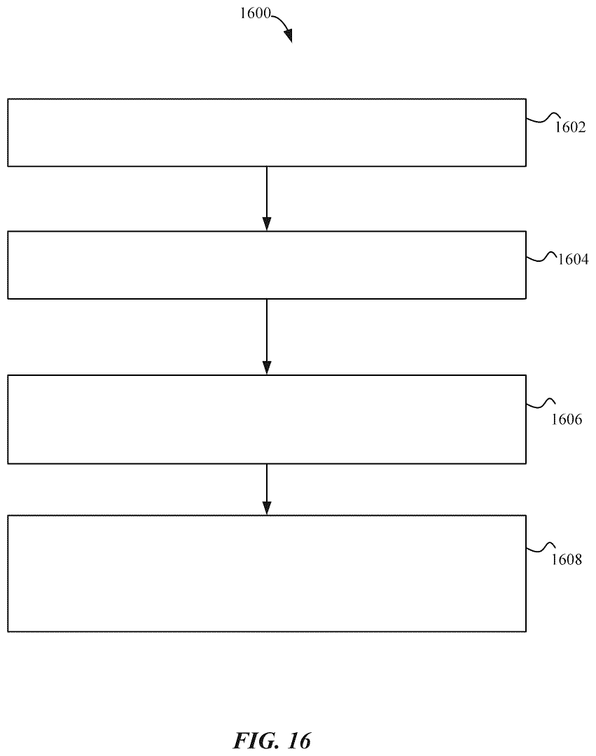

Below, FIGS. 1, 2A-2C, and 3-5 provide a description of exemplary devices for performing the techniques described herein. FIGS. 6A-6D illustrate exemplary user interfaces for participating in an interaction in accordance with some embodiments. FIG. 7 is a flow diagram illustrating methods for moving positions in accordance with some embodiments. FIG. 8 is a flow diagram illustrating methods for displaying content in accordance with some embodiments. The user interfaces in FIGS. 6A-6D are used to illustrate the processes described below, including the processes in FIGS. 7 and 8. FIGS. 9A-9J illustrate exemplary user interfaces for controlling user interfaces in accordance with some embodiments. FIG. 10 is a flow diagram illustrating methods for grouping content in accordance with some embodiments. FIG. 11 is a flow diagram illustrating methods for displaying a response in response to a request corresponding to a previous interaction in accordance with some embodiments. FIG. 12 is a flow diagram illustrating methods for displaying a summary of previous interactions in accordance with some embodiments. FIG. 13 is a flow diagram illustrating methods for increasing the size of an object in accordance with some embodiments. FIG. 14 is a flow diagram illustrating methods for displaying an avatar closer to a group of items in accordance with some embodiments. The user interfaces in FIGS. 9A-9J are used to illustrate the processes described below, including the processes in FIGS. 10, 11, 12, 13, and 14. FIGS. 15A-15D illustrate exemplary user interfaces for displaying an overlay in accordance with some embodiments. FIG. 16 is a flow diagram illustrating methods for displaying an overlay in accordance with some embodiments. The user interfaces in FIGS. 15A-15D are used to illustrate the processes described below, including the processes in FIG. 16.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application-level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with the methods described below including 700 and 800 (FIGS. 7 and 8).

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (e.g., a user, a person, an animal, another computer system different from the computer system, and/or an object) and/or an input (e.g., a tap input and/or a non-tap input (e.g., a verbal input, an audible request, an audible command, an audible statement, a swipe input, a hold-and-drag input, a gaze input, an air gesture, and/or a mouse click)) from a detected user. In some embodiments, I/O device 140 enables computer system 100 to identify users associated with and/or without an account within an environment. In some embodiments, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

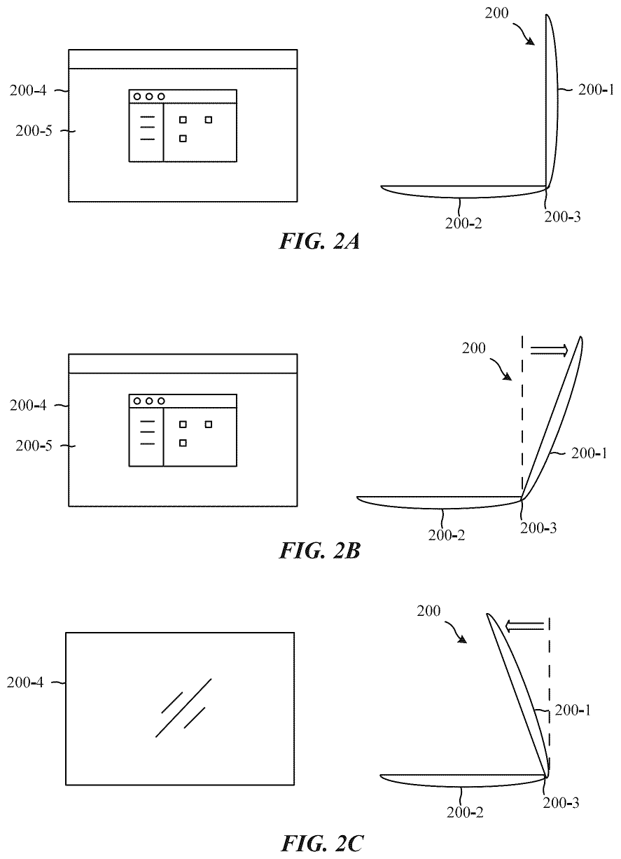

FIGS. 2-5 illustrate exemplary components and user interfaces of electronic device 200 in accordance with some embodiments. Electronic device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

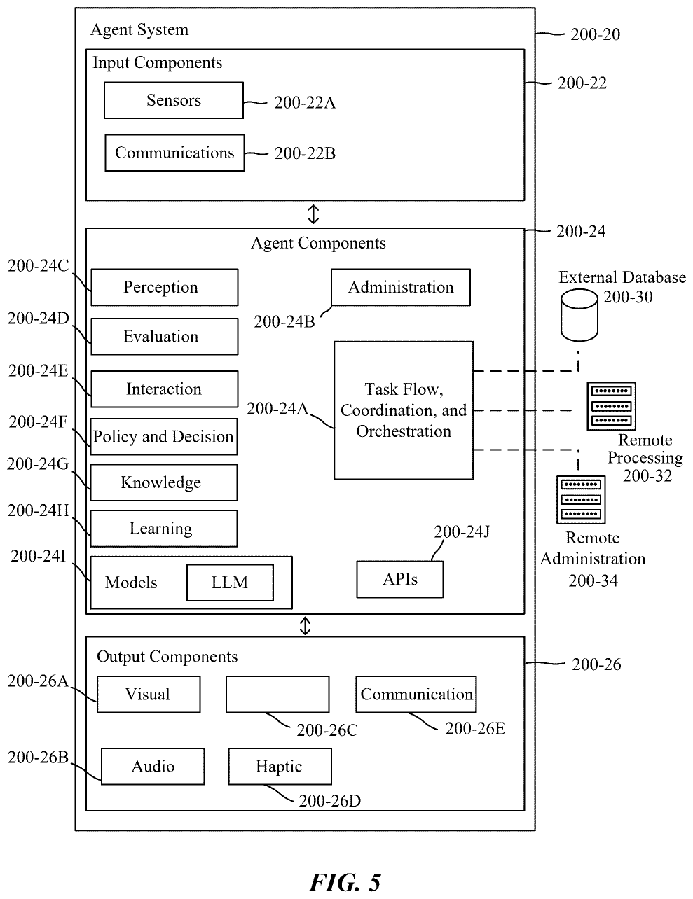

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

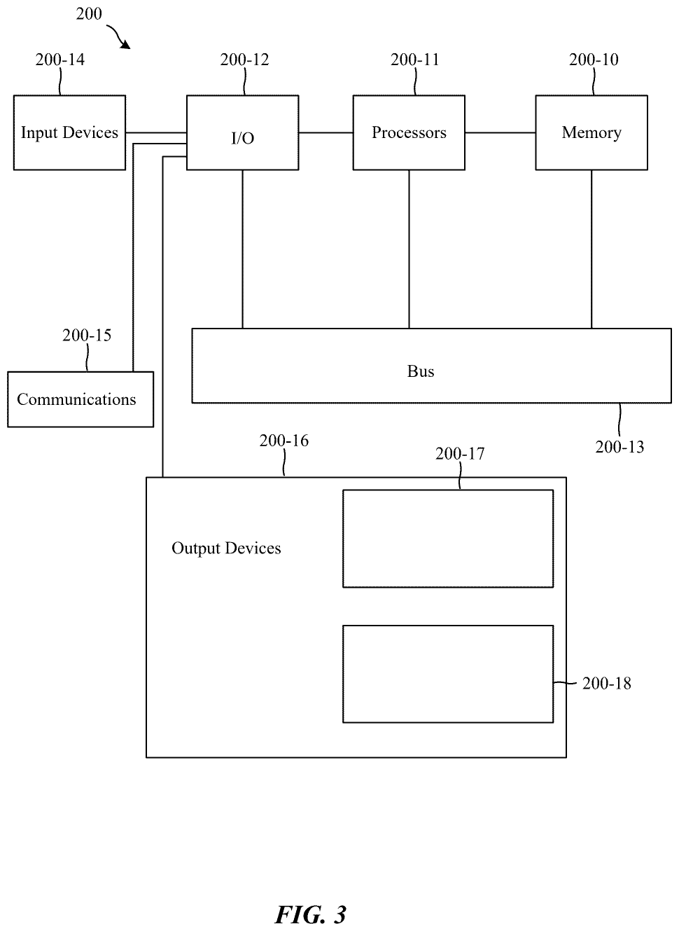

FIG. 3 illustrates exemplary block diagram of device 200. In some embodiments, device 200 includes some or all of the components described with respect to FIGS. 1A, 1B, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of personal electronic device 200 can include one or more non-transitory computer-readable storage mediums, for storing computer-executable instructions, which, when executed by one or more computer processors 200-11, For example, cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some embodiments, the storage medium is a transitory computer-readable storage medium. In some embodiments, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Electronic device 200 is not limited to the components and configuration of FIG. 3 but can include other and/or additional components in a multitude of possible configurations, all of which are intended to be within the scope of this disclosure.

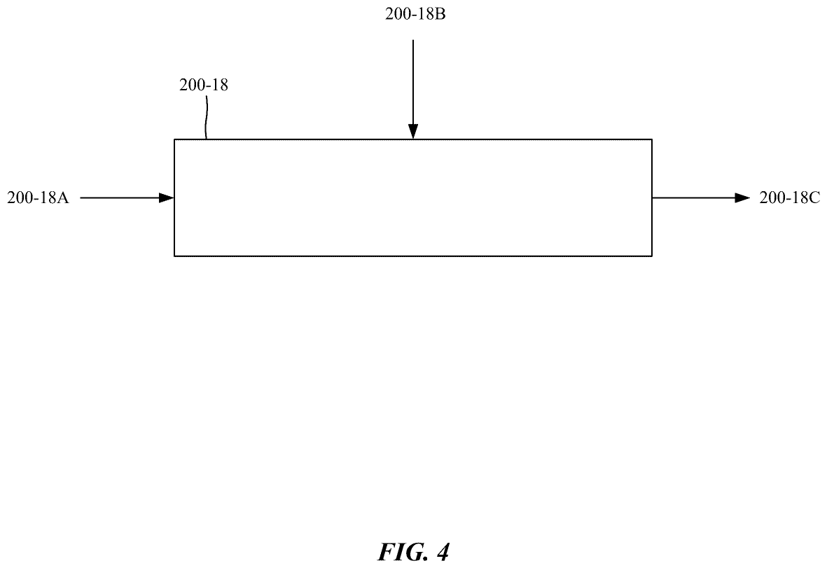

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or electronic device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a user, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “user,” “person,” “object,” and/or “animal” can be interchanged with “user” throughout this disclosure, unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20. As illustrated in FIG. 5, agent system 200-20 has a dotted box boundary that encloses input components 200-22, agent components 200-24, and output components 200-26. In some embodiments, agent system 200-20 includes fewer, more, and/or different components than illustrated in FIG. 5. In some embodiments, agent system 200-20 is implemented on a single device (e.g., computer system 100 and/or electronic device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 includes components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 is implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-241, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-241 (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user. In some embodiments, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. In some embodiments, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-241 performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-241 includes functionality performed by an operating system of a device implementing agent system 200-20. In some embodiments, models component 200-241 includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 includes components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components are implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-20 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or electronic device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, audible output, sound, and/or speech) (also referred to herein as a “verbal response,” an “audio response,” and/or an “audible response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (e.g., person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. In some embodiments, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). In some embodiments, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. In some embodiments, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or electronic device 200.

FIGS. 6A-6D illustrate exemplary user interface for participating in an interaction in accordance with some embodiments. The user interfaces in these figures are used to illustrate the processes described below, including the processes in FIGS. 7 and 8.

In particular, at least two distinct features of an exemplary computer system will be described below. The first feature concerns the physical movement of the computer system in relation to the detection of different types of interactions occurring in the environment. The second feature concerns displaying one or more word clouds in response to detecting one or more inputs. For ease of discussion, the first feature will be discussed in relation to FIGS. 6A-6D, and then, the second feature will be discussed in relation to FIGS. 6A-6D. However, in practice, the computer system can perform one or more techniques regarding these two features concurrently and/or separately.

With regards to the first feature, FIGS. 6A-6D illustrate one or more scenarios where a computer system moves based on type of interaction. In some embodiments, a type of interaction can be a particular user talking to the computer system. In some embodiments, a type of interaction can be whether one or more users are having a conversation with the computer system, and another type of interaction can be whether one or more users are having an interaction with one another (and, in some embodiments, not having an interaction with the computer system). In some embodiments, another type of interaction is an interaction that a user is having with themselves, such as one person talking out loud to themselves. In the scenario of a user talking to themselves, the computer system can temporarily face the user that is speaking and, in response to determining that the user is not addressing the computer system, return to its original position. In some embodiments, a type of interaction is an interaction of a user with another device and/or computer system (e.g., one person talking to another device). In some embodiments, a type of interaction can be a private interaction while another type of interaction can be a non-private interaction, such as a conversation being held between two or more people in a group of people versus a conversation held with the entire and/or a majority of a group of people. In some embodiments, an interaction is a conversation, which involves one or more users talking. In some embodiments, an interaction can be different from a conversation, such as one or more users gazing at each other, gesturing towards each other, touching each other, and/or talking about each other. In some embodiments, the computer system detects an interaction when one or more users are silent and/or when no user is talking in the environment. In some embodiments, the computer system can move differently in response to detecting different interactions. For example, the computer system can move to face the user, not face the user, face a particular area of the environment, or face another type of user in the environment.

Turning to FIG. 6A, the right side of FIG. 6A illustrates environment 602. Within environment 602 is computer system 600, user 608 at a left-most position, and user 604 in a right-most position. The dotted lines angled from computer system 600 represent the area of visibility of computer system 600. In some embodiments, the display screen of computer system 600 is visible to the elements of environment 602 that are within the dotted lines. In some embodiments, the dotted lines angled from computer system 600 represent the field-of-detection of computer system, such as the field-of-view of one or more cameras of computer system 600. At FIG. 6A, computer system 600 faces user 604 because computer system 600 has detected that user 604 is interacting with the computer system. Notably, at FIG. 6A, computer system 600 is not facing user 608, which is denoted by user 608 being outside of the dotted lines representing the area of visibility and/or the field-of-detection of computer system 600.

In some embodiments, computer system 600 moves in response to detecting a different type of interaction. For example, at FIG. 6B, computer system 600 detects input 618 from user 608, which is a different interaction from the interaction detected from user 604 at FIG. 6A (e.g., input 606). Here, computer system 600 detects that a different interaction has occurred because a new user (e.g., user 608) has started to interact with computer system 600. At FIGS. 6A-6B, in response to detecting the different type of interaction (e.g., the interaction between user 608 and computer system 600), computer system 600 rotates counterclockwise, so that user 608 is within the field-of-detection and/or area of visibility of computer system 600. This is illustrated by user 608 being within the dotted lines in FIG. 6B and user 604 being outside of the dotted lines at FIG. 6B.

In some embodiments, computer system 600 moves in different ways in response to detecting an interaction. For example, instead of or in addition to rotating counterclockwise, computer system 600 can also tilt (e.g., 0-270 degrees) to turn from facing user 604 to face user 608 and/or move left, up, down, and/or any combination thereof to move from facing user 604 to facing user 608. As used herein, it should be understood that “facing one or more users” is used to state that the one or more users are within the area of visibility and/or within the field-of-detection of computer system 600.

In some embodiments, computer system 600 detects an interaction through different modality. For example, at FIG. 6B, computer system 600 detected a different interaction based on voice input (e.g., input 618) that was received. However, in some embodiments, computer system 600 could also detect that a different interaction has occurred based on detecting one or more air gestures, such as one user pointing and/or waving at another user and/or the computer system. In some embodiments, the use of different air gestures causes computer system 600 to detect different types of interactions. In some embodiments, computer system 600 detecting that a user is waving at another user can cause computer system 600 to move differently than computer system 600 detecting that a user high-fiving another user. In some embodiments, computer system 600 could also detect that a different interaction has occurred based on detecting one or more other types of inputs, such as one or more gaze inputs (e.g., whether or not one or more users are gazing at each other and/or the computer system), sound inputs (e.g., whether one or more users are making noise relative to another user, such as hitting a physical object and/or opening a physical object), and/or inputs directed to one or more hardware components, such as a button and/or a rotatable input mechanism.

In some embodiments, computer system 600 moves to face a user based on detecting an interaction that does not involve a user directly communicating with computer system 600. In some embodiments, computer system 600 moves to face user 608 in response to detecting user 604 referencing user 608 at FIG. 6B. In some embodiments, if user 604 says, “This is my friend John” at FIG. 6A or FIG. 6B, computer system 600 could turn toward user 608 (e.g., assuming user 608 is “John”) without user 608 having to first interact directly with computer system 600. In some embodiments, detecting that user 604 is referring to user 608 includes detecting that user 604 is performing an air gesture, such as pointing at user 608, waving at user 608, and/or motioning for user 608 to come over.

While at FIG. 6B computer system 600 does not move (e.g., shake and/or bow) while facing user 608, computer system 600 can move while facing a position and/or one or more users (e.g., without detecting a different interaction) in some embodiments. In some embodiments, computer system 600 shakes and/or bows while facing user 608 at FIG. 6B. In some embodiments, the movements performed, such as bowing and/or shaking, are indicative of computer system 600 interacting back and/or with user 608 (e.g., while user 608 is interacting with computer system 600).

In some embodiments, computer system 600 detects that a new interaction has occurred when detecting that one or more users (and/or all users) are relatively silent and/or not talking in environment 602. For example, as illustrated in FIG. 6C, computer system 600 expands the area of visibility so that it faces both user 604 and user 608 simultaneously because computer system 600 has determined that a new interaction has occurred because no input has been detected from user 604 or user 608 for a predetermined period of time (e.g., 1-600 seconds). In some embodiments, computer system 600 detects that a new interaction has occurred when detecting that one or more users have stopped talking, gesturing, interacting, and/or gazing with each other and/or the computer system for a period of time (e.g., 1-600 seconds).

In some embodiments, computer system 600 detects that a new interaction has occurred when users in the environment are interacting with each other and not the computer system. At FIG. 6D, computer system 600 detects input 622, which includes the term “we” to denote that users 604 and 608 are talking amongst themselves (e.g., as opposed to the use of “I” in FIGS. 6A and 6B). Thus, it follows that at FIG. 6D, computer system 600 detects that users 604 and 608 are talking amongst themselves, so computer system 600 faces user 604 and user 608. If FIG. 6C were skipped (e.g., the users were never silent), computer system 600 would rotate clockwise from the position of computer system 600 at FIG. 6B facing user 608 to be at the position of computer system 600 at FIG. 6D, which faces multiple users, in response to detecting that the users are interacting with each other and not computer system 600. In some embodiments, if FIG. 6C is not skipped, computer system 600 can move from tilting downward or upward at FIG. 6C to a position that is flatter (e.g., 0 degrees of tilt) at FIG. 6D. In some embodiments, computer system 600 tilts upward or downward (e.g., in a less flat position) to denote that computer system 600 is not monitoring an interaction less and/or is less interested in an interaction than when computer system 600 tilts to a position that is flatter. In some embodiments, computer system 600 moves to a position, where computer system 600 is not facing user 608 and/or user 604 in response to detecting that users 604 and 608 are talking to each other and not computer system 600.

At FIG. 6D, computer system 600 detects input 622 from user 604. Note that, although user 604 is speaking, computer system 600 does not move to face user 604 but remains facing both user 604 and user 608 simultaneously. In some embodiments, computer system 600 reacts to different types of interactions. In some embodiments, computer system 600 moves to face user 604 in response to initially detecting input 622 but turns away in response to detecting that the user is talking to themselves (e.g., not addressing computer system 600).

Turning to the second feature, the discussion below includes descriptions of FIGS. 6A-6D illustrating one or more scenarios where computer system 600 displays a set of words, herein referred to as a word cloud in response to detecting one or more inputs. In some embodiments, a word cloud is defined as a set of words grouped together under one common category, topic, and/or subject matter. In some embodiments, in response to detecting particular words and contexts based on one or more inputs, computer system 600 displays the words under a title that represents the common category, topic, and/or subject matter for a word cloud.

As illustrated in FIG. 6A, computer system 600 detects input 606 (e.g., “Let's go to the beach”) from user 604. In response to detecting the context of input 606, computer system 600 determines that the word “beach” should be added to word cloud 614 (e.g., a visual representation of a group), which is titled “Azores Trip”. Thus, based on the context of input 606, computer system 600 determines that user 604 is referring to a trip to Azores and displays word representation 616, which is the word “beach” that computer system 600 detected in the phrase of input 606 and determined is contextually relevant to the Azores Trip word cloud. In some embodiments, computer system 600 uses one or more machine learning algorithms to determine which words are relevant to a word cloud and/or should be added and/or use to generate a word cloud or another group. In some embodiments, a word can be relevant based on one or more context that involve the current interaction between computer system 600 and the user, a previous interaction between computer system 600 and the user, and/or an explicit request by the user to add a word to the word cloud. Note that, at FIG. 6A, user 604 did not explicitly request that the word “beach” be added to word cloud 614. However, computer system 600 intuitively determined that the user made an implicit request to add the word “beach” from the phrase included in input 606 to word cloud 614.

In some embodiments, computer system 600 adds additional words to one or more word clouds based on context. For example, as illustrated in FIG. 6B, computer system 600 detects input 618 (e.g., “I like hiking”) from user 608. From input 618, computer system 600 determines that “hiking” is a key word (and/or a word that should be added to a word cloud based on context). In some embodiments, a key word is a word from input 618 that is relevant to the context determined by a computer system 600. For example, in FIGS. 6A-6B, user 604 and user 608 are discussing the Azores Trip. Because a determination is made that “hiking” from input 618 is relevant to the Azores Trip, computer system 600 adds “hiking” to word cloud 614, displayed on user interface 612 as word representation 620. Alternatively, if user 604 mentions items on a grocery list, computer system 600 does not add the items from the grocery list to the list discussing the Azores Trip (e.g., as discussed below in relation to FIG. 6C).

In some embodiments, computer system 600 does not include words that are not determined to be key words as a part of a word cloud. For example, as illustrated in FIG. 6B, upon detecting input 618, computer system 600 includes the key word “hiking” on the list of words but not the words “I like” because the words “I like” are irrelevant to the subject matter indicated by word cloud 614. In some embodiments, if computer system 600 detects an input that includes the phrase “I like hiking on mountains,” computer system 600 could add the key words “hiking” and “mountains” to word cloud 614 but would not include the word “on” because it is irrelevant and/or not a key word with respect to the subject matter indicated by word cloud 614.

In some embodiments, computer system 600 displays word representations dynamically. In some embodiments, if computer system 600 detects that user 608 spoke input 618 slowly, computer system 600 displays the word “hiking” slowly and/or adds the word “hiking” to the word cloud at a slower pace than if user 608 spoke the input quickly. In some embodiments, computer system 600 displays words that are a part of the word cloud at different sizes. In some embodiments, if computer system 600 detects that user 608 spoke input 618 low in pitch, tone, and/or at a low volume, computer system 600 displays the word “hiking” at a smaller size than if computer system 600 detects that user 608 spoke input 618 high in pitch, tone, and/or at a high volume. In some embodiments, if computer system 600 detects that the word “hiking” is more relevant to the subject matter of word cloud 614 than the word “beach,” computer system 600 displays “hiking” higher on user interface 612 than the word “beach.” In some embodiments, if computer system 600 detects that the word “hiking” is less relevant to the subject matter of word cloud 614 than the word “beach,” computer system 600 displays “hiking” lower on user interface 612 than the word “beach.” At FIG. 6C, computer system 600 does not detect any voice inputs and, therefore, does not add any word representations to word cloud 614.

In some embodiments, computer system 600 generates a new word cloud and/or adds words to an existing word cloud that is different from a word cloud (e.g., word cloud 614) that is currently displayed and/or to which computer system 600 mostly recent added words. For example, as illustrated in FIG. 6D, in response to detecting input 622 from user 604, computer system 600 creates a new word cloud (e.g., word cloud 626) and adds the relative word (e.g., “eggs”) to word cloud 626. Computer system 600 adds the word “eggs” to word cloud 626 upon detecting that the key word “eggs” should be related to a different category and/or set of words (e.g., more than the word “eggs” relates to the subject matter indicated by word cloud 614). As illustrated in FIG. 6D, in response to a determination that input 622 refers to a grocery list, computer system 600 creates word cloud 626 (e.g., titled “Groceries”), which computer system 600 displays on user interface 624. In some embodiments, computer system 600 detects a second input related to word cloud 626 and adds the word(s) (e.g., “milk,” “bread,” and/or “cheese”) from another input. In some embodiments, while displaying word cloud 626 (e.g., a list and/or group of words displayed via a display component), computer system 600 detects an input such as “We should book a hotel,” which relates to the Azores Trip word cloud. In some embodiments, computer system 600 redisplays word cloud 614 and/or increases the size of word cloud 614, adding the relative word (e.g., “hotel”) to the set of words. In some embodiments, if computer system 600 detects an input such as “We should book the hotel and buy milk today,” computer system 600 concurrently adds “hotel” to word cloud 614 and “milk” to word cloud 626 as the input includes “hotel,” which is a word that relates to word cloud 614, and “milk,” which is a word that relates to word cloud 626.

In some embodiments, computer system 600 de-emphasizes one or more word clouds (e.g., one or more word clouds that are not currently in focus). For example, as illustrated in FIG. 6D, in response to displaying word cloud 626, computer system 600 shrinks word cloud 614 into the bottom right corner of user interface 624. In some embodiments, in response to an input that causes a word to be added to a different word cloud (e.g., “eggs” to word cloud 626), computer system 600 ceases to display word cloud 614 completely. In some embodiments, if computer system 600 detects that user 604 begins to discuss shopping at a mall, computer system 600 ceases to display word cloud 626 and begins to display a word cloud related to shopping at a mall. In some embodiments, if computer system 600 detects that user 604 begins to discuss shopping at a mall, computer system 600 minimizes but still displays word cloud 626 while displaying a word cloud related to shopping at a mall.

In some embodiments, computer system 600 displays word clouds differently. In some embodiments, computer system 600 displays the word representations and/or groups of word representations in word cloud 614 in a square formation while displaying the word representations and/or groups of word representations in word cloud 626 in a circle formation. In some embodiments, computer system 600 displays the word representations and/or groups of word representations in word cloud 614 in a circle formation while displaying the word representations and/or groups of word representations in word cloud 626 in a square formation. In some embodiments, where a word cloud is displayed in a word cloud indicates how relevant the word is to a word cloud. In some embodiments, the more relevant words are displayed at the top of a word cloud and the less relevant words are displayed at the bottom of a word cloud and/or vice-versa. In some embodiments, computer system 600 moves differently while displaying different word clouds. In some embodiments, computer system 600 moves relative to the shape of the word cloud and/or based on the characteristics (e.g., moves to indicate a mountain and/or a hill) and/or number of words in the word cloud.

In some embodiments, computer system 600 includes different images in word clouds. In some embodiments, computer system 600 includes images of a beach and/or hiking trail with word cloud 614 that are not included with word cloud 626. In some embodiments, computer system 600 includes images of a grocery store and/or eggs with word cloud 626 that are not included with word cloud 614.

FIG. 7 is a flow diagram illustrating a method for moving positions using a computer system in accordance with some embodiments. Process 700 is performed at a computer system (e.g., 100, 200, and 600). Some operations in process 700 are, optionally, combined, the orders of some operations are, optionally, changed, and some operations are, optionally, omitted.

As described below, process 700 provides an intuitive way for moving positions. The method reduces the cognitive burden on a user for moving positions, thereby creating a more efficient human-machine interface. For battery operated computing devices, enabling a user to move positions faster and more efficiently conserves power and increases the time between battery charges.

In some embodiments, process 700 is performed at a computer system (e.g., 600) that is in communication with a movement component (e.g., an actuator, a movable base, a rotatable component, and/or a rotatable base). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, a hydraulic actuator and/or an electric actuator), a movable base, a rotatable component, and/or a rotatable base).

While the computer system (e.g., 600), via the movement component, is in a first position in an environment (e.g., 602) (e.g., a physical environment and/or a virtual environment), the computer system detects (702) an occurrence (e.g., a single instance and/or distinct event) of a first interaction (e.g., 606, 618, and/or 622) (e.g., as described at FIGS. 6A-6D) (e.g., one or more users (e.g., animals, users, people, and/or objects) looking, talking, gesturing, and/or moving in one or more directions and/or in relation to each other) (and, in some embodiments, while the computer system is facing a second position in the environment).

In response to (704) detecting the first interaction (e.g., 606, 618, and/or 622), in accordance with a determination that the first interaction (e.g., 606, 618, and/or 622) is a first type of interaction (e.g., type of conversation, such as back and forth between multiple people or conversation with a single person and/or a conversation with person(s) who are physically moving relative to the computer system, and/or type of activity, such as two people playing a board game and/or watching a movie), the computer system moves (706) (e.g., changing and/or repositioning), via the movement component, to a second position in the environment (e.g., 602) different from the first position in the environment (e.g., as described at FIGS. 6A-6D) (and, in some embodiments, moving the computer system to face (e.g., a direction of the movement component and/or a direction of a display component in communication with the computer system) a respective direction).

In response to (704) detecting the first interaction, in accordance with a determination that the first interaction (e.g., 606, 618, and/or 622) is a second type of interaction (e.g., a person speaking to themselves, and/or an interaction with a digital representation of a person) different from the first type of interaction, the computer system forgoes (708) moving, via the movement component, to the second position (e.g., as described at FIGS. 6A-6D) (e.g., continuing to face a direction and/or moving to face a direction different from the respective direction). Moving to the second position in the environment in accordance with a determination that the first interaction is a first type of interaction and not moving to the second position in accordance with a determination that the first interaction is a second type of interaction in response to detecting the first interaction enables the computer system to change position for certain types of interactions and not for others, thereby performing an operation when a set of conditions has been met without requiring further user input, reducing the number of inputs needed to perform an operation, and providing improved visual feedback to the user.

In some embodiments, before detecting the first interaction (e.g., 606, 618, and/or 622), a first portion (e.g., a display component, a screen, a center of a screen, a corner of a screen, and/or a hardware component (e.g., that is in a fixed position on a housing of the computer system and/or that is currently in a particular position on the housing of the computer system) (e.g., a button, a microphone indicator, a status indicator, and/or a light)) of the computer system (e.g., 600) is facing in a first direction. In some embodiments, moving to the second position causes the first portion to face a second direction different from the first direction (e.g., as described at FIGS. 6A-6D) (and/or causes the first portion to not face and/or cease facing the first direction). Moving or not moving from facing a first direction to facing a second direction when prescribed conditions are met enables the computer system to change direction during a type of interaction, thereby performing an operation when a set of conditions has been met without requiring further user input, reducing the number of inputs needed to perform an operation, and providing improved visual feedback to the user.

In some embodiments, the first interaction (e.g., 606, 618, and/or 622) is the first type of interaction when a determination is made that a number of users (e.g., 604, and/or 608) (e.g., people, animals, users, and/or objects) participating (e.g., contributing, talking, listening, and/or engaging) in the first interaction (e.g., 606, 618, and/or 622) is above a threshold amount (e.g., two or more people interacting, two or more participating in a interaction and/or conversation, and/or two or more people participating in an activity together) (e.g., 2-100). In some embodiments, the first interaction is the second type of interaction when a determination is made that the number of people participating in the first interaction is below the threshold amount. Moving or not moving to the second position in the environment based on whether or not the people participating in the first interaction is above/below a threshold amount enables the computer system to change position according to a certain number of users and control the amount of users that the portion of the computer system is facing, thereby performing an operation when a set of conditions has been met without requiring further user input, reducing the number of inputs needed to perform an operation, increasing security, and providing improved visual feedback to the user.

In some embodiments, at least a portion (e.g., a section, a segment, a piece, and/or a period of time) of the first interaction (e.g., 606, 618, and/or 622) is directed to (e.g., in the direction of and/or associated with) the computer system (e.g., 600) (e.g., one or more users are looking at, talking to, gesturing towards, and/or moving towards the computer system). In some embodiments, the first interaction is a conversation and/or interaction (and, in some embodiments, a back-and-forth conversation and/or interaction) between a user and the computer system, where a user gives the computer system a command, a question, and/or a statement, and the computer system responds. Moving to the second position in the environment based on an interaction directed to the computer system enables the computer system to change position so that one or more users can further interact with the computer system and/or is able to interact better with the computer system, thereby performing an operation when a set of conditions has been met without requiring further user input, reducing the number of inputs needed to perform an operation, and providing improved visual feedback to the user.

In some embodiments, at least a portion of the first interaction (e.g., 606, 618, and/or 622) is not directed to the computer system (e.g., 600). In some embodiments, no portion of the first interaction is directed to the computer system. In some embodiments, the first interaction is between two more users, where two or more users are talking amongst each other and/or engaging with each other and not the computer system. In some of these embodiments, the computer system is recording an interaction between two or more users and, in some embodiments, is displaying content based on the interaction between the two or more users. However, in some embodiments, the computer system is not actively responding with audio output to the context and/or context of the interaction between the computer system and the two or more users.

In some embodiments, in response to detecting the first interaction (e.g., 606, 618, and/or 622), in accordance with the determination that the first interaction (e.g., 606, 618, and/or 622) is the second type of interaction, the computer system moves, via the movement component, to a third position different from the first position and the second position (e.g., as described at FIGS. 6A-6D). Moving to a third position different from the first position and the second position in accordance with the determination that the first interaction is the second type of interaction enables the computer system to automatically move to a position for different types of interactions, thereby performing an operation when a set of conditions has been met without requiring further user input, reducing the number of inputs needed to perform an operation, and providing improved visual feedback to the user.

In some embodiments, before detecting the first interaction (e.g., 606, 618, and/or 622), a second portion (e.g., a display component, a screen, a center of a screen, a corner of a screen, and/or a hardware component (e.g., that is in a fixed position on a housing of the computer system and/or that is currently in a particular position on the housing of the computer system) (e.g., a button, a microphone indicator, a status indicator, and/or a light)) of the computer system (e.g., 600) is facing in a third direction. In some embodiments, in response to detecting the first interaction (e.g., 606, 618, and/or 622), in accordance with the determination that the first interaction (e.g., 606, 618, and/or 622) is the second type of interaction, the computer system continues to cause the second portion of the computer system (e.g., 600) to face the third direction (e.g., as described at FIGS. 6A-6D). Continuing to cause the second portion of the computer system to face the third direction in accordance with the determination that the first interaction is the second type of interaction enables the computer system to maintain the direction it faces for certain types of interactions, thereby performing an operation when a set of conditions has been met without requiring further user input, reducing the number of inputs needed to perform an operation, and providing improved visual feedback to the user.

In some embodiments, before detecting the first interaction (e.g., 606, 618, and/or 622), a third portion (e.g., a display component, a screen, a center of a screen, a corner of a screen, and/or a hardware component (e.g., that is in a fixed position on a housing of the computer system and/or that is currently in a particular position on the housing of the computer system) (e.g., a button, a microphone indicator, a status indicator, and/or a light)) of the computer system (e.g., 600) is facing in a fourth direction. In some embodiments, in response to detecting the first interaction (e.g., 606, 618, and/or 622), in accordance with the determination that the first interaction (e.g., 606, 618, and/or 622) is the second type of interaction, the computer system moves, via the movement component, to a fourth position different from the first position while continuing to cause the third portion of the computer system (e.g., 600) to face the fourth direction (e.g., as described at FIGS. 6A-6D). In some embodiments, moving to the fourth position while maintaining the computer system facing the fourth direction includes changing the position of the computer system in the environment without facing the third portion of the computer system in a different direction. In some embodiments, the direction the third portion of the computer system is facing includes a point of focus (e.g., an object and/or a point the eighth direction is directed towards in the environment) and moving to the fourth position while continuing to cause the third portion of the computer system facing the fourth direction includes changing the position of the third portion of the computer system in the environment while maintaining the point of focus. Moving to a fourth position different from the first position while continuing to cause the third portion of the computer system to face the fourth direction in accordance with the determination that the first interaction is the second type of interaction enables the computer system to face the same direction (e.g., to view the interaction) while moving for certain types of interactions, thereby performing an operation when a set of conditions has been met without requiring further user input, reducing the number of inputs needed to perform an operation, and providing improved visual feedback to the user.

In some embodiments, before detecting the first interaction (e.g., 606, 618, and/or 622), a fourth portion (e.g., a display component, a screen, a center of a screen, a corner of a screen, and/or a hardware component (e.g., that is in a fixed position on a housing of the computer system and/or that is currently in a particular position on the housing of the computer system) (e.g., a button, a microphone indicator, a status indicator, and/or a light)) of the computer system (e.g., 600) is facing in a fifth direction. In some embodiments, in response to detecting the first interaction (e.g., 606, 618, and/or 622), in accordance with the determination that the first interaction (e.g., 606, 618, and/or 622) is the second type of interaction, the computer system forgoes moving, via the movement component, the computer system (e.g., 600) (e.g., not moving, and/or forgoing moving to the second position and/or an additional position) while continuing to cause the fourth portion of the computer system to face the fifth direction. Not moving the computer system while continuing to cause the fourth portion of the computer system to face the fifth direction in accordance with the determination that the first interaction is the second type of interaction enables the computer system to face a direction for certain types of interactions while not moving, thereby performing an operation when a set of conditions has been met without requiring further user input, reducing the number of inputs needed to perform an operation, and providing improved visual feedback to the user.

In some embodiments, in response to detecting the first interaction (e.g., 606, 618, and/or 622), in accordance with a determination that the first interaction (e.g., 606, 618, and/or 622) is a third type of interaction (e.g., type of conversation, such as back and forth between multiple people or conversation with a single person and/or a conversation with person(s) who are physically moving relative to the computer system, and/or type of activity, such as two people playing a board game and/or watching a movie), different from the first type of interaction and the second type of interaction, the computer system moves (e.g., changing, and/or repositioning), via the movement component, to the second position in the environment (e.g., 602). Moving to the second position in the environment in accordance with a determination that the first interaction is a third type of interaction enables the computer system to move to a certain position for multiple types of interactions, thereby performing an operation when a set of conditions has been met without requiring further user input, reducing the number of inputs needed to perform an operation, and providing improved visual feedback to the user.

In some embodiments, the first interaction (e.g., 606, 618, and/or 622) is the first type of interaction when a determination is made that the first interaction includes a first type of conversation (e.g., back and forth conversation and/or conversation directed towards another person). In some embodiments, the first interaction is the second type of interaction when a determination is made that the first interaction includes a second type of conversation (e.g., single speaker conversation and/or conversation directed towards the computer system) different from the first type of conversation (e.g., as described at FIGS. 6A-6D). In some embodiments, the first interaction is not the first type of interaction when a determination is made that the first interaction includes the second type of conversation. In some embodiments, the first interaction is not the second type of interaction when a determination is made that the first interaction includes the first type of conversation.

In some embodiments, before detecting the first interaction (e.g., 606, 618, and/or 622) and while the computer system (e.g., 600) is in the first position, a fifth portion (e.g., a display component, a screen, a center of a screen, a corner of a screen, and/or a hardware component (e.g., that is in a fixed position on a housing of the computer system and/or that is currently in a particular position on the housing of the computer system) (e.g., a button, a microphone indicator, a status indicator, and/or a light)) of the computer system (e.g., 600) faces a first user (e.g., 604, and/or 608) (e.g., person, animal, user, and/or object) that is currently communicating (e.g., speaking, talking, gesturing, nodding, and/or motioning). In some embodiments, after moving to the second position in response to detecting the first interaction (e.g., 606, 618, and/or 622) and in accordance with a determination that the first interaction is the first type of interaction, the fifth portion of the computer system (e.g., 600) faces a second user (e.g., 604, and/or 608), different from the first user, while the computer system is in the second position. In some embodiments, the second user is communicating while the computer system is in the second position. In some embodiments, the second user is not communicating while the computer system is in the second position. Moving to the second position to face a second user after facing a first user in the environment in accordance with a determination that the first interaction is a first type of interaction and not moving to the second position in accordance with a determination that the first interaction is a second type of interaction in response to detecting the first interaction enables the computer system to face a different user for certain types of interactions, thereby performing an operation when a set of conditions has been met without requiring further user input, reducing the number of inputs needed to perform an operation, and providing improved visual feedback to the user.

In some embodiments, the computer system (e.g., 600) is in communication with one or more input devices (e.g., speakers, touch-sensitive displays, and/or cameras) detecting the occurrence of the first interaction (e.g., 606, 618, and/or 622) includes receiving, via the one or more input devices, input from the first user (e.g., 604, and/or 608) that is referencing (e.g., directing communicating with, pointing at, saying a phrase that includes the second user (e.g., “This is my friend, second user,” “Hi, second user,” and/or “Thank you, second user”)) the second user (e.g., 604, and/or 608). Moving to the second position to face a second user after facing a first user in the environment in accordance with a determination that the first interaction is a first type of interaction and not moving to the second position in accordance with a determination that the first interaction is a second type of interaction in response to detecting the first interaction that includes receiving an input referencing the second user enables the computer system to face a different user for certain types of interactions that reference a particular user, thereby performing an operation when a set of conditions has been met without requiring further user input, reducing the number of inputs needed to perform an operation, and providing improved visual feedback to the user.

In some embodiments, detecting the occurrence of the first interaction (e.g., 606, 618, and/or 622) includes receiving an indication that a third user (e.g., 604, and/or 608) (e.g., a person, an animal, a user, and/or an object) is not communicating (e.g., is no longer singing, is no longer speaking, is no longer gesturing, is no longer talking, is no longer nodding, and/or is no longer motioning). In some embodiments, receiving the indication that the third user is not communicating includes detecting that the third user is silent and/or has been silent for more than a predetermined period of time (e.g., 1-1000 seconds). Moving to the second position in the environment in accordance with a determination that the first interaction is a first type of interaction and not moving to the second position in accordance with a determination that the first interaction is a second type of interaction in response to detecting the first interaction including receiving an indication that the third user is not communicating enables the computer system to change position during a type of interaction when a user stops communicating, thereby performing an operation when a set of conditions has been met without requiring further user input, reducing the number of inputs needed to perform an operation, and providing improved visual feedback to the user.

In some embodiments, detecting the occurrence of the first interaction (e.g., 606, 618, and/or 622) includes detecting that a fourth user (e.g., 604, and/or 608), different from the third user (e.g., 604, and/or 608), is communicating (and/or has been communicating for more than a predetermined period of time (e.g., 1-1000 seconds)). Moving to the second position in the environment in accordance with a determination that the first interaction is a first type of interaction and not moving to the second position in accordance with a determination that the first interaction is a second type of interaction in response to detecting the first interaction including receiving an indication that the third user is not communicating and the fourth user is communicating enables the computer system to change position during a type of interaction when a user stops communicating and another user is communicating, thereby performing an operation when a set of conditions has been met without requiring further user input, reducing the number of inputs needed to perform an operation, and providing improved visual feedback to the user.

In some embodiments, the computer system (e.g., 600) is in a first tilt position (and/or angle (e.g., 0-360 degrees)) while the computer system is at the first position. In some embodiments, moving, via the movement component to the second position in the environment (e.g., 602) includes tilting, via the movement component, from the first tilt position to a second tilt position (and/or angle (e.g., 0-360 degrees)) different from the first tilt position. Tilting to the second position in the environment in response to detecting the first interaction enables the computer system to change the tilt position during a type of interaction, thereby performing an operation when a set of conditions has been met without requiring further user input, reducing the number of inputs needed to perform an operation, and providing improved visual feedback to the user.

In some embodiments, the computer system (e.g., 600) is in a first rotational position (and/or angle (e.g., 0-360 degrees)) while the computer system is at the first position. In some embodiments, moving, via the movement component to the second position in the environment (e.g., 602) includes rotating, via the movement component, from the first rotational position to a second rotational position (and/or angle (e.g., 0-360 degrees)) different from the first rotational position. Rotating to the second position in the environment in response to detecting the first interaction enables the computer system to change the rotational position during a type of interaction, thereby performing an operation when a set of conditions has been met without requiring further user input, reducing the number of inputs needed to perform an operation, and providing improved visual feedback to the user.

In some embodiments, the first position includes a first lateral position. In some embodiments, moving, via the movement component to the second position in the environment (e.g., 602) includes moving, via the movement component, from the first lateral position to a second lateral position different from the first lateral position (e.g., as described at FIGS. 6A-6D). Moving laterally to the second position in the environment in accordance with a determination that the first interaction is a first type of interaction and not moving to the second position in accordance with a determination that the first interaction is a second type of interaction where the second position is a lateral position in response to detecting the first interaction enables the computer system to change the lateral position during a type of interaction, thereby performing an operation when a set of conditions has been met without requiring further user input, reducing the number of inputs needed to perform an operation, and providing improved visual feedback to the user.

Note that details of the processes described above with respect to process 700 (e.g., FIG. 7) are also applicable in an analogous manner to the methods described below/above. For example, process 800 optionally includes one or more of the characteristics of the various methods described above with reference to process 700. For example, the new word can be added to a word cloud using one or more techniques of process 800 can be displayed in conjunction with moving to the second position using one or more techniques of process 700. For brevity, these details are not repeated below.

FIG. 8 is a flow diagram illustrating a method for displaying content using a computer system in accordance with some embodiments. Process 800 is performed at a computer system (e.g., 100, 200, and/or 600). Some operations in process 800 are, optionally, combined, the orders of some operations are, optionally, changed, and some operations are, optionally, omitted.

As described below, process 800 provides an intuitive way for displaying content. The method reduces the cognitive burden on a user for displaying content, thereby creating a more efficient human-machine interface. For battery operated computing devices, enabling a user to display content faster and more efficiently conserves power and increases the time between battery charges.

In some embodiments, process 800 is performed at a computer system (e.g., 600) that is in communication with a display component (e.g., a projector, a display screen, and/or a touch-sensitive display) and a microphone. In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, a hydraulic actuator and/or an electric actuator), a movable base, a rotatable component, and/or a rotatable base).

While displaying, via the display component, a user interface (e.g., 612, and/or 624) (e.g., a home screen, an application, and/or a user interface object), the computer system detects (802), via the microphone, first voice input (e.g., 606, 618, and/or 622) (e.g., a phrase, a statement, a question, and/or an answer).

In response to detecting the first voice input (e.g., 606, 618, and/or 622), the computer system displays (804), via the display component, a first set of one or more words (e.g., text and/or symbols) corresponding to the first voice input in a first manner (e.g., at a first size, as a prominent set of one or more words, and/or as an emphasized set of one or more words).

While displaying the first set of one or more words corresponding to the first voice input (e.g., 606, 618, and/or 622), the computer system detects (806), via the microphone, a second voice input (e.g., 606, 618, and/or 622) (e.g., a phrase, a question, and/or an answer).

In response to (808) detecting the second voice input (e.g., 606, 618, and/or 622), in accordance with a determination that the second voice input (e.g., 606, 618, and/or 622) includes a new word (e.g., 616, 620, and/or 628) (and, in some embodiments, not included in the first voice input) and that the new word (e.g., 616, 620, and/or 628) corresponding to the second voice input (e.g., 606, 618, and/or 622) should be added to the first set of one or more words, the computer system displays (810), via the display component, the new word (e.g., 616, 620, and/or 628) corresponding to the second voice input (e.g., 606, 618, and/or 622) with display of (e.g., as a part of and/or while concurrently displaying and/or presenting) the first set of one or more words in the first manner.

In response to (808) detecting the second voice input, in accordance with a determination that the second voice input (e.g., 606, 618, and/or 622) includes the new word (e.g., 616, 620, and/or 628) corresponding to the second voice input and that the new word corresponding to the second voice input should not be added to the first set of one or more words, the computer system displays (812), via the display component, a second set of one or more words that includes the new word corresponding to the second voice input in the first manner while ceasing to display the first set of one or more words in the first manner, wherein the second set of one or more words is different from the first set of one or more words (e.g., as described above at FIGS. 6A-6D). In some embodiments, the second set of one or more words is different from the first set of one or more words (and, in some embodiments, includes two or more words different from the first set of one or more words). In some embodiments, the second voice input is different from the first voice input. In some embodiments, the second voice input is separate from the first voice input and the same as the first voice input. Displaying the new word corresponding to the second voice input with display of the first set of one or more words in the first manner in accordance with a determination that the second voice input includes a new word and that the new word corresponding to the second voice input should be added to the first set of one or more words and displaying a second set of one or more words that includes the new word corresponding to the second voice input in the first manner while ceasing to display the first set of one or more words in the first manner in accordance with a determination that the second voice input includes the new word corresponding to the second voice input and that the new word corresponding to the second voice input should not be added to the first set of one or more words enables the computer system to automatically add new words from an input to a set of words and display a new set of words when the new word shouldn't be added to the set of words, thereby performing an operation when a set of conditions has been met without requiring further user input, reducing the number of inputs needed to perform an operation, and providing improved visual feedback to the user.

In some embodiments, the new word (e.g., 616, 620, and/or 628) is a first new word. In some embodiments, while displaying the second set of one or more words including the first new word (e.g., 616, 620, and/or 628) corresponding to the second voice input (e.g., 606, 618, and/or 622), the computer system detects, via the microphone, a third voice input (e.g., 606, 618, and/or 622) (e.g., different from the first voice input, different from the second voice input, separate from the first voice input and the same as the first voice input, and/or separate from the second voice input and the same as the second voice input). In some embodiments, in response to detecting the third voice input (e.g., 606, 618, and/or 622) and, in accordance with a determination that the third voice input (e.g., 606, 618, and/or 622) includes a second new word (e.g., 616, 620, and/or 628) different from the first new word and that the second new word (e.g., 616, 620, and/or 628) corresponding to the third voice input should be added to the first set of one or more words, the computer system displays, via the display component, the second new word corresponding to the third voice input with the first set of one or more words (e.g., as described above at FIGS. 6A-6D) (e.g., in the first manner) (and, in some embodiments, while ceasing to display the second set of one or more words in the first manner). In some embodiments, in accordance with a determination that the third voice input includes the second new word and that the second new word corresponds to the third voice input should not be added to the first set of one or more words, the computer system does not display, via the display component, the second new word corresponding to the third voice input and the first set of one or more words (and, in some embodiments, the computer system continues displaying the second set of one or more words (e.g., in the first manner)). In some embodiments, in accordance with a determination that the third voice input includes the second new word and that the second new word corresponding to the third voice input should not be added to the first set of one or more words, the computer does not display, via the display component, the second new word corresponding to the third voice input with the first set of one or more words (e.g., in the first manner) (and, in some embodiments, the computer system displays a new set of one or more words that includes the second new word). Displaying the second new word corresponding to the third voice input with the first set of one or more word in accordance with a determination that the third voice input includes a second new word different from the first new word and that the second new word corresponding to the third voice input should be added to the first set of one or more words enables the computer system to detect additional inputs and re-display a set of words with a new word when a determination is made that the new word corresponding to new verbal input should be added to first set of words, thereby performing an operation when a set of conditions has been met without requiring further user input, reducing the number of inputs needed to perform an operation, and providing improved visual feedback to the user.

In some embodiments, the new word (e.g., 616, 620, and/or 628) is a third new word. In some embodiments, while displaying the second set of one or more words including the third new word (e.g., 616, 620, and/or 628) corresponding to the second voice input (e.g., 606, 618, and/or 622), the computer system detects, via the microphone, a fourth voice input (e.g., 606, 618, and/or 622) (e.g., different from the first voice input, different from the second voice input, separate from the first voice input and the same as the first voice input, and/or separate from the second voice input and the same as the second voice input). In some embodiments, in response to detecting the fourth voice input (e.g., 606, 618, and/or 622) and in accordance with a determination that the fourth voice input (e.g., 606, 618, and/or 622) includes a fourth new word (e.g., 616, 620, and/or 628) different from the third new word (e.g., 616, 620, and/or 628) and that the fourth new word corresponding to the fourth voice input should be added to the second set of one or more words, the computer system displays, via the display component, the fourth new word corresponding to the fourth voice input with display of the second set of one or more words (e.g., as described above at FIGS. 6A-6D) (e.g., in the first manner) (and, in some embodiments, while not displaying the first set of one or more words). In some embodiments, in accordance with a determination that the fourth voice input includes the fourth new word and that the fourth new word corresponding to the fourth voice input should not be added to the second set of one or more words, the computer system does not display, via the display component, the fourth new word corresponding to the fourth voice input with display of the second set of one or more words. In some embodiments, in accordance with a determination that the fourth voice input includes the fourth new word and that the fourth new word corresponding to the fourth voice input should not be added to the second set of one or more words, the computer system displays a set of one or more words that includes the fourth new word (e.g., different from the first set of one or more words and the second set of one or more words) (e.g., in the first manner). Displaying the fourth new word corresponding to the fourth voice input with display of the second set of one or more words in accordance with a determination that the fourth voice input includes a fourth new word and that the fourth new word corresponding to the fourth voice input should be added to the second set of one or more words enables the computer system to add new words for additional inputs by automatically adding the new words with the previous set of words, thereby performing an operation when a set of conditions has been met without requiring further user input, reducing the number of inputs needed to perform an operation, and providing improved visual feedback to the user.

In some embodiments, the new word (e.g., 616, 620, and/or 628) is a fifth new word. In some embodiments, while displaying the second set of one or more words including the fifth new word (e.g., 616, 620, and/or 628) corresponding to the second voice input (e.g., 606, 618, and/or 622), the computer system detects, via the microphone, a fifth voice input (e.g., 606, 618, and/or 622) (e.g., different from the first voice input, different from the second voice input, separate from the first voice input and the same as the first voice input, and/or separate from the second voice input and the same as the second voice input). In some embodiments, in response to detecting the fifth voice input (e.g., 606, 618, and/or 622) and in accordance with a determination that the fifth voice input (e.g., 606, 618, and/or 622) includes a sixth new word (e.g., 616, 620, and/or 628) different from the fifth new word (e.g., 616, 620, and/or 628) and that the sixth new word corresponding to the fifth voice input should be not added to the second set of one or more words, the computer system displays, via the display component, a third set of one or more words that includes the sixth new word (e.g., in the first manner) corresponding to the fifth voice input while ceasing to display the second set of one or more words in the first manner, wherein the third set of one or more words is different from the second set of one or more words (and, in some embodiments, different from the first set of one or more words). In some embodiments, in accordance with a determination that the fifth voice input includes the sixth new word and that the sixth new word corresponding to the fifth voice input should be added to the second set of one or more words, the computer system does not display, via the display component, the third set of one or more words that includes the sixth new word corresponding to the fifth voice input (e.g., in the first manner) (and, in some embodiments, does not cease to display the second set of one or more words in the first manner). Displaying the third set of one or more words that includes the sixth new word corresponding to the fifth voice input while ceasing to display the second set of one or more words in the first manner in accordance with a determination that the fifth voice input includes a sixth new word and that the sixth new word corresponding to the fifth voice input should be not added to the second set of one or more words enables the computer system to continually add new words to sets of words for additional inputs, thereby performing an operation when a set of conditions has been met without requiring further user input, reducing the number of inputs needed to perform an operation, and providing improved visual feedback to the user.

In some embodiments, the new word (e.g., 616, 620, and/or 628) is a seventh new word. In some embodiments, while displaying the second set of one or more words that includes the seventh new word (e.g., 616, 620, and/or 628) corresponding to the second voice input (e.g., 606, 618, and/or 622), the computer system detects, via the microphone, a sixth voice input (e.g., 606, 618, and/or 622) (e.g., different from the first voice input, different from the second voice input, separate from the first voice input and the same as the first voice input, and/or separate from the second voice input and the same as the second voice input). In some embodiments, in response to detecting the sixth voice input (e.g., 606, 618, and/or 622) and in accordance with a determination that the sixth voice input (e.g., 606, 618, and/or 622) includes an eighth new word (e.g., 616, 620, and/or 628) different from the seventh new word (e.g., 616, 620, and/or 628) and that the eighth new word corresponding to the sixth voice input should not be added to a respective set of one or more words (e.g., any set of words, the second set of one or more words and/or the first set of one or more words), the computer system forgoes displaying, via the display component, the seventh new word corresponding to the sixth voice input. In some embodiments, a determination that the eighth new word corresponding to the sixth voice input should not be added to the respective set of one or more words is made when a determination is made that the eighth new word is not an important word, a key word, a main word, and/or a relevant word with respect to a context, an interaction, and/or a conversation. In some embodiments, the eighth word is a preposition, a conjunction, and/or another part of speech, which is deemed not to be important. Not displaying, the seventh new word corresponding to the sixth voice input in accordance with a determination that the sixth voice input includes an eighth new word different from the seventh new word and that the eighth new word corresponding to the sixth voice input should not be added to a respective set of one or more words enables the computer system to detect additional inputs and not add additional words that should not be added to the set of one or more words, thereby performing an operation when a set of conditions has been met without requiring further user input, reducing the number of inputs needed to perform an operation, and providing improved visual feedback to the user.

In some embodiments, in response to detecting the sixth voice input (e.g., 606, 618, and/or 622) and in accordance with the determination that the sixth voice input (e.g., 606, 618, and/or 622) includes the eighth new word and that the eighth new word (e.g., 616, 620, and/or 628) should not be added to a list of words, the computer system continues to display, via the display component, the second set of one or more words in the first manner. Displaying the second set of one or more words in the first manner in accordance with the determination that the sixth voice input includes the eighth new word and that the eighth new word should not be added to a list of words enables the computer system to maintain display of the set of one or more words when the new input includes new words but not a word that should be added to the set of one or more words, thereby performing an operation when a set of conditions has been met without requiring further user input, reducing the number of inputs needed to perform an operation, and providing improved visual feedback to the user.

In some embodiments, the second voice input (e.g., 606, 618, and/or 622) includes a phrase (e.g., a fourth set of one or more words and/or a short verbal expression) including the new word.

In some embodiments, the new word (e.g., 616, 620, and/or 628) is a ninth new word. In some embodiments, in response to detecting the second voice input (e.g., 606, 618, and/or 622) and in accordance with a determination that the second voice input (e.g., 606, 618, and/or 622) includes a tenth new word, different from the ninth new word, that the tenth new word (e.g., 616, 620, and/or 628) corresponding to the second voice input should be added to the first set of one or more words, that the second voice input includes the ninth new word, and that the ninth new word (e.g., 616, 620, and/or 628) corresponding to the second voice input should be added to the first set of one or more words, the computer system concurrently displays via the display component, the ninth new word corresponding to the second voice input and the tenth new word corresponding to the second voice input with display of the first set of one or more words in the first manner (e.g., as described above at FIGS. 6A-6D). In some embodiments, the phrase includes the tenth new word. In some embodiments, in accordance with a determination that the second voice input includes the tenth new word, that the tenth new word corresponding to the second voice input should not be added to the first set of one or more words, that the second voice input includes the ninth new word, and that the ninth new word corresponding to the second voice input should be added to the first set of one or more words, the computer system displays, via the display component, the ninth new word corresponding to the second voice input and does not display the tenth new word corresponding to the second voice input while displaying the first set of one or more words (e.g., in the first manner). In some embodiments, in accordance with a determination that the second voice input includes the tenth new word, that the tenth new word corresponding to the second voice input should be added to the first set of one or more words, that the second voice input includes the ninth new word, and that the ninth new word corresponding to the second voice input should not be added to the first set of one or more words, the computer system displays, via the display component, the tenth new word corresponding to the second voice input and does not display the ninth new word corresponding to the second voice input while displaying the first set of one or more words (e.g., in the first manner). In some embodiments, in accordance with a determination that the second voice input includes the tenth new word, that the tenth new word corresponding to the second voice input should not be added to the first set of one or more words, that the second voice input includes the ninth new word, and that the ninth new word corresponding to the second voice input should not be added to the first set of one or more words, the computer system does not display, via the display component, the ninth new word corresponding to the second voice input and does not display the tenth new word corresponding to the second voice input while displaying the first set of one or more words (e.g., in the first manner). Concurrently displaying the ninth new word corresponding to the second voice input and the tenth new word corresponding to the second voice input with display of the first set of one or more words in the first manner in accordance with a determination that the second voice input includes a tenth new word that the tenth new word corresponding to the second voice input should be added to the first set of one or more words, that the second voice input includes the ninth new word, and that the ninth new word corresponding to the second voice input should be added to the first set of one or more words enables the computer system to add multiple new words concurrently to a set of words for inputs with multiple new words, thereby performing an operation when a set of conditions has been met without requiring further user input, reducing the number of inputs needed to perform an operation, and providing improved visual feedback to the user.

In some embodiments, the second voice input (e.g., 606, 618, and/or 622) includes an eleventh new word (e.g., 616, 620, and/or 628) that is between the ninth new word (e.g., 616, 620, and/or 628) and the tenth new word (e.g., 616, 620, and/or 628) in the second voice input. In some embodiments, in response to detecting the second voice input (e.g., 606, 618, and/or 622) (e.g., and in accordance with a determination that the eleventh new word should not be added to the first set of one or more words and/or any respective set of one or more words), the computer system forgoes displaying, via the display component, the eleventh new word (e.g., 616, 620, and/or 628) corresponding to the second voice input (and, in some embodiments, in the first set of one or more words, the second set of one or more words, or additional sets of one or more words) (e.g., while concurrently displaying, via the display component, the ninth new word corresponding to the second voice input and the tenth new word corresponding to the second voice input with display of the first set of one or more words (e.g., in the first manner)). In some embodiments, in response to detecting the second voice input, the computer system does not add the eleventh new word corresponding to the second voice input to a set of one or more words (the first set of one or more words, the second set of one or more words, or additional sets of one or more words). Not displaying the eleventh new word corresponding to the second voice input in response to detecting the second voice input enables the computer system to automatically ignore some words between other new words that should be added, thereby performing an operation when a set of conditions has been met without requiring further user input, reducing the number of inputs needed to perform an operation, and providing improved visual feedback to the user.

In some embodiments, the new word (e.g., 616, 620, and/or 628) is a twelfth new word. In some embodiments, in response to detecting the second voice input (e.g., 606, 618, and/or 622), in accordance with a determination that the second voice input (e.g., 606, 618, and/or 622) includes a thirteenth new word (e.g., 616, 620, and/or 628) different from the twelfth new word (e.g., 616, 620, and/or 628) and that the thirteenth new word corresponding to the second voice input should not be added to the first set of one or more words and that the twelfth new word corresponding to the second voice input should not be added to the first set of one or more words, the computer system concurrently displays via the display component, the thirteenth new word corresponding to the second voice input and the twelfth new word corresponding to the second voice input as a part of the second set of one or more words (e.g., as described above at FIGS. 6A-6D) (e.g., while ceasing to display the first set of one or more words in the first manner) (e.g., in the first manner). In some embodiments, in accordance with a determination that the second voice input includes the thirteenth new word, that the thirteenth new word corresponding to the second voice input should be added to the first set of one or more words, and that the twelfth new word corresponding to the second voice input should not be added to the first set of one or more words, the computer system displays, via the display component, the second set of one or more words (e.g., in the first manner) that includes twelfth new word corresponding to the second voice input while ceasing to display the first set of one or more words and does not display the thirteenth new word corresponding to the second voice input. In some embodiments, in accordance with a determination that the second voice input includes the thirteenth new word, that the thirteenth new word corresponding to the second voice input should not be added to the first set of one or more words, and that the twelfth new word corresponding to the second voice input should be added to the first set of one or more words, the computer system displays, via the display component, the second set of one or more words (e.g., in the first manner) that includes the thirteenth new word corresponding to the second voice input while ceasing to display the first set of one or more words and does not display the twelfth new word corresponding to the second voice input. In some embodiments, in accordance with a determination that the second voice input includes the thirteenth new word, that the thirteenth new word corresponding to the second voice input should not be added to the first set of one or more words, and that the twelfth new word corresponding to the second voice input should not be added to the first set of one or more words, the computer system displays, via the display component, the second set of one or more words that does not include the twelfth new word corresponding to the second voice input while ceasing to display the first set of one or more words and does not display the thirteenth new word corresponding to the second voice input. Concurrently displaying the thirteenth new word corresponding to the second voice input and the twelfth new word corresponding to the second voice input as a part of the second set of one or more words in accordance with a determination that the second voice input includes a thirteenth new word and that the thirteenth new word corresponding to the second voice input should not be added to the first set of one or more words and that the twelfth new word corresponding to the second voice input should not be added to the first set of one or more words enables the computer system to display multiple new words including the additional new word to the set of one or more words at the same time, thereby performing an operation when a set of conditions has been met without requiring further user input, reducing the number of inputs needed to perform an operation, and providing improved visual feedback to the user.

In some embodiments, the second voice input (e.g., 606, 618, and/or 622) includes a fourteenth new word (e.g., 616, 620, and/or 628) different from the thirteenth new word (e.g., 616, 620, and/or 628) and the twelfth new word in the second voice input. In some embodiments, in response to detecting the second voice input (e.g., 606, 618, and/or 622) (e.g., and in accordance with a determination that the fourteenth new word should not be added to the first set of one or more words and/or any respective set of one or more words), the computer system forgoes displaying, via the display component, the fourteenth new word (e.g., 616, 620, and/or 628) corresponding to the second voice input (and, in some embodiments, in the first set of one or more words, the second set of one or more words, or additional sets of one or more words) (e.g., while concurrently displaying, via the display component, the thirteenth new word and the twelfth new word corresponding to the second voice input and with display of the first set of one or more words (e.g., in the first manner)). In some embodiments, in response to detecting the second voice input, the computer system does not add the fourteenth new word corresponding to the second voice input to a set of one or more words (the first set of one or more words, the second set of one or more words, or additional sets of one or more words). Not displaying, the fourteenth new word corresponding to the second voice input in response to detecting the second voice input enables the computer system to ignore words in an input that are between other words which are being displayed (e.g., adds important words' dependent context and does not add other words dependent on context), thereby performing an operation when a set of conditions has been met without requiring further user input, reducing the number of inputs needed to perform an operation, and providing improved visual feedback to the user.

In some embodiments, the second voice input (e.g., 606, 618, and/or 622) does not include an explicit indication (e.g., a set of one or more words that explicitly refers to and/or a command) to add the new word (e.g., 616, 620, and/or 628) to a particular set of one or more words (e.g., as described above at FIGS. 6A-6D) (e.g., the first set of one or more words and/or the second set of one or more words). Displaying the new word corresponding to the second voice input with display of the first set of one or more words in the first manner in accordance with a determination that the second voice input includes a new word and that the new word corresponding to the second voice input that does not include an explicit indication to add the new word should be added to the first set of one or more words and displaying, via the display component, a second set of one or more words that includes the new word corresponding to the second voice input in the first manner while ceasing to display the first set of one or more words in the first manner in accordance with a determination that the second voice input includes the new word corresponding to the second voice input and that the new word corresponding to the second voice input should not be added to the first set of one or more words enables the computer system to automatically add a new word to the set of one or more words even when the input does not explicitly indicate the word should be added and display a new set of one or more words when a determination is made that the new word should be added to the set of one or more words, thereby performing an operation when a set of conditions has been met without requiring further user input, reducing the number of inputs needed to perform an operation, and providing improved visual feedback to the user.

In some embodiments, in response to detecting the second voice input (e.g., 606, 618, and/or 622), in accordance with a determination that the second voice input (e.g., 606, 618, and/or 622) includes a fifteenth new word (e.g., 616, 620, and/or 628) and that the new word corresponding to the second voice input should be added to the first set of one or more words, the computer system displays a first set of one or more indications (e.g., list headers, representations of the first set of one or more words, and/or text) corresponding to the first set of one or more words while displaying the fifteenth new word (e.g., 616, 620, and/or 628) corresponding to the second voice input with display of (e.g., as a part of and/or while concurrently displaying and/or presenting) the first set of one or more words in the first manner. In some embodiments, in response to detecting the second voice input, in accordance with a determination that the second voice input (e.g., 606, 618, and/or 622) includes the fifteenth new word (e.g., 616, 620, and/or 628) corresponding to the second voice input and that the fifteenth new word corresponding to the second voice input should not be added to the first set of one or more words, the computer system displays a second set of indications, different from the first set of indications, corresponding to the second set of one or more words while displaying the new word (e.g., 616, 620, and/or 628) corresponding to the second voice input in the first manner (e.g., as described above at FIGS. 6A-6D) (e.g., and while not displaying the first set of one or more words in the first manner). Displaying a first set of one or more indications corresponding to the first set of one or more words while displaying the fifteenth new word corresponding to the second voice input with display of the first set of one or more words in the first manner in accordance with a determination that the second voice input includes a fifteenth new word and that the new word corresponding to the second voice input should be added to the first set of one or more words and displaying a second set of indications corresponding to the second set of one or more words while displaying the new word corresponding to the second voice input in the first manner in accordance with a determination that the second voice input includes the fifteenth new word corresponding to the second voice input and that the fifteenth new word corresponding to the second voice input should not be added to the first set of one or more words enables the computer system to display different indications for a new word that is displayed with the set one or more words and a new set of one or more words to display with the new word, thereby performing an operation when a set of conditions has been met without requiring further user input, reducing the number of inputs needed to perform an operation, and providing improved visual feedback to the user.

In some embodiments, the first set of one or more words are displayed in a first arrangement (e.g., organization, order, sequence, spacing, and/or shape of the display of a set of words). In some embodiments, the second set of one or more words are displayed in a second arrangement different from the first arrangement (e.g., as described above at FIGS. 6A-6D). Displaying the new word corresponding to the second voice input with display of the first set of one or more words in the first manner and a first arrangement in accordance with a determination that the second voice input includes a new word and that the new word corresponding to the second voice input should be added to the first set of one or more words and displaying, via the display component, a second set of one or more words that includes the new word corresponding to the second voice input in the first manner and a second arrangement while ceasing to display the first set of one or more words in the first manner in accordance with a determination that the second voice input includes the new word corresponding to the second voice input and that the new word corresponding to the second voice input should not be added to the first set of one or more words enables the computer system to automatically display a new word to the set of one or more words in a first arrangement and display a new set of one or more words in a different arrangement when a determination is made that the new word should be added to the set of one or more words, thereby performing an operation when a set of conditions has been met without requiring further user input, reducing the number of inputs needed to perform an operation, and providing improved visual feedback to the user.

In some embodiments, displaying the first set of one or more words includes displaying a first set of one or more media representations (e.g., video, image, animation, 3D rendering, augmented reality overlay, motion graphics, data visualization, and/or digital art) corresponding to the first set of one or more words. In some embodiments, displaying the second set of one or more words includes displaying a second set of one or more media representations corresponding to the second set of one or more words, wherein the second set of one or more media representations is different from the first set of one or more media representations (e.g., as described above at FIGS. 6A-6D). Displaying the new word corresponding to the second voice input with display of the first set of one or more words in the first manner including displaying a first set of one or more media representations in accordance with a determination that the second voice input includes a new word and that the new word corresponding to the second voice input should be added to the first set of one or more words and displaying, via the display component, a second set of one or more words that includes the new word corresponding to the second voice input in the first manner including a second set of one or more media representations corresponding to the second set of one or more words while ceasing to display the first set of one or more words in the first manner in accordance with a determination that the second voice input includes the new word corresponding to the second voice input and that the new word corresponding to the second voice input should not be added to the first set of one or more words enables the computer system to automatically add a new word to the set of one or more words including a first media and display a new set of one or more words when a determination is made that the new word should be added to the set of one or more words including a second media, thereby performing an operation when a set of conditions has been met without requiring further user input, reducing the number of inputs needed to perform an operation, and providing improved visual feedback to the user.

In some embodiments, the determination that the new word (e.g., 616, 620, and/or 628) corresponding to the second voice input (e.g., 606, 618, and/or 622) should be added to the first set of one or more words (e.g., in the first manner) includes a determination that the new word is a key (e.g., relevant, important) word (e.g., pivotal term, central word, and/or an essential communication element) in the second voice input. Displaying the new word corresponding to the second voice input with display of the first set of one or more words in the first manner in accordance with a determination that the second voice input includes a new word and that the new word corresponding to the second voice input should be added to the first set of one or more words including a determination that the new word is a key word in the second voice input and displaying, via the display component, a second set of one or more words that includes the new word corresponding to the second voice input in the first manner while ceasing to display the first set of one or more words in the first manner in accordance with a determination that the second voice input includes the new word corresponding to the second voice input and that the new word corresponding to the second voice input should not be added to the first set of one or more words enables the computer system to automatically add a new key word to the set of one or more words and display a new set of one or more words when a determination is made that the new word should be added to the set of one or more words, thereby performing an operation when a set of conditions has been met without requiring further user input, reducing the number of inputs needed to perform an operation, and providing improved visual feedback to the user.

In some embodiments, a determination of whether the new word (e.g., 616, 620, and/or 628) is a key (e.g., relevant, important) word (e.g., pivotal term, central word, and/or an essential communication element) in the second voice input (e.g., 606, 618, and/or 622) includes: in accordance with a determination that a current context is a first context (e.g., based on previous voice inputs to the second voice input and/or the first voice input, and/or the presence of users (e.g., a user, a person, an animal, another computer system different from the computer system, and/or an object) near the computer system) (e.g., context in which the computer system is operating, context of the internal dialogue of the computer system, and/or environmental context), a determination is made that the new word (e.g., 616, 620, and/or 628) is the key word (e.g., in the second voice input); and in accordance with a determination that the current context is a second context, different form the first context, a determination is made that new word is not the key word (e.g., in the second voice input). Displaying the new word corresponding to the second voice input with display of the first set of one or more words in the first manner in accordance with a determination that the second voice input includes a new word and that the new word corresponding to the second voice input should be added to the first set of one or more words including a determination that the new word is a key word in accordance with the current context is a first context and displaying, via the display component, a second set of one or more words that includes the new word corresponding to the second voice input in the first manner while ceasing to display the first set of one or more words in the first manner in accordance with a determination that the second voice input includes the new word corresponding to the second voice input and that the new word corresponding to the second voice input should not be added to the first set of one or more words including a determination that the new word is not a key word in accordance with the determination that the current context is a second context enables the computer system to automatically add a new word to the set of one or more words and display a new set of one or more words when a determination is made that the new key word should be added to the set of one or more words using the context, thereby performing an operation when a set of conditions has been met without requiring further user input, reducing the number of inputs needed to perform an operation, and providing improved visual feedback to the user.

In some embodiments, a determination of whether the new word (e.g., 616, 620, and/or 628) corresponding to the second voice input (e.g., 606, 618, and/or 622) should be added to the first set of one or more words includes: in accordance with a determination that the new word (e.g., 616, 620, and/or 628) is relevant to a context (e.g., previous sets of one or more words, and/or the user) of the first set of one or more words, a determination is made that the new word (e.g., 616, 620, and/or 628) should be added to the first set of one or more words; and in accordance with a determination that the new word (e.g., 616, 620, and/or 628) is not relevant to the context of the first set of one or more words, a determination is made that the new word should not be added to the first set of one or more words. Displaying the new word corresponding to the second voice input with display of the first set of one or more words in the first manner in accordance with a determination that the second voice input includes a new word and that the new word corresponding to the second voice input should be added to the first set of one or more words including a determination that the new word is relevant to a context of the set of one or more words and displaying, via the display component, a second set of one or more words that includes the new word corresponding to the second voice input in the first manner while ceasing to display the first set of one or more words in the first manner in accordance with a determination that the second voice input includes the new word corresponding to the second voice input and that the new word corresponding to the second voice input should not be added to the first set of one or more words including a determination that the new word is not relevant to the context of the first set of one or more words enables the computer system to automatically add a new word to the set of one or more words that is relevant to the context of the set of one or more words and display a new set of one or more words when a determination is made that the new word should be added to the set of one or more words, thereby performing an operation when a set of conditions has been met without requiring further user input, reducing the number of inputs needed to perform an operation, and providing improved visual feedback to the user.

In some embodiments, while detecting the second voice input (e.g., 606, 618, and/or 622) (and, in some embodiments, and in accordance with a determination that the second voice input includes one or more new words (and, in some embodiments, not included in the first voice input) and that the one or more new words corresponding to the second voice input should be added to the first set of one or more words): at a first time, detecting a first portion of the second voice input (e.g., 606, 618, and/or 622); in response to detecting the first portion of the second voice input (e.g., 606, 618, and/or 622), displaying, via the display component, a word (e.g., 616, 620, and/or 628) corresponding to the first portion of the second voice input with the first set of one or more words (and, in some embodiments, in accordance with a determination that the word corresponding to the first portion of the second voice input should be added to the first set of one or more words); at a second time (e.g., after the first time), detecting a second portion, different from the first portion, of the second voice input (e.g., 606, 618, and/or 622); and in response to detecting the second portion of the second voice input (e.g., 606, 618, and/or 622), displaying, via display component, a word (e.g., 616, 620, and/or 628) corresponding to the second portion of the second voice input with the first set of one or more words (and, in some embodiments, in accordance with a determination that the word corresponding to the second portion of the second voice input should be added to the first set of one or more words) (e.g., concurrently with display of the word corresponding to the first portion of the second voice input with the first set of one or more words) (e.g., in the first manner). In some embodiments, the computer system changes the first set of one or more words in response to detecting the second voice input and/or while detecting the second voice input. In some embodiments, changing the first set of one or more words includes moving at least a word of the first set of one or more words, changing the first set of one or more words to the second set of one or more words, and/or adding the new word corresponding to the second voice input to the first set of one or more words. Displaying a word corresponding to the second portion of the second voice input with the first set of one or more words in response to detecting the second portion of the second voice input and displaying a word corresponding to the first portion of the second voice input with the first set of one or more words in response to detecting the first portion of the second voice input enables the computer system to automatically display words dynamically as the input is received, thereby performing an operation when a set of conditions has been met without requiring further user input, reducing the number of inputs needed to perform an operation, and providing improved visual feedback to the user.

In some embodiments, in accordance with a determination that the second voice input (e.g., 606, 618, and/or 622) has a first speed, the first time and the second time are separated by a first interval of time. In some embodiments, in accordance with a determination that the second voice input (e.g., 606, 618, and/or 622) has a second speed, different from the first speed, the first time and the second time are separated by a second interval of time different from the first interval of time. In some embodiments, the faster the voice input, the faster the words are displayed. In some embodiments, the slower the voice input, the slower the words are displayed. Displaying a word corresponding to the second portion of the second voice input with the first set of one or more words in response to detecting the second portion of the second voice input and displaying a word corresponding to the first portion of the second voice input with the first set of one or more words in response to detecting the first portion of the second voice input where the first time and the second time are separated by a first interval of time in accordance with a determination that the second voice input has a first speed and the first time and the second time are separated by a second interval of time in accordance with a determination that the second voice input has a second speed, different from the first speed enables the computer system to automatically display words at a dynamically at a speed based on the speed of the input, thereby performing an operation when a set of conditions has been met without requiring further user input, reducing the number of inputs needed to perform an operation, and providing improved visual feedback to the user.

In some embodiments, in accordance with a determination that the first portion of the second voice input (e.g., 606, 618, and/or 622) has a first set of one or more characteristics (e.g., pitch, tone, and/or volume), the word (e.g., 616, 620, and/or 628) corresponding to the first portion of the second voice input is a first size (e.g., text width and/or height). In some embodiments, in accordance with a determination that the first portion of the second voice input (e.g., 606, 618, and/or 622) has a second set of one or more characteristics (e.g., pitch, tone, and/or volume), different from the first set of one or more characteristics, the word (e.g., 616, 620, and/or 628) corresponding to the first portion of the second voice input is a second size different from the first size. In some embodiments, the louder a respective portion of the voice input, the bigger a word corresponding to the respective portion of the voice input.

In some embodiments, in accordance with a determination that the word (e.g., 616, 620, and/or 628) corresponding to the first portion of the second voice input (e.g., 606, 618, and/or 622) has a first relevance score with respect to the first set of one or more words, the word (e.g., 616, 620, and/or 628) corresponding to the first portion of the second voice input is displayed at a first position with respect to (e.g., in and/or relative to) the first set of one or more words. In some embodiments, in accordance with a determination that the word (e.g., 616, 620, and/or 628) corresponding to the first portion of the second voice input (e.g., 606, 618, and/or 622) has a second relevance score, different from the first relevance score, with respect to the first set of one or more words, the word corresponding to the first portion of the second voice input is displayed at a second position, different from the first position, with respect to (e.g., in and/or relative to) the first set of one or more words. In some embodiments, words displayed on top (and/or right and/or left) may be more/less relevant to a respective set of words than words displayed on bottom (and/or left and/or right).

In some embodiments, ceasing to display the first set of one or more words in the first manner includes removing display of the first set of one or more words.

In some embodiments, ceasing to display the first set of one or more words in the first manner includes displaying, via the display component, the first set of words in a second manner different from the first manner (e.g., as described above at FIGS. 6A-6D). In some embodiments, while displayed in the first manner, the first set of one or more words is more visually prominent and/or emphasized than the first set of one or more words is while the first set of one or more words is displayed in the second manner.

Note that details of the processes described above with respect to process 800 (e.g., FIG. 8) are also applicable in an analogous manner to the methods described below/above. For example, process 700 optionally includes one or more of the characteristics of the various methods described above with reference to process 800. For example, the new word can be added to a word cloud using one or more techniques of process 800 can be displayed in conjunction with moving to the second position using one or more techniques of process 700. For brevity, these details are not repeated below.

FIGS. 9A-9J illustrate exemplary user interface for controlling user interfaces in accordance with some embodiments. The user interfaces in these figures are used to illustrate the processes described below, including the processes in FIGS. 10-14.

FIGS. 9A-9J illustrate computer system 900 displaying different user interfaces as a tablet. It should be recognized that computer system 900 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 900 includes and/or is in communication with one or more sensors (e.g., one or more cameras, more or more LiDAR detectors, one or more motion sensors, one or more infrared sensors, and/or one or more microphones). In some embodiments, computer system 900 includes and/or is in communication with one or more output devices (e.g., a display screen, a projector, a touch-sensitive display, and/a speaker). In some embodiments, computer system 900 includes and/or is in communication with one or more movement components (e.g., an actuator, a moveable base, a rotatable component, and/or a rotatable base). In some embodiments, computer system 900 includes one or more components and/or features described above in relation to computer system 100 and/or electronic device 200.

FIGS. 9A-9J illustrate one or more scenarios where computer system 900 is used to review and/or recall a previous interaction. In some embodiments, a previous interaction includes a previous conversation that a user has had with computer system 900 and/or another user (e.g., where computer system 900 has recorded the previous conversation), a previous presentation that computer system 900 has given to a user and/or the user has given to computer system 900 concerning one or more topics, and/or a previous set of one or more inputs provided by a user along with a previous set of one or more outputs generated by computer system. In some cases, managing interactions involves a user utilizing a digital assistant of computer system 900. In some embodiments, the digital assistant is represented by an avatar, such as avatar 904. In some embodiments, computer system 900 updates avatar 904 to indicate to a user that computer system 900 is interacting with one or more users in the environment. For example, computer system 900 can update avatar 904, such that avatar 904 appears to be looking at, looking away from, talking to, nodding at, and/or motioning to one or more users in the environment. As illustrated in FIG. 9A, avatar 904 is a face having one or more human characteristics. In some embodiments, avatar 904 has a different appearance (e.g., different colors (e.g., sets of colors, flesh tones, reds, oranges, yellows, greens, blues, and/or purples), textures (e.g., skin, hair, fur, scales, plastic, glass, feathers, and/or wood), accessories (e.g., hat, glasses, monocle, wand, book, collar, bow, wings, halo, and/or crown), and/or face types (e.g., human, animal, anthropomorphized object, alien, non-descript face, fantasy creature, and/or a collection of objects that resemble a face)).

With regards to interactions, in some embodiments, the user provides verbal input or some other input, such as touch input, air gestures, and/or inputs to one or more hardware buttons to interact with computer system 900 and/or the digital assistant represented by avatar 904. In some embodiments, in response to detecting an input, an interaction is initiated with the digital assistant provided by computer system 900. While an interaction is ongoing, computer system 900 can display content and provide one or more audio and/or haptic outputs to interact with the user, such as walking a user through trip details and/or answering one or more questions from the user. In some embodiments, the interaction that takes place between computer system 900 and the user can be stored and recalled at a later time via the detection of one or more inputs by a user. In some embodiments, in response to detecting one or more inputs from the user, such as a verbal input, computer system 900 displays a summary of a previous interaction. In some embodiments, the summary is dynamically generated with audio output, where computer system 900 provides an interactive overview of the previous interaction. In some embodiments, the summary can include one or more content items (e.g., applications, and/or media items) used to complete a task concerning the previous interaction and/or one or more other highlights, such as relevant content, updated content, and/or content that was not originally included in the previous interaction.

In some embodiments, a verbal request to discuss a previous interaction can be an explicit (e.g., clear, definitive) request. For example, a user can audibly state, “Show me music recommendations again,” or “Do you remember our conversation about music yesterday?” (e.g., a statement directly related to a previous interaction intended to recall a previous interaction). In some embodiments, a verbal request to discuss a previous interaction can be an implicit request. For example, a user can audibly state, “Your music recommendations earlier were good” (e.g., a statement loosely related to a previous interaction not necessarily intended to recall a previous interaction). At FIG. 9A, computer system 900 detects verbal input 905a (e.g., “What should I watch?”). In some embodiments, computer system 900 detects one or more other types of inputs, such as tap inputs, air gestures, mouse clicks, and/or gaze inputs, and performs similar techniques to the verbal inputs described herein, such as verbal input 905a.

As illustrated in FIG. 9B, in response to detecting verbal input 905a, computer system 900 reduces the size of avatar 904 and displays first content item 906 (e.g., “First movie”) (e.g., a movie recommendation). As illustrated in FIG. 9B, computer system 900 displays avatar 904 in the top left corner facing towards (e.g., looking at) first content item 906 as computer system 900 presents (e.g., introduces, describes) first content item 906 (e.g., avatar 904 can face a content item and/or a category as an indication that computer system 900 is presenting (e.g., focusing on and outputting an audio description corresponding to) that content item and/or category). In some embodiments, if computer system 900 detects a touch input, in response to detecting a touch input, computer system 900 can display a content item at a location where the touch input was detected. For example, if a touch input is detected in the top right corner, computer system 900 can display a content item and/or category in the top right corner. At FIG. 9B, computer system 900 outputs an audible description corresponding to first content item 906.

In some embodiments, if an input is detected to be directed to a content item and/or a category, in response to detecting an input, computer system 900 can cease to display any other content items and/or categories displayed. For example, in a scenario where computer system 900 detects an input directed to a first content item, in response to detecting an input, computer system 900 can cease to display a second content item that is displayed in tandem with a first content item.

As illustrated in FIG. 9C, computer system 900 displays second content item 908 (e.g., “Second movie”) (e.g., a movie recommendation) automatically without detecting an additional input after detecting verbal input 905a. In addition, computer system 900 outputs an audible description corresponding to the second content item and ceases to output the audible description corresponding to the first content item. To display second content item 908 at a central location on the user interface, computer system 900 moves first content item 906 to the top left corner and avatar 904 to the bottom left corner. In this example, computer system 900 attempts to display content items that are currently being discussed (e.g., that audio is being output for) at a central location on the user interface and other items (e.g., previous discussed content items) at other locations on the user interface. In some embodiments, displaying content items at the central location that are currently being discussed allows a user to focus those items as compared to content items that are not displayed at the central location.

Additionally, at FIG. 9C, computer system 900 dynamically moves avatar 904 as different content items are displayed. As illustrated in FIG. 9C, computer system 900 ceases displaying avatar 904 as facing towards first content item 906 and displays avatar 904 as facing towards second content item 908. In some embodiments, avatar 904 can be updated to stop facing towards old content items and/or categories to face towards new content items and/or categories as computer system 900 presents (e.g., via audio output) second content item 908. Accordingly, at FIG. 9C, avatar 904 appears to be facing towards second content item 908 because computer system 900 is outputting audio corresponding to second content item 908. In some embodiments, as new content items and/or categories are displayed, avatar 904 is updated to appear to face towards the new content items and/or categories before moving. In some embodiments, as new content items and/or categories are displayed, avatar 904 is updated to appear to face towards the new content items and/or categories while moving. In some embodiments, as new content items and/or categories are displayed, avatar 904 is updated to appear to face towards the new content items and/or categories after moving.

In some embodiments, computer system 900 can display avatar 904 on different sides of content items and/or categories. For example, if a music content item is displayed, computer system 900 can display avatar 904 above, below, to the right of, to the left of, on top of, behind, and/or at an angle to the content item and/or category. In some embodiments, computer system 900 does not display avatar 904 in the same placement for different content items and/or categories. For example, if avatar 904 is displayed on the right side of a music category, computer system 900 can display avatar 904 below a photo category. In some embodiments, avatar 904 can face towards or away from a user (e.g., avatar 904 can look back and forth between the user and the content item that computer system 900 is currently presenting). In some embodiments, after a predetermined amount of time, computer system 900 updates avatar 904, such that avatar 904 appears to stop facing towards a content item and/or a category. In this instance, avatar 904 can appear to look in the direction of a user and/or the environment. In some embodiments, once avatar 904 appears to stop facing towards a content item and/or a category, avatar 904 will not look back at the content item and/or category until computer system 900 outputs audio corresponding to the particular item and/or after a predetermined period of time.

As illustrated in FIG. 9D, computer system 900 displays third content item 910 (e.g., “First TV show”) (e.g., a TV show recommendation). Additionally, computer system 900 displays category 950 (e.g., a category corresponding to movie content items). Computer system 900 displays second content item 908 as overlapping first content item 906 within category 950. Computer system 900 overlaps first content item 906 and second content item 908 because a determination is made that first content item 906 and second content item 908 are in the same category of items (e.g., “movies”). In some embodiments, computer system 900 can visually group content without overlapping. For example, instead of overlapping, computer system 900 can display content items belonging to the same category next to each other (e.g., along a shared edge) and/or can display content items belonging to the same category in a certain arrangement. At FIG. 9D, computer system 900 ceases outputting an audible description corresponding to second content item 908 and outputs an audible description corresponding to third content item 910. As illustrated in FIG. 9D, computer system 900 displays avatar 904 as facing towards third content item 910 as it presents third content item 910.

Further explanation on the purposes of categories may be useful for understanding. Computer system 900 can display similar content (e.g., as defined by a computer system and/or by user input) within a category (e.g., a grouping of content). In an instance where multiple content items are placed within the same category, computer system 900 can visually group (e.g., overlap) them as a method of structure (e.g., order and/or organization) to communicate similarity. In some embodiments, if a new content item is added to an interaction with a preexisting category or if the new content item is the same as the content items in the existing category, computer system 900 can display the new content item within the category (e.g., overlapping the other content items in the category). For example, if a music video category exists and a new music video content item is introduced, computer system 900 can automatically display the new music video content item within the existing music video category (e.g., overlapping the content items already displayed within the category). In some embodiments, if a new content item is added to an interaction with a preexisting category or if the new content item is not the same as the content items in the existing category, computer system 900 can display the new content item within a new category. For example, if a music video category exists and a photo content item is introduced, computer system 900 can automatically create and display the new photo content item within a new photo category. In some embodiments, computer system 900 can display a source indicator (e.g., an indicator displaying the source of the content item) corresponding to a content item. For example, if a movie content item is only available on a certain streaming service, computer system 900 can display a source indicator to indicate that information to a user.

In some embodiments, while outputting audio descriptions corresponding to the displayed content items, computer system 900 can display new content items and visually group them based on existing categories. For example, if a movies category exists and a new movie content item is displayed, computer system 900 can automatically categorize the new movie content item within the existing movies category as it outputs and audio description.

In some embodiments, computer system 900 can visually group content items after ceasing to output audio descriptions corresponding to the content item. For example, once computer system 900 ceases outputting an audio description for a movie content item, computer system 900 can visually group the movie content item with one or more other movie content items. In some embodiments, computer system 900 can visually group content items while outputting an audio description corresponding to the content item. For example, while computer system 900 outputs an audio description for a movie content item, computer system 900 can visually group the movie content item with one or more other movie content items. In some embodiments, when an interaction is started, content is not visually grouped. In this instance, the content can be grouped after a user finishes the interaction. In another instance, the content can be grouped while the user is still engaged in the interaction.

In some embodiments, computer system 900 does not visually group all displayed content items. For example, if there are two movie content items, three music content items, and one application content item displayed, computer system 900 can visually group the movie content items into a category and the music content items into a category and not group the application content item into a category.

In some embodiments, at least one content item can be visually grouped with another content item. For example, if two music content items are displayed in tandem with one video content item, computer system 900 can display a category for the two music content items. In some embodiments, at least one content item will not be visually grouped. For example, if there are two movie content items, computer system 900 does not have to group them into one category. This can occur if computer system 900 is grouping based on a different feature other than media type and/or content type (e.g., genre, runtime, time period, and/or fan reception). While the previous example uses movies as an example, it should be recognized that this is merely an example and techniques described herein can work with other content items and/or content types.

As illustrated in FIG. 9E, computer system 900 displays category 950 (e.g., a category corresponding to movie content items) and category 952 (e.g., a category corresponding to television show content items). Category 950 includes first content item 906 and second content item 908. Category 952 includes third content item 910 and fourth content item 912 (e.g., a TV show recommendation). As illustrated in FIG. 9E, computer system 900 displays avatar 904 in the middle right of user interface 902. At FIG. 9E, computer system 900 outputs an audible description corresponding to fourth content item 912. At FIG. 9E, computer system 900 detects verbal input 905e (e.g., “What should I listen to?”), which interrupts the output of the audio description corresponding to fourth content item 912. In some embodiments, an interruption occurs when a user speaks (e.g., directs a verbal input to computer system 900) while computer system 900 is outputting an audio description (e.g., the user speaks over computer system 900). In some embodiments, an interruption occurs when a user speaks while computer system 900 “takes a breath” or where there is a natural pause in the output of an audio description.

At FIG. 9E, computer system 900 updates avatar 904, such that avatar 904 appears to look away from one or more content items to look at the environment and/or a user in the environment. Computer system 900 updates avatar 904 at FIG. 9E to indicate that computer system 900 is listening to a user in the environment that caused the interruption. In other words, computer system 900 updates avatar 904 to indicate that computer system 900 is listening. In some embodiments, computer system 900 zooms out of the user interface when an interruption is detected. In some embodiments, computer system 900 can zoom out of the user interface even when an interruption is not detected, such as computer system 900 detecting that the interaction has been completed. In some embodiments, computer system 900 can change the user interface in other ways than zooming out of content when an interruption is detected, such as fading out content on the user interface, zooming into content on the user interface, ceasing to display content of the user interface, changing the color of content of the user interface, increasing the opacity of content of the user interface, displaying an indication, and/or moving content on the user interface. It should be understood that, while an interruption was discussed as being detected in response to detecting a verbal input, other types of inputs can cause an interruption to be detected, such as an air gesture that is detected while the computer system is outputting an audio description and/or detecting that a user has been gazing away from computer system 900 for longer than a period of time.

In some embodiments, if no response is required to the interruption, computer system 900 can re-display the user interface of FIG. 9D (e.g., the user interface that was displayed before the interruption). For example, if a user creates an incomprehensible interruption (e.g., an interruption that computer system 900 cannot and/or does not understand), such as a loud noise and/or an incomprehensible verbal input, computer system 900 can revert back to displaying the user interface that was displayed before the interruption occurred.

In some embodiments, if computer system 900 detects an interruption corresponding to the content item and/or category that computer system 900 is outputting an audio description for, computer system 900 will not display the interaction in a second manner (e.g., a zoomed-out manner). For example, if computer system 900 outputs an audio description corresponding to a movie content item, if an interruption corresponding to the movie content item is detected, computer system 900 will not display the interaction in a second manner (e.g., computer system 900 can continue to display the interaction in a first manner).

In some embodiments, after displaying an interaction in a second manner in response to an interruption, if computer system 900 detects an interruption corresponding to a first content item and/or category, computer system 900 can display the interaction in the first manner. For example, if the first content is a music content item, if computer system 900 is displaying an interaction, if computer system 900 detects an interruption corresponding to the music content item, computer system 900 will cease to display the interaction in the second manner and can display the interaction in the first manner. If computer system 900 displays an interaction, if computer system 900 detects an interruption not corresponding to the music content item, computer system 900 can continue to display the interaction in the second manner. In some embodiments, if computer system 900 is outputting an audio description corresponding to a first content item and an interruption is detected, computer system 900 will begin outputting an audio description corresponding to a second content item. For example, if computer system 900 is outputting an audio description corresponding to a movie content item and an interruption is detected, computer system 900 will output an audio description corresponding to a music content item. In some embodiments, if computer system 900 is outputting an audio description corresponding to a first content item and no interruption is detected, computer system 900 will continue to output an audio description corresponding to a first content item. Looking back at FIG. 9E, computer system 900 detected verbal input 905e and determined that verbal input 905e is a request that required a response.

As illustrated in FIG. 9F, in response to detecting verbal input 905e, computer system 900 visually overlaps the movie and television content items within category 954 (e.g., a category containing different content types). In addition, computer system 900 displays fifth content item 914 (e.g., first song) (e.g., a song recommendation). In some embodiments, computer system 900 ceases to display the movie and television content items because of a determination that the movie and television content items are from a different interaction than the interaction corresponding to the song content item. For example, “What should I listen to?” is a different interaction than “What should I watch?” in some embodiments.

As illustrated in FIG. 9G, in response to detecting verbal input 905e, computer system 900 ceases to display movie and television content items (e.g., category 954) because of a determination that the movie and television content items are from a different interaction than the interaction corresponding to the song content item. In response to detecting verbal input 905e, computer system 900 displays sixth content item 916 (e.g., “Second song”) (e.g., a song recommendation) below fifth content item 914. As illustrated in FIG. 9G, computer system 900 displays avatar 904 as facing towards sixth content item 916 as it presents sixth content item 916. Notably, at FIG. 9G, the song content items are in a different configuration than the television and movie content items were because different interactions can have different layouts and/or configurations of content items.

At FIG. 9G, computer system 900 detects verbal input 905g (e.g., “What should I watch again?”). As illustrated in FIG. 9H, in response to detecting verbal input 905g, computer system 900 creates category 956 (e.g., a category corresponding to song content items). Category 956 includes fifth content item 914 and sixth content item 916. In addition, computer system 900 shrinks the display of fifth content item 914 and sixth content item 916 to make room for content corresponding to a previous interaction. As illustrated in FIG. 9H, in response to detecting verbal input 905g, computer system 900 recalls and displays content from a previous interaction. (e.g., previous content corresponding to the verbal request of “What should I watch?” (e.g., as seen in FIGS. 9A-9E)). In some embodiments, computer system 900 displays category 950 (e.g., visually groups first content item 906 and second content item 908) in the same manner as in the previous interaction at FIGS. 9A-9E and category 952 (e.g., visually groups third content item 910 and fourth content item 912) in the same manner as in the previous interaction) at FIGS. 9A-9E. In some embodiments, computer system 900 displays the content from a previous interaction in the same manner as it was displayed while the previous interaction was ongoing.

As illustrated in FIG. 9H, in response to detecting verbal input 905g, computer system 900 displays seventh content item 918 (e.g., “First service”) (e.g., an application containing the media corresponding to second content item 908) to the right of category 950 and eighth content item 920 (e.g., “Second service”) (e.g., an application containing the media corresponding to fourth content item 912) to the right of category 952. Accordingly, in response to detecting input 905h, computer system 900 adds new relevant content corresponding to the previous content to the interaction summary. In some embodiments, if there is no new relevant content to display, computer system 900 will not display any new content. In some embodiments, computer system 900 can display new content items and/or categories in an orientation that allows the new content items and/or categories to fit around the old content items and/or categories. In some embodiments, computer system 900 displays old content items of the previous interaction in a different configuration when new content is added than the old content items were displayed when new content is not added items. Additionally, computer system 900 displays avatar 904 in the bottom right corner looking at one or more of the new content items.

At FIG. 9H, in response to detecting verbal input 905g, computer system 900 outputs an audible description corresponding to first content item 906 (e.g., computer system 900 automatically displays and describes content items corresponding to the previous interaction in order of their display). In some embodiments, computer system 900 can cease to display a content item once an audio description corresponding to that content item has been output. For example, in FIG. 9H, in the instance where computer system 900 ceases outputting an audio description for first content item 906, computer system 900 can cease to display first content item 906. In some embodiments, computer system 900 can cease to display content items in a category of content items once an audio description corresponding to the majority of content items within the category has been output. For example, in FIG. 9I, in the instance where computer system 900 ceases outputting an audio description for first content item 906 and second content item 908, in response, computer system 900 can cease to display category 950 (e.g., the first content item 906 and second content item 908). At FIG. 9H, computer system 900 detects verbal input 905h1, (e.g., “Remember your listening recommendation? Do you have any more?”). In some embodiments, in response to detecting verbal input 905h1, computer system 900 displays avatar 904 as facing the user.

At FIG. 9H, computer system 900 detects tap input 905h2 directed to second content item 908 (e.g., displayed content items can be interactive). In response to detecting tap input 905h2, computer system 900 displays a user interface corresponding to the application and/or initiates a playback of the media corresponding to second content item 908. At FIG. 9H, computer system 900 detects tap input 905h3 directed to seventh content item 918. In response to detecting tap input 905h3, computer system 900 displays a user interface corresponding to the application and/or outputs an audio description corresponding to seventh content item 918. In some embodiments, in response to detecting an input directed to a content item and/or a category, computer system 900 can output an audio description corresponding to the contents of the content item and/or category. In some embodiments, if computer system 900 displays a user interface in response, other displayed content items and/or categories can be displayed in tandem. For example, if computer system 900 displays an application content item and a movie category and computer system 900 displays a user interface corresponding to the application content item, computer system 900 can display the movie category in tandem with the application item user interface. In some embodiments, if computer system 900 is displaying content corresponding to a content item and/or a category, a user can exit the content and return to an interaction summary (e.g., via an input (e.g., a touch gesture, an air gesture, and/or a verbal input)). For example, if computer system 900 is displaying a photo user interface (e.g., a user interface corresponding to a photo content item displayed in an interaction summary), a user can direct an input to the photo user interface. In response to detecting this input, computer system 900 can cease to display the photo user interface and return to the interaction summary. In some embodiments, if an input is detected to be directed to a content item, in response to detecting an input, computer system 900 can cease to display all other content items and/or categories. If computer system 900 detects an input directed to the movie content item, in response to detecting the input, computer system 900 will cease to display the category corresponding to music content items. In some embodiments, if no input is detected to be directed to a content time and/or category, computer system 900 can continue to display content items and/or categories. Thus, when looking at the discussion of detecting inputs 905h1-905h3, computer system 900 provides a user with the ability to obtain further details and/or perform one or more operations that are specific to a particular content item.

As illustrated in FIG. 9I, in response to detecting verbal input 905h1 (e.g., a verbal request to continue an old interaction with new content), computer system 900 ceases to display seventh content item 918, and eighth content item 920. As illustrated in FIG. 9I, computer system 900 displays category 956. Category 956 includes content from previous interaction (e.g., the previous content as seen in FIG. 9H) (e.g., fifth content item 914 and sixth content item 916 (e.g., in response to verbal input 905h1 (e.g., a request for more music content), computer system 900 displays the previous content in category 956 to make room for new content)). As illustrated in FIG. 9I, in response to detecting verbal input 905h1, computer system 900 displays ninth content item 922 (e.g., “Third Song”) (e.g., a song recommendation) below category 956. As illustrated in FIG. 9I, computer system 900 displays avatar 904 as facing towards ninth content item 922 as it presents ninth content item 922. At FIG. 9I, computer system 900 outputs an audible description corresponding to ninth content item 922 (e.g., in response to a verbal request to continue an old interaction with new content, computer system 900 can automatically display (e.g., roll out, present) and output an audio description corresponding to content items and/or categories (e.g., without user input). At FIG. 9I, computer system 900 detects verbal input 905i (e.g., “Tell me about my Portugal vacation.”).

As illustrated in FIG. 9J, in response to detecting verbal input 905i, computer system 900 ceases to display category 950, category 952, category 956 and ninth content item 922. As illustrated in FIG. 9J, in response to detecting verbal input 905i, computer system 900 displays content from a previous interaction. As illustrated in FIG. 9J, computer system 900 displays interaction indicator 990 (e.g., “Portugal Vacation”), category 958 (e.g., a category corresponding to music content played on the Portugal vacation), category 960 (e.g., a category corresponding to travel content used on the Portugal vacation), category 962 (e.g., a category corresponding to location content used on the Portugal vacation), and fourteenth content item 932 (e.g., “Airline tickets”) (e.g., computer system 900 can display a content item from a previous interaction that is not visually grouped in a category).

Category 958 includes tenth content item 924 (e.g., “Mageman”) (e.g., a song played on the Portugal vacation) and eleventh content item 626 (e.g., “Fado”) (e.g., a song played on the Portugal vacation). Category 960 includes twelfth content item 928 (e.g., “Train”) (e.g., a travel application for trains used on the Portugal vacation) and thirteenth content item 930 (e.g., “Car”) (e.g., a car rental application used on the Portugal vacation) (e.g., computer system 900 can concurrently display content items corresponding to different applications within the same category). Category 962 includes fifteenth content item 934 (e.g., “Porto”) (e.g., an information application with information covering Porto, a city in Portugal, used on the Portugal vacation) and sixteenth content item 936 (e.g., “Lisbon”) (e.g., an information application with information covering Lisbon, the capital city of Portugal, used on the Portugal vacation).

In some embodiments, if an input is detected to be directed to a content item and/or a category, in response to detecting an input, computer system 900 can initiate an operation to be performed for the content item and/or a category. For example, if computer system 900 detects an input directed to thirteenth content item 930, in response to detecting an input, computer system 900 can initiate a car rental operation.

In some embodiments, when content items from a previous interaction are recalled and displayed, computer system 900 can display content items corresponding to a “parent category” (e.g., a category acting as an origin for additional content) in response to an input directed to a category. For example, a scenario where a user issues a request to recall a previous interaction corresponding to their Portugal vacation (e.g., as illustrated in FIG. 9I). In this instance, if a user directs a tap input to category 962 (e.g., more specifically, to sixteenth content item 936 (e.g., “Lisbon”)) (e.g., a parent category corresponding to locations in Portugal), in response to detecting a tap input, computer system 900 can display additional content items corresponding to (e.g., related to, stemming from) sixteenth content item 936 (e.g., “Lisbon”). For example, computer system 900 can display an article content item (e.g., an article covering the best places to eat in Lisbon), a news content item (e.g., a news story corresponding to Lisbon), and/or a photo content item (e.g., a display of landmarks seen in Lisbon) (e.g., all “child” categories related to (e.g., deriving from, originating from) the “parent category” of category 962).

In some embodiments, if a new content item and/or category is displayed in response to a verbal request to continue an old interaction with new content, computer system 900 can output an audio description for the new content item and/or category before outputting an audio description for an old content item and/or category (e.g., that was displayed in the previous interaction). In some embodiments, after describing a new content item and/or category (e.g., in response to a verbal request to continue an old interaction with new content), computer system 900 can output an audio description for old content items and/or categories. In some embodiments, if a new content item and/or category is displayed in response to a verbal request to continue an old interaction with new content, computer system 900 can output an audio description for an old content item and/or category before outputting an audio description for the new content item and/or category. In some embodiments, if a new content item and/or category is displayed in response to a verbal request to continue an old interaction with new content, computer system 900 can output a shorter description for old content items and/or categories and a longer audible description for a new content item and/or category (e.g., computer system 900 makes a determination that the old content items and/or categories have already been described (e.g., the old content items and/or categories are part of a previous interaction) and opts to describe the new content items and/or categories in greater detail).

In some embodiments, in response to a verbal request to continue an old interaction with new content, computer system 900 does not display old content in categories. For example, a scenario where an old interaction included two movie content items. If computer system 900 detects a verbal request to continue an old interaction with new content, computer system 900 can display the two movie content items outside of a category, along with the new content item.

In some embodiments, if new content items and/or categories are displayed in response to a verbal request to continue an old interaction with new content, computer system 900 can add the new content items and/or categories to a preexisting category. For example, if a new music content item is displayed, if a preexisting music category is displayed in response to a verbal request to continue an old interaction with new content, computer system 900 can add the new music content item to the preexisting music category (e.g., the new music category item overlaps the other music category items in the music category).

In some embodiments, if new content items and/or categories are displayed in response to a verbal request to continue an old interaction with new content, computer system 900 will not add the new content items and/or categories to a preexisting category if the new content items and/or categories do not fit within the preexisting categories. For example, if a new music content item is displayed, if a preexisting movie category is displayed in response to a verbal request to continue an old interaction with new content, computer system 900 will not add the new music content item to the preexisting movie category (e.g., the new music category item does not overlap the other content items in the music category).

FIG. 10 is a flow diagram illustrating a method for grouping content using a computer system in accordance with some embodiments. Process 1000 is performed at a computer system (e.g., 100, 200, and/or 900). Operations in process 1000 are, optionally, combined, the orders of some operations are, optionally, changed, and some operations are, optionally, omitted.

As described below, process 1000 provides an intuitive way for grouping content. The method reduces the cognitive burden on a user for grouping content, thereby creating a more efficient human-machine interface. For battery operated computing devices, enabling a user to group content faster and more efficiently conserves power and increases the time between battery charges.

In some embodiments, process 1000 is performed at a computer system (e.g., 900) that is in communication with a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system detects (1002), via the one or more input devices, an input (e.g., 905a, 905e, 905h, 905i1, 905i2, 905i3, and/or 905j) (e.g., a tap input and/or a non-tap input (e.g., a verbal input, an audible request, an audible command, an audible statement, a swipe input, a hold-and-drag input, a gaze input, an air gesture, and/or a mouse click)) corresponding to a user (e.g., a person, an animal, an object, and/or a first computer system (e.g., different from the computer system)).

In conjunction with (e.g., after and/or in response to) detecting the input (e.g., 905a, 905e, 905h, 905i1, 905i2, 905i3, and/or 905j) corresponding to the user, the computer system displays (1004), via the display component, a representation of a first portion of content (e.g., 906, 908, 910, 912, 914, 916, 918, 920, 922, 924, 926, 928, 930, 932, 934, and/or 936) related to (e.g., corresponding to, associated with, that is a reply to, and/or that is an answer to) the input and a representation of a second portion of content (e.g., 906, 908, 910, 912, 914, 916, 918, 920, 922, 924, 926, 928, 930, 932, 934, and/or 936) related to the input, including: (1006) in accordance with a determination that the first portion of content (e.g., 906, 908, 910, 912, 914, 916, 918, 920, 922, 924, 926, 928, 930, 932, 934, and/or 936) is in a first category of content (e.g., classification of items based on shared characteristics, classification of items based on different characteristics, group, class, and/or type) and the second portion of content (e.g., 906, 908, 910, 912, 914, 916, 918, 920, 922, 924, 926, 928, 930, 932, 934, and/or 936) (e.g., different from (e.g., not inclusive of, not the same of, not encompassing, and/or not encompassed by) the first portion of content) is in the first category of content, visually grouping the representation of the first portion of content and the representation of the second portion of content (e.g., as described above at FIGS. 9D-9E) (e.g., a portion of the representation of the first portion of content overlaps a portion of the representation of the second portion of content) (e.g., a portion of the representation of the second portion of content overlaps a portion of the representation of the first portion of content) (e.g., the representation of the first portion of content is displayed adjacent to and/or within a predefined distance from the representation of the second portion of content) (e.g., the representation of the first portion of content and the representation of the second portion of content are displayed in an area corresponding to the first category of content); and in accordance with (1008) a determination that the first portion of content (e.g., 906, 908, 910, 912, 914, 916, 918, 920, 922, 924, 926, 928, 930, 932, 934, and/or 936) is in the first category of content and the second portion of content (e.g., 906, 908, 910, 912, 914, 916, 918, 920, 922, 924, 926, 928, 930, 932, 934, and/or 936) is in a second category of content different from the first category of content, forgoing visually grouping the representation of the first portion of content and the representation of the second portion of content (e.g., displaying the representation of the first portion of content without visually grouping the representation of the first portion and the representation of the second portion) (e.g., displaying the representation of the second portion of content without visually grouping the representation of the first portion and the representation of the second portion). Visually grouping the representation of the first portion of content and the representation of the second portion of content in accordance with a determination that the first portion of content and the second portion of content are both in the first category of content enables a computer system to indicate content that is in the same category, thereby providing improved visual feedback to the user and/or performing an operation when a set of conditions has been met without requiring further user input.

In some embodiments, the input includes the first portion of content and/or the second portion of content. In some embodiments, the input does not include the first portion of content and/or the second portion of content. In some embodiments, the input corresponding to the user is a first input. In some embodiments, before detecting the first input, the computer system detects a second input corresponding to the user. In some embodiments, the second input includes the first portion of content and/or the second portion of content. In some embodiments, the representation of the first portion of content is the same size as the representation of the second portion of content. In some embodiments, the representation of the first portion of content is a different size (e.g., bigger and/or smaller than) than the representation of the second portion of content.

In some embodiments, the input (e.g., 905a, 905e, 905h, 905i1, 905i2, 905i3, and/or 905j) is (and/or includes) a verbal input (e.g., voice command, auditory input, oral input, spoken language, and/or spoken input). Visually grouping the representation of the first portion of content and the representation of the second portion of content in response to detecting verbal input enables a computer system to indicate content that is in the same category as a response to detecting verbal input, thereby providing improved visual feedback to the user and/or performing an operation when a set of conditions has been met without requiring further user input.

In some embodiments, while displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936), the computer system displays, via the display component, a representation of a third portion of content (e.g., 906, 908, 910, 912, 914, 916, 918, 920, 922, 924, 926, 928, 930, 932, 934, and/or 936), wherein the representation of the third portion of content is different from the representation of the first portion of content and the representation of the second portion of content, wherein displaying the representation of the third portion of content includes: in accordance with a determination that the first portion of content (e.g., 906, 908, 910, 912, 914, 916, 918, 920, 922, 924, 926, 928, 930, 932, 934, and/or 936) is in the first category of content, the second portion of content (e.g., 906, 908, 910, 912, 914, 916, 918, 920, 922, 924, 926, 928, 930, 932, 934, and/or 936) is in the first category of content, and the third portion of content (e.g., 906, 908, 910, 912, 914, 916, 918, 920, 922, 924, 926, 928, 930, 932, 934, and/or 936) is in the first category of content, visually grouping the representation of the first portion of content, the representation of the second portion of content, and the representation of the third portion of content; in accordance with a determination that the first portion of content (e.g., 906, 908, 910, 912, 914, 916, 918, 920, 922, 924, 926, 928, 930, 932, 934, and/or 936) is in the first category of content, the second portion of content (e.g., 906, 908, 910, 912, 914, 916, 918, 920, 922, 924, 926, 928, 930, 932, 934, and/or 936) is in the second category of content, and the third portion of content (e.g., 906, 908, 910, 912, 914, 916, 918, 920, 922, 924, 926, 928, 930, 932, 934, and/or 936) is in the first category of content, visually grouping the representation of the first portion of content and the representation of the third portion of content without visually grouping the representation of the second portion of content and the representation of the third portion of content and without visually grouping the representation of the first portion of content and the representation of the second portion of content; and in accordance with a determination that the first portion of content (e.g., 906, 908, 910, 912, 914, 916, 918, 920, 922, 924, 926, 928, 930, 932, 934, and/or 936) is in the first category of content, the second portion of content (e.g., 906, 908, 910, 912, 914, 916, 918, 920, 922, 924, 926, 928, 930, 932, 934, and/or 936) is in the second category of content, and the third portion of content (e.g., 906, 908, 910, 912, 914, 916, 918, 920, 922, 924, 926, 928, 930, 932, 934, and/or 936) is in the second category of content, visually grouping the representation of the second portion of content and the representation of the third portion of content without visually grouping the representation of the second portion of content and the representation of the first portion of content and without visually grouping the representation of the first portion of content and the representation of the third portion of content (e.g., as described above at FIGS. 9D-9E). Visually grouping representations of content that is in the same category and separating representations of other content from this group representations of content in the same category enables a computer system to indicate how different content corresponds to each other, thereby providing improved visual feedback to the user and/or performing an operation when a set of conditions has been met without requiring further user input.

In some embodiments, while displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936) and while the representation of the first portion of content is not visually grouped with the representation of the second portion of content, the computer system displays, via the display component, a representation of a fourth portion of content (e.g., 906, 908, 910, 912, 914, 916, 918, 920, 922, 924, 926, 928, 930, 932, 934, and/or 936), wherein the representation of the fourth portion of content is different from the representation of the first portion of content and the representation of the second portion of content, wherein displaying the representation of the fourth portion of content includes: in accordance with a determination that the fourth portion of content (e.g., 906, 908, 910, 912, 914, 916, 918, 920, 922, 924, 926, 928, 930, 932, 934, and/or 936) is in the same category of content as the first portion of content, visually grouping the representation of the fourth portion of content and the representation of the first portion of content; in accordance with a determination that the fourth portion of content (e.g., 906, 908, 910, 912, 914, 916, 918, 920, 922, 924, 926, 928, 930, 932, 934, and/or 936) is in the same category of content as the second category of content, visually grouping the representation of the fourth portion of content and the representation of the second portion of content; and in accordance with a determination that the fourth portion of content (e.g., 906, 908, 910, 912, 914, 916, 918, 920, 922, 924, 926, 928, 930, 932, 934, and/or 936) is in a different category of content than the first portion of content and the second portion of content: forgoing visually grouping the representation of the fourth portion of content (e.g., 906, 908, 910, 912, 914, 916, 918, 920, 922, 924, 926, 928, 930, 932, 934, and/or 936) and the representation of the first portion of content (e.g., displaying the representation of the fourth portion of content without visually grouping the representation of the fourth portion and the representation of the first portion); and forgoing visually grouping the representation of the fourth portion of content (e.g., 906, 908, 910, 912, 914, 916, 918, 920, 922, 924, 926, 928, 930, 932, 934, and/or 936) and the representation of the second portion of content (e.g., as described above at FIGS. 9D-9E) (e.g., displaying the representation of the fourth portion of content without visually grouping the representation of the fourth portion and the representation of the second portion). Visually grouping a representation of content with content that corresponds to the same category of the representation of content enables a computer system to indicate how different content corresponds to each other, thereby providing improved visual feedback to the user and/or performing an operation when a set of conditions has been met without requiring further user input.

In some embodiments, the representation of the second portion is a first representation of the second portion. In some embodiments, before visually grouping the representation of the first portion of content (e.g., 906, 908, 910, 912, 914, 916, 918, 920, 922, 924, 926, 928, 930, 932, 934, and/or 936) and the first representation of the second portion of content (e.g., 906, 908, 910, 912, 914, 916, 918, 920, 922, 924, 926, 928, 930, 932, 934, and/or 936), the computer system displays, via the display component, a second representation of the second portion of content not visually grouped with the representation of the first portion of content. In some embodiments, after displaying the second representation of the second portion of content, the computer system visually transitioning the second representation of the second portion of content to be the first representation of the second portion (e.g., moving and/or shrinking the second representation of the second portion of content to be visually grouped with the representation of the first portion of content). Displaying a second representation of the second portion of content not visually grouped with the representation of the first portion of content before visually grouping the representation of the first portion of content and the first representation of the second portion of content enables a computer system to separately display different content before visually grouping such content, allowing such content to be displayed away from each other before being visually grouped, thereby providing improved visual feedback to the user and/or reducing the number of inputs needed to perform an operation.

In some embodiments, displaying the second representation of the second portion of content (e.g., 906, 908, 910, 912, 914, 916, 918, 920, 922, 924, 926, 928, 930, 932, 934, and/or 936) not visually grouped with the representation of the first portion of content (e.g., 906, 908, 910, 912, 914, 916, 918, 920, 922, 924, 926, 928, 930, 932, 934, and/or 936) includes displaying, via the display component, the second representation of the second portion of content without overlapping and without being overlapped by a user-interface element (e.g., as described above at FIGS. 9D-9G) (e.g., a representation of a portion of content and/or another user-interface element).

In some embodiments, the first representation of the second portion is a second size smaller than the first size. In some embodiments, after initially displaying the second representation of the second portion, the computer system displays, via the display component, an animation transitioning the second representation of the second portion to become the first representation of the second portion by shrinking the second representation of the second portion (e.g., as described above at FIGS. 9E-9F). Shrinking the second representation of the second portion after initially displaying the second representation of the second portion enables a computer system to visually indicate how content is related while reducing de-emphasizing certain content at a particular time, thereby providing improved visual feedback to the user and/or reducing the number of inputs needed to perform an operation.

In some embodiments, the second representation of the second portion is initially displayed at a first location, and wherein the first representation of the second portion is displayed at a second location different from the first location. In some embodiments, after initially displaying the second representation of the second portion at the first location, the computer system displays, via the display component, an animation transitioning the second representation of the second portion to become the first representation of the second portion by moving the second representation of the second portion toward the first location (e.g., as described above at FIGS. 9C-9F). Moving the second representation of the second portion toward the first location portion enables a computer system to visually indicate how content is being related while ensuring that the content is in proximity to each other when a determination is made that the content corresponds to each other, thereby providing improved visual feedback to the user and/or reducing the number of inputs needed to perform an operation.

In some embodiments, the user is a first user. In some embodiments, while displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936) visually grouped, the computer system detects, via the one or more input devices, a second input (e.g., 905a, 905e, 905h, 905i1, 905i2, 905i3, and/or 905j) corresponding to a second user (e.g., the first user or another user different from the first user). In some embodiments, in response to detecting the second input (e.g., 905a, 905e, 905h, 905i1, 905i2, 905i3, and/or 905j) corresponding to the second user and in accordance with a determination that the second input satisfies a first set of criteria (e.g., that content corresponding to the second input is sufficiently distinct and/or different from content corresponding to the first input), the computer system ceases displaying, via the display component, the representation of the first portion of content and the representation of the second portion of content visually grouped. In some embodiments, in response to detecting the second input corresponding to the second user and in accordance with the determination that the second input satisfies the first set of criteria, the computer system displays, via the display component, content corresponding to the second input (e.g., 905a, 905e, 905h, 905i1, 905i2, 905i3, and/or 905j) (e.g., as described above at FIGS. 9C-9F) (e.g., a representation of a portion of content). In some embodiments, in response to detecting the second input corresponding to the second user and in accordance with a determination that the second input satisfies a first set of criteria, the computer system ceases displaying the representation of the first portion of content and the representation of the second portion of content. In some embodiments, in response to detecting the second input corresponding to the second user and in accordance with a determination that the second input does not satisfy the first set of criteria, the computer system continues displaying the representation of the first portion of content and the representation of the second portion of content visually grouped. In some embodiments, in response to detecting the second input corresponding to the second user and in accordance with a determination that the second input does not satisfy the first set of criteria, the computer system displays, via the display component, a new representation of the first portion (e.g., different from the representation of the first portion) and a new representation of the second portion (e.g., different from the representation of the second portion) visually grouped. Ceasing displaying the representation of the first portion of content and the representation of the second portion of content visually grouped and displaying content corresponding to the second input in response to detecting the second input corresponding to the second user allows the computer system to introduce new content and preserve the display from displaying possibly stale content, thereby providing improved visual feedback to the user and/or performing an operation when a set of conditions has been met without requiring further user input.

In some embodiments, in accordance with the first portion of content (e.g., 906, 908, 910, 912, 914, 916, 918, 920, 922, 924, 926, 928, 930, 932, 934, and/or 936) being in the first category of content and the second portion of content (e.g., 906, 908, 910, 912, 914, 916, 918, 920, 922, 924, 926, 928, 930, 932, 934, and/or 936) being in the first category of content and after ceasing displaying the representation of the first portion of content and the representation of the second portion of content visually grouped, the computer system detects, via the one or more input devices, a third input (e.g., 905a, 905e, 905h, 905i1, 905i2, 905i3, and/or 905j) corresponding to the first category of content. In some embodiments, the third input does not include an identification of the first portion of content and/or the second portion of content. In some embodiments, in response to detecting the third input (e.g., 905a, 905e, 905h, 905i1, and/or 905j), the computer system displays the representation of the first portion of content and the representation of the second portion of content visually grouped (e.g., as described above at FIGS. 9C-9F). Displaying the representation of the first portion of content and the representation of the second portion of content visually grouped in response to detecting the third input enables a computer system to re-visit content previously displayed, thereby providing improved visual feedback to the user and/or reducing the number of inputs needed to perform an operation.

In some embodiments, in accordance with the first portion of content (e.g., 906, 908, 910, 912, 914, 916, 918, 920, 922, 924, 926, 928, 930, 932, 934, and/or 936) being in the first category of content and the second portion of content (e.g., 906, 908, 910, 912, 914, 916, 918, 920, 922, 924, 926, 928, 930, 932, 934, and/or 936) being in the first category of content and after ceasing displaying the representation of the first portion of content and the representation of the second portion of content, the computer system detects, via the one or more input devices, a fourth input (e.g., 905a, 905e, 905h, 905i1, 905i2, 905i3, and/or 905j) corresponding to a third category of content different from the first category of content. In some embodiments, in response to detecting the fourth input (e.g., 905a, 905e, 905h, 905i1, and/or 905j), the computer system displays, via the display component, the representation of the first portion of content and the representation of the second portion of content visually grouped (e.g., as described above at FIGS. 9C-9F). In some embodiments, in response to detecting the fourth input, the computer system displays, via the display component, a new representation of the first portion of content (e.g., a smaller or larger representation of the first portion of content than the representation of the first portion) and a new representation of the second portion of content (e.g., a smaller or larger representation of the second portion of content than the representation of the second portion) visually grouped. Displaying the representation of the first portion of content and the representation of the second portion of content visually grouped in response to detecting the fourth input enables a computer system to re-visit content previously displayed with the content in a similar or same visual configuration as when the content was previously displayed in response to a request that does not directly corresponding to the content, thereby providing improved visual feedback to the user and/or performing an operation when a set of conditions has been met without requiring further user input.

In some embodiments, the user is a second user. In some embodiments, while overlapping the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936) visually grouped, the computer system detects, via the one or more input devices, a fifth input (e.g., 905a, 905e, 905h, 905i1, 905i2, 905i3, and/or 905j) corresponding to a third user (e.g., the second user or another user different from the second user). In some embodiments, in response to detecting the fifth input (e.g., 905a, 905e, 905h, 905i1, and/or 905j), the computer system displays, via the display component, content corresponding to the fifth input while displaying the representation of the first portion of content and the representation of the second portion of content visually grouped (e.g., as described above at FIGS. 9C-9F). Displaying content corresponding to the fifth input while displaying the representation of the first portion of content and the representation of the second portion of content visually grouped in response to detecting the fifth input enables a computer system to maintain display of visually grouped content while responding to other input and allows for the user to keep in mind content that was previously discussed while introducing new content, thereby providing improved visual feedback to the user and/or reducing the number of inputs needed to perform an operation.

In some embodiments, while outputting audio content and displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936), the computer system displays, via the display component, a representation of a fifth portion of content (e.g., 906, 908, 910, 912, 914, 916, 918, 920, 922, 924, 926, 928, 930, 932, 934, and/or 936) different from the representation of the first portion of content and the representation of the second portion of content, including: in accordance with a determination that the first portion of content is in the first category of content and that the fifth portion of content (e.g., 906, 908, 910, 912, 914, 916, 918, 920, 922, 924, 926, 928, 930, 932, 934, and/or 936) is in the first category of content, visually grouping the representation of the fifth portion of content and the representation of the first portion of content; in accordance with a determination that the second portion of content is in the first category of content and that the fifth portion of content (e.g., 906, 908, 910, 912, 914, 916, 918, 920, 922, 924, 926, 928, 930, 932, 934, and/or 936) is in the first category of content, visually grouping the representation of the fifth portion of content and the representation of the second portion of content; in accordance with a determination that the first portion of content is in the first category of content and that the fifth portion of content (e.g., 906, 908, 910, 912, 914, 916, 918, 920, 922, 924, 926, 928, 930, 932, 934, and/or 936) is in a third category of content different from the first category of content, displaying the representation of the fifth portion of content without visually grouping the representation of the first portion of content and the representation of the fifth portion of content; and in accordance with a determination that the second portion of content is in the first category of content and that the fifth portion of content (e.g., 906, 908, 910, 912, 914, 916, 918, 920, 922, 924, 926, 928, 930, 932, 934, and/or 936) is in the third category of content, displaying the representation of the fifth portion of content without visually grouping the representation of the second portion of content and the representation of the fifth portion of content (e.g., as described above at FIGS. 9C-9F). Selectively visually grouping representations of content while outputting audio content and displaying the representation of the first portion of content and the representation of the second portion of content enables a computer system to indicate whether categories of content correspond to each other in real-time, thereby providing improved visual feedback to the user, and/or performing an operation when a set of conditions has been met without requiring further user input.

In some embodiments, displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936) includes, in accordance with a determination that the first portion of content is in the first category of content and the second portion of content is in the second category of content, displaying, via the display component, the representation of the first portion of content not visually grouped with the representation of the second portion of content (e.g., as described above at FIGS. 9C-9F). Displaying the representation of the first portion of content not visually grouped with the representation of the second portion of content enables a computer system to visually and accurately group different content detected via a voice input, thereby providing improved visual feedback to the user and/or performing an operation when a set of conditions has been met without requiring further user input.

In some embodiments, while displaying the representation of the first portion of content (e.g., 906, 908, 910, 912, 914, 916, 918, 920, 922, 924, 926, 928, 930, 932, 934, and/or 936) and the representation of the second portion of content (e.g., 906, 908, 910, 912, 914, 916, 918, 920, 922, 924, 926, 928, 930, 932, 934, and/or 936), in accordance with a determination that the first portion of content is in the same category of content as a sixth portion of content (e.g., 906, 908, 910, 912, 914, 916, 918, 920, 922, 924, 926, 928, 930, 932, 934, and/or 936), the computer system displays, via the display component, a representation of the sixth portion of content and the representation of the first portion of content visually grouped, wherein the representation of the sixth portion of content is different from the representation of the first portion of content and the representation of the second portion of content. In some embodiments, while displaying the representation of the first portion of content and the representation of the second portion of content, in accordance with a determination that the second portion of content (e.g., 906, 908, 910, 912, 914, 916, 918, 920, 922, 924, 926, 928, 930, 932, 934, and/or 936) is in the same category of content as the sixth portion of content, the computer system displays, via the display component, the representation of the sixth portion of content and the representation of the second portion of content visually grouped (e.g., as described above at FIGS. 9C-9F). Displaying multiple representations visually grouped with each other while not displaying another representation visually grouped with the multiple representations enables a computer system to indicate to a user that separate content is determined to correspond to each other and to visually group different data based on shared characteristics of the data while keeping unrelated content not visually grouped, thereby providing improved visual feedback to the user and/or performing an operation when a set of conditions has been met without requiring further user input.

In some embodiments, in conjunction with (e.g., after and/or in response to) detecting the input (e.g., 905a, 905e, 905h, 905i1, 905i2, 905i3, and/or 905j) corresponding to the user, the computer system displays, via the display component, a seventh representation of content without being visually grouped with a user-interface element (e.g., a representation of a portion of content and/or another user-interface element), wherein the seventh representation of content is different from the representation of the first portion and the representation of the second portion. Displaying a seventh representation of content without being visually grouped with a user-interface element enables a computer system to visually group different data based on shared characteristics and also display data not having the shared characteristics away from the visually grouped data, thereby providing improved visual feedback to the user and/or performing an operation when a set of conditions has been met without requiring further user input.

Note that details of the processes described above with respect to process 1000 (e.g., FIG. 10) are also applicable in an analogous manner to the methods described below/above. For example, process 1100 optionally includes one or more of the characteristics of the various methods described above with reference to process 1000. For example, the computer system can use one or more techniques of process 1100 to display a response corresponding to a previous interaction using one or more techniques of process 1000. For brevity, these details are not repeated below.

FIG. 11 is a flow diagram illustrating a method for displaying a response in response to a request corresponding to a previous interaction using a computer system in accordance with some embodiments. Process 1100 is performed at a computer system (e.g., 100, 200, 900). Some operations in process 1100 are, optionally, combined, the orders of some operations are, optionally, changed, and some operations are, optionally, omitted.

As described below, process 1100 provides an intuitive way for displaying a response in response to a request corresponding to a previous interaction. The method reduces the cognitive burden on a user for displaying a response in response to a request corresponding to a previous interaction, thereby creating a more efficient human-machine interface. For battery operated computing devices, enabling a user to display a response in response to a request corresponding to a previous interaction faster and more efficiently conserves power and increases the time between battery charges.

In some embodiments, process 1100 is performed at a computer system (e.g., 900) that is in communication with a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system detects (1102), via the one or more input devices, a request (e.g., 905h, 905i1, and/or 905j) (e.g., for a summary and/or for a condensed summary) (e.g., from one or more application (e.g., email application, messenger application, an/or social media application) to complete a task) corresponding to (e.g., to review, to summarize, and/or including an indication of) a previous interaction (e.g., as described above at FIGS. 9I-9J) (e.g., a conversation, a dialogue, a set of actions and/or a set of operations performed by a computer system (e.g., the computer system and/or a different computer system), and/or a set of inputs and a set of responses) (e.g., with the computer system and/or another computer system).

In response to detecting the request (e.g., 905h, 905i1, and/or 905j) corresponding to the previous interaction, the computer system displays (1104), via the display component, a user interface (e.g., 902) that includes: (1106) a first representation (e.g., an icon, a portion of a user interface, a user interface object, a video, and/or a graphical image) of a first application (e.g., 918, 920, 924, 926, 928, 930, 932, 934, and/or 936) (e.g., to complete at least a portion of one or more tasks and/or to perform at least a portion of one or more tasks) corresponding to the previous interaction (e.g., as described above at FIGS. 9I-9J); a (1108) first representation (e.g., an icon, a portion of a user interface, an object, a video, and/or a graphical image) of a first response (e.g., 914, 916, 922, 924, 926, 928, 930, 932, 934, and/or 936) to the request (e.g., 905h, 905i, and/or 905j), wherein the first response is from the previous interaction (e.g., as described above at FIGS. 9I-9J); and a (1110) second representation (e.g., an icon, a portion of a user interface, a user interface object, a video, and/or a graphical image) of a second response (e.g., 914, 916, 922, 924, 926, 928, 930, 932, 934, and/or 936) to the request (e.g., 905h, 905i1, and/or 905j), wherein the second response is from the previous interaction, and wherein the first representation of the first response is different from the second representation of the second response (e.g., as described above at FIGS. 9I-9J). In some embodiments, the first representation of the first application is displayed on top of (e.g., in a corner of and/or on a side of) and/or is overlaid on the first representation of the first response to the request. In some embodiments, the first representation of the first response to the request is displayed on top of and/or is overlaid on the first representation of the first icon. In some embodiments, the second representation of the second response corresponds to a different portion (e.g., different task) from the first application. In some embodiments, the second representation of the second response corresponds to a different application. Displaying a user interface that includes representations of the response corresponding to the previous interaction and a representation of a first application corresponding to the previous interaction in response to a request corresponding to the previous interaction enables the computer system to provide a summary of the previous interaction to a user without the user needing to manually browse through the previous interaction and/or guide the user through the previous interaction, thereby providing improved feedback, reducing the number of inputs needed to perform an operation, performing an operation when a set of conditions has been met without requiring further input, and allowing the computer system to avoid burn-in of the display component.

In some embodiments, the first representation of the first response (e.g., 914, 916, 922, 924, 926, 928, 930, 932, 934, and/or 936) and the second representation of the second response (e.g., 914, 916, 922, 924, 926, 928, 930, 932, 934, and/or 936) are visually grouped with each other (e.g., as described above at FIGS. 9I-9J). In some embodiments, the first representation of the first response and the second representation of the second response are visually grouped when the first representation of the first response overlaps the second representation of the second response (and/or vice-versa). In some embodiments, the first representation of the first response overlaps the second representation of the second response vertically (e.g., a portion of the first representation of the first response overlaps below or above a portion of the second representation of the second response) (and/or vice-versa). In some embodiments, the first representation of the first response overlaps the second representation of the second response horizontally (e.g., a portion of the first representation of the first response overlaps on the right or left of the second representation of the second response) (and/or vice-versa). In some embodiments, the first representation of the first response and the second representation of the second response are related to each other (e.g., from the same conversation, the same type of highlight, that same category) and/or concern the same subject matter. Displaying the first representation of the first response and the second representation of the second response as being visually grouped together enables the computer system to provide feedback to the user that the first representation of the first response and the second representation of the second response are related to each other and/or concern the same subject matter, thereby providing improved visual feedback and performing an operation when a set of conditions has been met without requiring further input.

In some embodiments, while (and/or in conjunction with, before, and/or after) displaying the first representation of the first response (e.g., 914, 916, 922, 924, 926, 928, 930, 932, 934, and/or 936) and the second representation of the second response (e.g., 914, 916, 922, 924, 926, 928, 930, 932, 934, and/or 936), the computer system displays, via the display component, a third representation of a third response to the request (e.g., 905h, 905i1, and/or 905j) (e.g., as a part of the user interface and/or concurrently with the first representation and the second representation), wherein the third representation of the third response that is not visually grouped with the first representation of the first response and second representation of the second response (and, in some embodiments, any other representation), and wherein the third response is different from the first response and second response (e.g., as described above at FIGS. 9I-9J). In some embodiments, the third representation of the third response corresponds to a different portion (e.g., task, operation, and/or uses different functionality) of the first application. In some embodiments, the third representation of the third response corresponds to an application that is different from the first application. In some embodiments, the first representation of the first response and the second representation of the second response are visually grouped together in an area of the user interface and the third representation of the third response is in a different area (e.g., away from the first representation and second representation) of the user interface that is not visually grouped with the area of the user interface and/or the first representation of the first response or the second representation of the second response. In some embodiments, the first representation of the first response (and, in some embodiments, the second representation of the second response) is on the first side of the user interface and the third representation of the third response is on the second side of the user interface different from the first side of the user interface. In some embodiments, the third representation of the third response is unrelated to and/or does not concern subject matter directed to and/or corresponding to the first representation of the first response and the second representation of the second response. In some embodiments, the third representation does not overlap the first representation of the first response, and the first representation of the first response does not overlap the third representation of the third response. In some embodiments, the second representation of the second response does not overlap the third representation of the third response, and the third representation of the third response does not overlap the second representation of the second response. Displaying a third representation of a third response as not being visually grouped with the first representation of the first response and the second representation of the second response enables the computer system to provide feedback to a user that the third representation of the third response is unrelated to and/or does not concern the same subject matter as the first representation of the first response and the second representation of the second response, thereby providing improved visual feedback and performing an operation when a set of conditions has been met without requiring further input.

In some embodiments, after displaying the first representation of the first response (e.g., 914, 916, 922, 924, 926, 928, 930, 932, 934, and/or 936) (e.g., and with a determination that the predetermined period of time (e.g., 0.1-60 seconds) is over) and without detecting one or more inputs (e.g., verbal inputs, air gestures, gaze inputs, and/or touch inputs) (e.g., intervening inputs and/or inputs that would cause another representation to be displayed) after displaying the representation of the first response (e.g., 914, 916, 922, 924, 926, 928, 930, 932, 934, and/or 936), the computer system displays, via the display component, a fourth representation of a fourth response (e.g., 914, 916, 922, 924, 926, 928, 930, 932, 934, and/or 936) to the request (e.g., 905h, 905i1, and/or 905j), wherein the fourth response is from the previous interaction, and wherein the fourth representation of the fourth response is different from the first representation of the first response. In some embodiments, the fourth representation of the fourth response is the same as the second representation of the second response. In some embodiments, the fourth representation of the fourth response is different from the second representation of the second response. In some embodiments, the computer system outputs content (e.g., audio and/or haptic) that corresponds with one of the responses while displaying a representation of one of the responses. In some embodiments, in conjunction with displaying the first representation of the first response (e.g., and/or the second representation of the second response) to the request, the computer system outputs content corresponding to the first response. In some embodiments, in accordance with a determination that output (e.g., one or more audio outputs and/or haptic outputs) of content corresponding to the first response is near completion (e.g., or that the output of content corresponding to the first response is done (or nearly done) and/or that the computer system has output the first response for a period of time), the computer system displays a different representation of a different response, wherein the different response is from the previous interaction. In some embodiments, the different representation of the fourth response is different from the first representation of the first response. In some embodiments, different representation of the fourth response is different from the second representation of the second response. In some embodiments, the different representation of the different response is the same as the second representation of the second response and in accordance with a determination that output (e.g., one or more audio outputs and/or haptic outputs) of content corresponding to the first response is near completion, the computer system outputs content corresponding to the different response. In some embodiments, the third representation of the third response is different from the second representation of the second response. Displaying a fourth representation of a fourth response without detecting one or more inputs and after displaying the representation of the first response allows the computer system to automatically display the responses from the previous conversations, thereby providing improved feedback and reducing the number of inputs needed to perform an operation.

In some embodiments, in conjunction with (e.g., after, while, and/or before) displaying the fourth representation of the fourth response (e.g., 914, 916, 922, 924, 926, 928, 930, 932, 934, and/or 936) (and, in some embodiments, outputting (e.g., audio and/or haptic) content corresponding to the fourth response), the computer system ceases displaying the first representation of the first response (e.g., 914, 916, 922, 924, 926, 928, 930, 932, 934, and/or 936) (e.g., as described above at FIGS. 9I-9J) (e.g., with the determination that a predefined amount of time has passed) (e.g., without detecting one or more inputs after displaying the fourth representation of the fourth response) (e.g., after outputting content corresponding to the first response). Ceasing displaying the first representation of the first response in conjunction with displaying the fourth representation of the fourth response allows the computer system to automatically reduce visual distractions in the user interface while transitioning to a new response, thereby providing improved feedback, reducing the number of inputs needed to perform an operation, performing an operation when a set of conditions has been met without requiring further input, and allowing the computer system to avoid burn-in of the display component.

In some embodiments, the first response (e.g., 914, 916, 922, 924, 926, 928, 930, 932, 934, and/or 936) and the second response (e.g., 914, 916, 922, 924, 926, 928, 930, 932, 934, and/or 936) are included in a group of responses. In some embodiments, the first representation of the first response (e.g., 914, 916, 922, 924, 926, 928, 930, 932, 934, and/or 936) and the second representation of the second response (e.g., 914, 916, 922, 924, 926, 928, 930, 932, 934, and/or 936) is included in representations for the group of responses. In some embodiments, the representations for the group of responses are visually grouped together before displaying the fourth representation of the fourth response (e.g., 914, 916, 922, 924, 926, 928, 930, 932, 934, and/or 936). In some embodiments, in conjunction with displaying the fourth representation of the fourth response (e.g., 914, 916, 922, 924, 926, 928, 930, 932, 934, and/or 936) and in accordance with a determination that content has been output for more than a threshold amount (e.g., more than half, more than 80%, all but a number (e.g., 1-10), and/or all) of the group of responses (e.g., and without detecting one or more inputs (e.g., verbal inputs, air gestures, gaze inputs, and/or touch inputs) (e.g., intervening inputs and/or inputs that would cause another representation to stop being displayed)), ceasing displaying the representations for the group of responses (e.g., including ceasing to display the first representation of the first response and the second representation of the second response). Ceasing displaying the visually grouped representations for the group of responses in conjunction with displaying the fourth representation of the fourth response allows the computer system to automatically reduce visual distractions on the user interface while transitioning to a new response that is unrelated to and/or does not concern the same subject matter as the representations for the group of responses, thereby providing improved feedback, reducing the number of inputs needed to perform an operation, performing an operation when a set of conditions has been met without requiring further input, and allowing the computer system to avoid burn-in of the display component.

In some embodiments, while (e.g., after) displaying the first representation of the first application (e.g., 918, 920, 924, 926, 928, 930, 932, 934, and/or 936) corresponding to the previous interaction, the computer system detects a first input (e.g., 905i2, and/or 905i3) (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) directed to the first representation of the first application. In some embodiments, in response to detecting the first input (e.g., 905i2, and/or 905i3) directed to the first representation of the first application (e.g., 918, 920, 924, 926, 928, 930, 932, 934, and/or 936), the computer system displays, via the display component, a first application user interface (e.g., 902) corresponding to the first application (e.g., and ceasing to display the user interface with the first representation of the first application, the first representation of the first response, and the second representation of the second response). In some embodiments, the computer system opens the first application user interface corresponding to the first application and/or launches the first application in response to detecting the first input directed to the first representation of the first application. Displaying a first application user interface corresponding to the first application in response to detecting the first input directed to the first representation of the first application enables the computer system to allow a user with control to transition to the first application, thereby performing an operation when a set of conditions has been met without requiring further input and allowing the computer system to avoid burn-in of the display component.

In some embodiments, in response to detecting the request (e.g., 905h, 905i1, and/or 905j) corresponding to the previous interaction, the computer system displays, via the display component, a second representation (e.g., an icon, a portion of a user interface, a user interface object, a video, and/or a graphical image) of a second application (e.g., 918, 920, 924, 926, 928, 930, 932, 934, and/or 936) (e.g., to complete at least a portion of one or more tasks and/or to perform at least a portion of one or more tasks) corresponding to the previous interaction, wherein the second application is different from the first application, and wherein the second representation of the second application is concurrently displayed with the first representation of the first application (e.g., and concurrently with the representation of the first response and the second representation of the second response). In some embodiments, the second application corresponds to the first response. In some embodiments, the second application corresponds to the second response. In some embodiments, the second application corresponds to another response. Displaying a second representation of a second application in response to detecting the request corresponding to the previous interaction enables the computer system to guide the user through the previous interaction, thereby providing improved feedback, and reducing the number of inputs needed to perform an operation.

In some embodiments, while displaying the second representation of the second response (e.g., 914, 916, 922, 924, 926, 928, 930, 932, 934, and/or 936) to the request (e.g., 905h, 905i1, and/or 905j), the computer system detects a second input (e.g., 905i2, and/or 905i3) (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) directed to the second representation of the second response to the request (e.g., 905h, 905i1, and/or 905j). In some embodiments, in response to detecting the second input (e.g., 905i2, and/or 905i3) directed to the second representation of the second response (e.g., 914, 916, 922, 924, 926, 928, 930, 932, 934, and/or 936) to the request (e.g., 905h, 905i1, and/or 905j), the computer system displays a fifth representation of the second response (e.g., additional response and/or new content) to the request, wherein the fifth representation of the second response to the request is different from the second representation of the second response to the request (and, in some embodiments, while displaying the first representation of the first response to the request (e.g., and/or the second representation of the second response to the request) with less emphasis and/or at a size smaller than the additional representation corresponding to the second response to the request (and, in some embodiments, while ceasing to display the first representation of the first response to the request) (and, in some embodiments, while still displaying the first representation of the first response to the request and adding the fifth representation of the second response to the second representation of the second response to the request)). In some embodiments, in response to detecting the second input directed to the second representation of the second response to the request, the computer system displays additional content corresponding the second response. Displaying a fifth representation of the second response to the request that is different from the second representation of the second response in response to detecting the second input directed to the second representation of the second response to the request enables the computer system to provide additional information of the second response to a user when requested without transitioning to a new user interface, thereby providing improved feedback, reducing the number of inputs needed to perform an operation, performing an operation when a set of conditions has been met without requiring further input, and allowing the computer system to avoid burn-in of the display component.

In some embodiments, while (and/or after) displaying the second representation of the second response (e.g., 914, 916, 922, 924, 926, 928, 930, 932, 934, and/or 936) to the request (e.g., 905h, 905i1, and/or 905j), the computer system detects a third input (e.g., 905i2, and/or 905i3) (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) directed to the representation of the second response to the request. In some embodiments, in response to detecting the third input (e.g., 905i2, and/or 905i3) directed to the representation of the second response (e.g., 914, 916, 922, 924, 926, 928, 930, 932, 934, and/or 936) to the request (e.g., 905h, 905i1, and/or 905j), the computer system outputs audio, via one or more output devices (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.), content corresponding the second response. In some embodiments, outputting audio is in conjunction with displaying additional content. In some embodiments, outputting audio is not in conjunction with displaying additional content. Outputting audio content corresponding the second response in response to detecting a third input directed to the representation of the second response to the request enables the computer system to provide auditory feedback to a user, thereby providing improved feedback and performing an operation when a set of conditions has been met without requiring further input.

In some embodiments, the request (e.g., 905h, 905i1, and/or 905j) corresponding to the previous interaction is an audible request (e.g., verbal input, an audible request, an audible command). In some embodiments, the request corresponding to the previous interaction is detected via a microphone that is in communication with the computer system.

In some embodiments, the request corresponding to the previous interaction does not include a first explicit indication (e.g., direct request and/or a command) to display the user interface (e.g., 902). In some embodiments, the request corresponding to the previous interaction does not include an explicit request to display a summary of the previous interaction.

In some embodiments, the request (e.g., 905h, 905i1, and/or 905j) corresponding to the previous interaction includes a second explicit indication (e.g., direct request and/or a command) to display the user interface (e.g., 902).

In some embodiments, while displaying the first representation of the first response (e.g., 914, 916, 922, 924, 926, 928, 930, 932, 934, and/or 936) to the request (e.g., 905h, 905i1, and/or 905j) (and the second representation of the second response to the request), the computer system outputs a second content corresponding to (e.g., related to, of, concerning, and/or about) the first response. In some embodiments, while outputting content corresponding to the first response (e.g., 914, 916, 922, 924, 926, 928, 930, 932, 934, and/or 936), in accordance with a determination that a set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) has been detected while outputting the second content corresponding to the first response (e.g., 914, 916, 922, 924, 926, 928, 930, 932, 934, and/or 936) (and/or, in some embodiments, while displaying the first representation of the first response to the request), the computer system displays, via the display component, a sixth representation of the first response without displaying a respective representation of the second response, wherein the sixth representation of the first response is different from the first representation of the first response. In some embodiments, the Y representation of the second response is different form the second representation of the second response. In some embodiments, displaying the sixth representation of the first response includes ceasing to display the second representation of the second response. In some embodiments, displaying the sixth representation of first response includes deemphasizing the first representation of the first response and/or the second representation of the second response while adding the sixth representation of the first response. In some embodiments, displaying the sixth representation of the first response includes adding additional responses to the first representation of the first response to the request. In some embodiments, while outputting content corresponding to the first response, in accordance with a determination that the set of one or more inputs has not been detected while outputting content corresponding to the first response (e.g., 914, 916, 922, 924, 926, 928, 930, 932, 934, and/or 936) (and/or, in some embodiments, while displaying the first representation of the first response to the request), the computer system forgoes displaying the sixth representation of the first response (and, in some embodiments, the seventh representation of the second response). Displaying a sixth representation of the first response and/or forgoing displaying the sixth representation of the first response in accordance with a determination that the set of one or more inputs has been detected or not enables the computer system to cater the next operation based on if an input is received or not by the user, thereby providing improved feedback, reducing the number of inputs needed to perform an operation, and performing an operation when a set of conditions has been met without requiring further input.

In some embodiments, while outputting the second content corresponding to the first response (e.g., 914, 916, 922, 924, 926, 928, 930, 932, 934, and/or 936) and in accordance with a determination that a set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) have been detected while displaying the first representation of the first response (e.g., 914, 916, 922, 924, 926, 928, 930, 932, 934, and/or 936), the computer system ceases to display the second representation of the second response (e.g., 914, 916, 922, 924, 926, 928, 930, 932, 934, and/or 936) (e.g., as described above at FIGS. 9I-9J). In some embodiments, while outputting the second content corresponding to the first response and in accordance with a determination that a set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) have been detected while displaying the first representation of the first response to the request, the computer system continues to display the first representation of the first response. Ceasing displaying the second representation of the second response while outputting the second content corresponding to the first response and in accordance with a determination that a set of one or more inputs allows the computer system to reduce visual distractions on the user interface while displaying the sixth representation of the first response, thereby providing improved feedback, reducing the number of inputs needed to perform an operation, performing an operation when a set of conditions has been met without requiring further input, and allowing the computer system to avoid burn-in of the display component.

In some embodiments, while outputting the second content corresponding to the first response (e.g., 914, 916, 922, 924, 926, 928, 930, 932, 934, and/or 936) and in accordance with a determination that the set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) has not been detected while displaying the first representation of the first response to the request (e.g., 905h, 905i1, and/or 905j), the computer system continues to display the second representation of the second response (e.g., 914, 916, 922, 924, 926, 928, 930, 932, 934, and/or 936). In some embodiments, while outputting the second content corresponding to the first response and in accordance with a determination that the set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) has not been detected while displaying the first representation of the first response to the request, the computer system continues to display the first representation of the first response.

In some embodiments, while displaying the first representation of the first response (e.g., 914, 916, 922, 924, 926, 928, 930, 932, 934, and/or 936), the computer system outputs third content corresponding to the first response. In some embodiments, while outputting the third content corresponding to the first response (e.g., 914, 916, 922, 924, 926, 928, 930, 932, 934, and/or 936), in accordance with a determination that a second set of one or more inputs (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) has not been detected while outputting the third content corresponding to the first response (e.g., 914, 916, 922, 924, 926, 928, 930, 932, 934, and/or 936), the computer system outputs fourth content corresponding to the second response (e.g., 914, 916, 922, 924, 926, 928, 930, 932, 934, and/or 936) (e.g., while continuing to display the second representation of the second). In some embodiments, while outputting the third content corresponding to the first response and in accordance with a determination that an input is not detected while outputting content corresponding to the first response, the computer system ceases to output the third content corresponding to the first response. In some embodiments, while outputting the third content corresponding to the first response, in accordance with a determination that the second set of one or more inputs has been detected while outputting content corresponding to the first response (e.g., 914, 916, 922, 924, 926, 928, 930, 932, 934, and/or 936), the computer system forgoes outputting content corresponding to the second response (e.g., 914, 916, 922, 924, 926, 928, 930, 932, 934, and/or 936) (e.g., as described above at FIGS. 9I-9J). In some embodiments, while outputting the third content corresponding to the first response and in accordance with a determination that an input is detected while outputting content corresponding to the first response, the computer system continues to output the third content corresponding to (e.g., related to) the first response.

In some embodiments, the first response (e.g., 914, 916, 922, 924, 926, 928, 930, 932, 934, and/or 936) includes a first portion of the first response and a second portion of the first response. In some embodiments, the first representation of the first response (e.g., 914, 916, 922, 924, 926, 928, 930, 932, 934, and/or 936) includes the first portion of the response (e.g., and does not include the second portion of the first response). In some embodiments, the third content corresponding to the first response (e.g., 914, 916, 922, 924, 926, 928, 930, 932, 934, and/or 936) includes content displayed in the first representation of the first response and content related to a sub response (e.g., a different portion of the first response not shown in the first representation of the first response, additional task and/or additional information (e.g., calendar, weather, and/or contacts)) corresponding to the first response, wherein the sub-response is the second portion of the first response not displayed on the user interface (e.g., 902). Outputting the third content corresponding to the first response that includes content displayed in the first representation of the first response and a sub-response enables the computer system to provide auditory feedback to the user on responses related to the first response, thereby providing improved feedback, reducing the number of inputs needed to perform an operation, preforming an operation when a set of conditions has been met without requiring further input, and allowing the computer system to avoid burn-in of the display component.

In some embodiments, displaying the first representation of the first response (e.g., 914, 916, 922, 924, 926, 928, 930, 932, 934, and/or 936) includes: in accordance with a determination that the request (e.g., 905h, 905i1, and/or 905j) corresponding to the previous interaction is a second type of interaction, displaying the first representation of the first response in a second position different from the first position. In some embodiments, the first representation of the first response is in a position similar to where the response is when the previous interaction occurs. In some embodiments, the first representation of the first response in a position where all content corresponding to the first response of the previous interaction can be shown (e.g., if the first response of the previous interaction includes a long dialogue, the representation of the first response position is displayed in a way to show the long dialogue and/or if the first response of the previous conversation is a set of actions, the first representations of the first response is displayed in a way that each step is in a position to show the order of the steps).

In some embodiments, the first representation of the first application (e.g., 918, 920, 924, 926, 928, 930, 932, 934, and/or 936) is not visually grouped with the first representation of the first response (e.g., 914, 916, 922, 924, 926, 928, 930, 932, 934, and/or 936) to the request (e.g., 905h, 905i1, and/or 905j) (e.g., and/or the second representation of the second response to the request). In some embodiments, the first representation of the first response and the second representation of the second response are visually grouped together in an area of the user interface and the first representation of the first application is in a different area (e.g., away from and within a predetermined distance away from the first representation and second representation) of the user interface that is not visually grouped with the area of the user interface and/or the first representation or the second representation. In some embodiments, the first representation of the first response in a first arear of the user interface and the second representation of the second response is in a second area of the user interface (e.g., not visually grouped together in an area of the user interface) and the first representation of the first application is in a different area (e.g., away from and/or within a predetermined distance away from the first representation and second representation) of the user interface that is not visually grouped with the area of the user interface and/or the first representation or the second representation. In some embodiments, the first representation (and, in some embodiments, the second representation) is on the first side of the user interface and the first representation of the application is on second side of the user interface different from the first side of the user interface. In some embodiments, the first representation of the first application is unrelated to and/or does not concern subject matter directed to and/or corresponding to the first representation of the first response and the second representation of the second response. In some embodiments, the first representation of the first application is related to and/or concerns subject matter directed to and/or corresponding to at least the one representation of one of the responses (e.g., first representation of the first response and the second representation of the second response). In some embodiments, the first representation of the first application does not overlap the first representation of the first response, and the first representation of the first response does not overlap the first representation of the first application. In some embodiments, the second representation of the second response does not overlap the first representation of the application, and the first representation of the application does not overlap the second representation of the response. Displaying the first representation of the first application and the first representation of the first response as not being visually grouped together enables the computer system to provide feedback to the user that first representation of the first application and the first representation of the first response are unrelated to each other and/or do not concern the same subject matter, thereby providing improved visual feedback and performing an operation when a set of conditions has been met without requiring further input

In some embodiments, first representation of the first response (e.g., 914, 916, 922, 924, 926, 928, 930, 932, 934, and/or 936) and the first representation of the first application (e.g., 918, 920, 924, 926, 928, 930, 932, 934, and/or 936) overlap each other. In some embodiments, the first representation of the first application and the second representation of the second response do not overlap each other. In some embodiments, the first representation of the first application is related to and/or concerns subject matter directed to and/or corresponding to first representation of the first response. In some embodiments, the first representation of the first response and the first representation of the first application are visually grouped when the first representation of the first response overlaps the first representation of the first application (and/or vice-versa). In some embodiments, the first representation of the first response overlaps the first representation of the application vertically (e.g., a portion of the first representation of the first response overlaps below or above a portion of the first representation of the first application) (and/or vice-versa). In some embodiments, the first representation of the first response overlaps the first representation of the application horizontally (e.g., a portion of the first representation of the first response overlaps on the right or left of the first representation of the application) (and/or vice-versa). Displaying the first representation of the first application and the first representation of the first response as being visually grouped together enables the computer system to provide feedback to the user that first representation of the first application and the first representation of the first response are related to each other and/or concern the same subject matter, thereby providing improved visual feedback and performing an operation when a set of conditions has been met without requiring further input

In some embodiments, while displaying the first representation of the first response (e.g., 914, 916, 922, 924, 926, 928, 930, 932, 934, and/or 936) to the request (e.g., 905h, 905i, and/or 905j), the computer system outputs fourth content corresponding to the first response. In some embodiments, while displaying the first representation of the first response (e.g., 914, 916, 922, 924, 926, 928, 930, 932, 934, and/or 936) to the request (e.g., 905h, 905i1, and/or 905j) and outputting the fourth content corresponding to the first response, the computer system detects a fourth input (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) directed to the first representation of the first response. In some embodiments, in response to detecting the fourth input directed to the first representation of the first response, the computer system ceases outputting the fourth content corresponding to the first response (e.g., 914, 916, 922, 924, 926, 928, 930, 932, 934, and/or 936). In some embodiments, in response to detecting the fourth input directed to the first representation of the first response, the computer system outputs fifth content (e.g., content for sub responses and/or additional material) (e.g., content that is not shown indicated by the first representation of the first response to the request) corresponding to the first response (e.g., 914, 916, 922, 924, 926, 928, 930, 932, 934, and/or 936), wherein the fourth content corresponding to the first response is different from the fifth content corresponding to the first response. Ceasing outputting the fourth content corresponding to the first response and outputting fifth content corresponding to the first response in response to detecting the fourth input directed to the first representation of the first response while outputting the fourth content corresponding to the first response enables the computer system to provide auditory feedback to the user of additional response corresponding to first response not shown on the user interface, thereby providing improved feedback, reducing the number of inputs needed to perform an operation, preforming an operation when a set of conditions has been met without requiring further input, and allowing the computer system to avoid burn-in of the display component.

In some embodiments, while displaying the first representation of the first application (e.g., 918, 920, 924, 926, 928, 930, 932, 934, and/or 936) corresponding to the previous interaction, the computer system detects a fifth input (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)) directed to the first representation of the first application. In some embodiments, in response to detecting a fifth input (e.g., 905i2, and/or 905i3) directed to the first representation of the first application (e.g., 918, 920, 924, 926, 928, 930, 932, 934, and/or 936), the computer system performs an operation corresponding to the first application (e.g., as described above at FIGS. 9I-9J) (e.g., book an appointment, and/or reserve a car). In some embodiments, performing the operation corresponding to the first application includes calling the first application to perform an operation and/or causing the first application to perform an operation. Performing an operation corresponding to the first application in response to detecting a fifth input directed to the first representation of the first application allows the computer system to complete a task concerning the previous conversation, thereby reducing the number of inputs needed to perform an operation and preforming an operation when a set of conditions has been met without requiring further input.

In some embodiments, in response to detecting the fifth input (e.g., 905i2, and/or 905i3) directed to the first representation of the first application (e.g., 918, 920, 924, 926, 928, 930, 932, 934, and/or 936), the computer system continues to display one or more of the first representation of the first response (e.g., 914, 916, 922, 924, 926, 928, 930, 932, 934, and/or 936) and the second representation of the second response (e.g., 914, 916, 922, 924, 926, 928, 930, 932, 934, and/or 936) (e.g., as described above at FIGS. 9I-9J). In some embodiments, the computer system continues to the display a representation of a response that has not been selected and/or to which input has not been directed.

In some embodiments, in response to detecting a fifth input (e.g., 905i2, and/or 905i3) directed to the first representation of the first application (e.g., 918, 920, 924, 926, 928, 930, 932, 934, and/or 936), the computer system ceases to display one or more of the first representation of the first response (e.g., 914, 916, 922, 924, 926, 928, 930, 932, 934, and/or 936) and the second representation of the second response (e.g., 914, 916, 922, 924, 926, 928, 930, 932, 934, and/or 936) (e.g., as described above at FIGS. 9I-9J). In some embodiments, the computer system ceases to display a representation of a response that has been selected and/or to which input has been directed. Ceasing to display one or more of the first representation of the first response and the second representation of the second response in response to detecting a fifth input directed to the first representation of the first application enables the computer system to reduce visual distractions on the user interface while performing the operation corresponding to the first application, thereby providing improved feedback, reducing the number of inputs needed to perform an operation, performing an operation when a set of conditions has been met without requiring further input, and allowing the computer system to avoid burn-in of the display component.

In some embodiments, in response to detecting the fifth input directed to the first representation of the first application (e.g., 918, 920, 924, 926, 928, 930, 932, 934, and/or 936), the computer system displays, via the display component, a second application (e.g., 918, 920, 924, 926, 928, 930, 932, 934, and/or 936) user interface corresponding to the first application (e.g., as described above at FIGS. 9I-9J). Displaying a second application user interface corresponding to the first application in response to detecting the fifth input directed to the first representation of the first application enables the computer system to allow a user with control to transition to the first application when the operation is performed, thereby providing improved feedback, reducing the number of inputs needed to perform an operation, performing an operation when a set of conditions has been met without requiring further input, and allowing the computer system to avoid burn-in of the display component.

In some embodiments, the second application (e.g., 918, 920, 924, 926, 928, 930, 932, 934, and/or 936) user interface corresponding to the first application (e.g., 918, 920, 924, 926, 928, 930, 932, 934, and/or 936) is concurrently displayed with one or more response of the first representation of the first response (e.g., 914, 916, 922, 924, 926, 928, 930, 932, 934, and/or 936) (e.g., and/or the second representation of the second response). In some embodiments, in response to detecting the fifth input directed to the first representation of the first application, the computer system changes the size (e.g., shrinks, reduces the size, and/or de-emphasizes) one or more of the first representation of the first response and the second representation of the second response (e.g., while continuing to display the respective representation) (e.g., while concurrently displaying the second application user interface corresponding to the first application). Displaying with one or more response of the first representation of the first response with the second application user interface corresponding to the first application allows the computer system to provide feedback to the user of the response that corresponds to the operation, thereby providing improved feedback, reducing the number of inputs needed to perform an operation, and performing an operation when a set of conditions has been met without requiring further input.

In some embodiments, while displaying the second application (e.g., 918, 920, 924, 926, 928, 930, 932, 934, and/or 936) user interface corresponding to the first application (e.g., 918, 920, 924, 926, 928, 930, 932, 934, and/or 936), the computer system detects a sixth input (e.g., 905i2, and/or 905i3) (e.g., a verbal input (e.g., an audible request, an audible command, and/or an audible statement) and/or a non-audible input (e.g., a tap input, a swipe input, a hold-and-drag input, a gaze input, an air gesture, and/or a mouse click)). In some embodiments, in response to detecting the sixth input (e.g., 905i2, and/or 905i3), the computer system ceases displaying the second application (e.g., 918, 920, 924, 926, 928, 930, 932, 934, and/or 936) on the user interface corresponding to the first application (e.g., 918, 920, 924, 926, 928, 930, 932, 934, and/or 936). In some embodiments, in response to detecting the sixth input, the computer system concurrently displays via the display component: the first representation of the first application (e.g., 918, 920, 924, 926, 928, 930, 932, 934, and/or 936) corresponding to the previous interaction; the first representation of the first response (e.g., 914, 916, 922, 924, 926, 928, 930, 932, 934, and/or 936) to the request (e.g., 905h, 905i1, and/or 905j), wherein the first response is from the previous interaction; and the second representation of the second response (e.g., 914, 916, 922, 924, 926, 928, 930, 932, 934, and/or 936) to the request (e.g., 905h, 905i1, and/or 905j), wherein the second response is from the previous interaction, and wherein the first representation of the first response is different from the second representation of the second response. Ceasing displaying the second application user interface corresponding to the first application and displaying the previous user interface when detecting the sixth input allows the computer system to provide control to transition back to the summary with an input, thereby providing improved feedback and reducing the number of inputs needed to perform an operation.

Note that details of the processes described above with respect to process 1100 (e.g., FIG. 11) are also applicable in an analogous manner to the methods described below/above. For example, process 1200 optionally includes one or more of the characteristics of the various methods described above with reference to process 1100. For example, the computer system can use one or more techniques of process 1200 to display a summary of the previous interactions using one or more techniques of process 1100. For brevity, these details are not repeated below.

FIG. 12 is a flow diagram illustrating a method for displaying a summary of previous interactions using a computer system in accordance with some embodiments. Process 1200 is performed at a computer system (e.g., 100, 200, and/or 900). Some operations in process 1200 are, optionally, combined, the orders of some operations are, optionally, changed, and some operations are, optionally, omitted.

As described below, process 1200 provides an intuitive way for displaying a summary of previous interactions. The method reduces the cognitive burden on a user for displaying a summary of previous interactions, thereby creating a more efficient human-machine interface. For battery operated computing devices, enabling a user to display a summary of previous interactions faster and more efficiently conserves power and increases the time between battery charges.

In some embodiments, process 1200 is performed at a computer system (e.g., 900) that is in communication with a display component (e.g., a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system detects (1202) (e.g., via one or more input devices) a first request (e.g., 905h, 905i, and/or 905j) (e.g., for a summary and/or for a condensed summary) corresponding to (e.g., concerning, to review, and/or to discuss) a previous interaction (e.g., between a user and the computer system) to the previous interaction.

In response to (1204) detecting the request (e.g., 905h, 905i1, and/or 905j) corresponding to the previous interaction, in accordance with a determination that the request (e.g., 905h, 905i1, and/or 905j) does not correspond to (e.g., does not include) new content, the computer system displays (1206), via the display component, a first summary (e.g., as described above in relation to process 1000) of the previous interaction that includes a first set of one or more representations (e.g., 906, 908, 910, 912, 914, 916, 918, 920, 922, 924, 926, 928, 930, 932, 934, and/or 936) corresponding to the previous interaction (e.g., as described above in relation to process 1000) in a first orientation relative to a second set of one or more representations corresponding to the previous interaction (e.g., as described above at FIGS. 9I-9J).

In response to (1204) detecting the request corresponding to the previous interaction, in accordance with a determination that the request (e.g., 905h, 905i1, and/or 905j) includes new content, the computer system displays (1208), via the display component, a second summary (and, in some embodiments, that includes the new content) of the previous interaction (e.g., as described above in relation to process 1000) that includes the first set of one or more representations (e.g., 906, 908, 910, 912, 914, 916, 918, 920, 922, 924, 926, 928, 930, 932, 934, and/or 936) (e.g., as described above in relation to process 1000) corresponding to the previous interaction in a second orientation relative to the second set of one or more representations, wherein the second orientation is different from the first orientation (e.g., as described above at FIGS. 9I-9J) (e.g., layout, location, and/or position). Displaying a summary that includes the first set of one or more representations corresponding to the previous interaction in a first or a second orientation relative to the second set of one or more representations in based on if new content should be added or not, allows the computer system to optimize the user interface space when displaying the summary with or without new content, thereby providing improved feedback, reducing the number of inputs needed to perform an operation, performing an operation when a set of conditions has been met without requiring further input, and allowing the computer system to avoid burn-in of the display component.

In some embodiments, the computer system (e.g., 900) is in communication with one or more output devices (e.g., as described above in relation to process 1000). In some embodiments, in response to detecting the first request (e.g., 905h, 905i1, and/or 905j) corresponding to the previous interaction, in accordance with a determination that the request (e.g., 905h, 905i1, and/or 905j) does not correspond to new content, the computer system outputs, via the one or more output devices, first audio (e.g., as described above in relation to process 1000) corresponding to a portion of the previous interaction (e.g., the first set of one or more representations and the second set of one or more representations that are displayed in the first orientation). In some embodiments, in response to detecting the first request corresponding to the previous interaction, in accordance with a determination that the request (e.g., 905h, 905i1, and/or 905j) includes new content, the computer system outputs second audio corresponding to the portion of the previous interaction (e.g., the first set of one or more representations and the second set of one or more representations that are displayed in the second orientation). In some embodiments, while displaying the first summary, the computer system outputs audio corresponding to the portion of the content that corresponds to the first set of one or more representations. In some embodiments, while displaying the second summary of the previous conversation, the computer system outputs audio corresponding to a different portion and/or a new portion of the previous conversation. In some embodiments, while displaying the first summary, the computer system does not output audio corresponding to a different portion and/or a new portion of the previous conversation. Outputting audio content corresponding to the portion of the previous conversation enables the computer system to provide auditory feedback to a user, thereby providing improved feedback and performing an operation when a set of conditions has been met without requiring further input.

In some embodiments, the first audio is the same as (e.g., includes the same content as) the second audio.

In some embodiments, the first audio is different from the second audio. In some embodiments, the first audio includes a first amount of content corresponding to the portion of the previous interaction. In some embodiments, the second audio includes a second amount of content corresponding to the portion of the previous interaction different from the first amount of content corresponding to the portion of the previous interaction. In some embodiments, the first amount is less than the second amount (e.g., as described above at FIGS. 9I-9J). In some embodiments, the first audio is a concatenation of and/or summarizes the portion more quickly than the first audio. In some embodiments, the second amount is less than the first amount. In some embodiments, the second audio includes new content.

In some embodiments, in response to detecting the first request (e.g., 905h, 905i1, and/or 905j) corresponding to the previous interaction, in accordance with a determination that the request (e.g., 905h, 905i1, and/or 905j) does not correspond to new content, the computer system forgoes outputting, via the one or more output devices, third audio (e.g., as described above in relation to process 1000) corresponding to the new content. In some embodiments, in response to detecting the first request corresponding to the previous interaction, in accordance with a determination that the request (e.g., 905h, 905i1, and/or 905j) includes new content, the computer system outputs, via the one or more output devices, third audio (e.g., as described above in relation to process 1000) corresponding to the new content (e.g., as described above at FIGS. 9I-9J).

In some embodiments, the first set of one or more representations (e.g., 906, 908, 910, 912, 914, 916, 918, 920, 922, 924, 926, 928, 930, 932, 934, and/or 936) includes representations that are visually grouped (e.g., visually overlapping, overlapping, and/or a first representation in the first set of one or more representations overlapping a second representation in the first set of one or more representations (or vice-versa)) (e.g., as described above in relation to process 1000) with each other (e.g., as described above at FIGS. 9I-9J). In some embodiments, the first set of one or more representations includes a first representation that overlaps a second representation vertically (e.g., a portion of the first representation overlaps below or above a portion of the second representation). In some embodiments, the first set of one or more representations includes a first representation that overlaps a second representation horizontally (e.g., a portion of the first representation overlaps on the right or left of the second representation. In some embodiments, the first set of one or more representations includes a first representation and a second representation as a result of the representations being related to each other (e.g., from the same interaction, same type of highlight, and/or same category)). In some embodiments, the first set of one or more representations includes a first representation and a second representation. In some embodiments, a portion of the first representation overlaps a portion of the second representation (or vice-versa). Displaying the first set of one or more representations that includes representations that are visually grouped together enables the computer system to provide feedback to the user that the first set of representations are related to each other and/or concern the same subject matter, thereby providing improved visual feedback and performing an operation when a set of conditions has been met without requiring further input.

In some embodiments, the first set of one or more representations (e.g., 906, 908, 910, 912, 914, 916, 918, 920, 922, 924, 926, 928, 930, 932, 934, and/or 936) and the second set of one or more representations (e.g., 906, 908, 910, 912, 914, 916, 918, 920, 922, 924, 926, 928, 930, 932, 934, and/or 936) are not visually grouped together (e.g., as described above at FIGS. 9I-9J). In some embodiments, the first set of one or more representations is in a first portion of a user interface and the second set of one or more representations is in a second portion of the user interface different from the first portion. In some embodiments, the first set of one or more representations and the second set of one or more representations are in two distinct (e.g., separate and/or different) areas of the user interface. In some embodiments, the first set of one or more representations and the second set of one or more representations are not related to, do not correspond to, and/or are connected to each other (e.g., from the same interaction, from the same type of highlight, that same category). In some embodiments, the representation of the first set of one or more representations overlap each other and/or the representations of the second set of one or more representations overlap each other. Displaying the first set of one or more representations and the second set of one or more representations as not being visually grouped together enables the computer system to provide feedback to the user that the first set of or more representations and the second set of one or more representations are unrelated to each other and/or do not concern the same subject matter, thereby providing improved visual feedback and performing an operation when a set of conditions has been met without requiring further input.

In some embodiments, in response to detecting the request (e.g., 905h, 905i1, and/or 905j) corresponding to the previous interaction, in accordance with a determination that the request (e.g., 905h, 905i1, and/or 905j) corresponds to (e.g., concerning, to review, and/or to discuss) new content, the computer system displays, via the display, a third set of one or more representations (e.g., 906, 908, 910, 912, 914, 916, 918, 920, 922, 924, 926, 928, 930, 932, 934, and/or 936) corresponding to the new content (e.g., that is included to the second summary and/or a new summary) (e.g., while displaying the first set of one or more representations in a second orientation relative to the second set of one or more representations and/or new orientation relative to the second set of one or more representations and the third set of one or more representation). In some embodiments, in response to detecting the request corresponding to the previous interaction, in accordance with a determination that the request (e.g., 905h, 905i1, and/or 905j) does not correspond to (e.g., does not include) new content, the computer system forgoes displaying, via the display, the third set of one or more representations (e.g., 906, 908, 910, 912, 914, 916, 918, 920, 922, 924, 926, 928, 930, 932, 934, and/or 936) corresponding to the new content (e.g., as described above at FIGS. 9I-9J) (e.g., that is included to the first summary and/or while displaying a first set of one or more representations corresponding to a first orientation relative to the second set of one or more representations). In some embodiments, the third set of one or more representations is visually grouped with the first (or second) set of one or more representations of the previous interaction. In some embodiments, the third set of one or more representations is added to the first (or second) set of representations corresponding to the previous interaction. In some embodiments, the third set of one or more representations is not visually grouped with the first set of one or more representations and the second set of one or more representations. Displaying or forgoing displaying a third set of one or more representations corresponding to the new content when new content should be added or not allows the computer system to provide visual feedback if there is new content available or not for the previous interaction, thereby providing improved feedback, reducing the number of inputs needed to perform an operation, and performing an operation when a set of conditions has been met without requiring further input.

In some embodiments, the new content is a first new content. In some embodiments, after displaying the third set of one or more representations corresponding to the first new content, the computer system detects a second request (e.g., 905h, 905i1, and/or 905j) (e.g., for a summary, for a condensed summary) corresponding (e.g., concerning, to review, and/or to discuss) to the previous interaction. In some embodiments, in response to detecting the second request (e.g., 905h, 905i1, and/or 905j) corresponding to the previous interaction, in accordance with a determination that the second request (e.g., 905h, 905i1, and/or 905j) includes a second new content, the computer system displays, via the display component, a fourth set of one or more representations (e.g., 906, 908, 910, 912, 914, 916, 918, 920, 922, 924, 926, 928, 930, 932, 934, and/or 936) corresponding to the second new content in a third orientation (e.g., relative to one or more sets of representations previously displayed (e.g., the first set of one or more representation, the second set of one or more representation and/or the third set of one or more representation)). In some embodiments, in response to detecting the second request corresponding to the previous interaction, in accordance with a determination that the second request (e.g., 905h, 905i1, and/or 905j) does not correspond to the second new content, the computer system continues displaying, via the display component, the third set of one or more representations (e.g., 906, 908, 910, 912, 914, 916, 918, 920, 922, 924, 926, 928, 930, 932, 934, and/or 936) corresponding to the first new content without displaying a fourth set of one or more representations (e.g., 906, 908, 910, 912, 914, 916, 918, 920, 922, 924, 926, 928, 930, 932, 934, and/or 936) corresponding to the second new content, wherein the third set of one or more representations in a fourth orientation (e.g., layout, location, and/or position) (e.g., the second orientation or a new orientation), different from the third orientation (e.g., relative to the first set of more representations and/or the second set of one or more representations) (e.g., as described above at FIGS. 9I-9J). In some embodiments, the fourth orientation is the same as the second orientation. In some embodiments, the fourth orientation is different from the second orientation. In some embodiments, the fourth orientation and the third orientation are different from the first orientation. Displaying a fourth set one or more representations corresponding to the previous interaction in a third orientation or continuing displaying the third set of one or more representations corresponding to the first new content without displaying a fourth set of one or more representations corresponding to the second new content based on if the second new content should be added or not, allows the computer system to optimize the user interface space when displaying sets of one or more representations depending on how much information needs to be displayed, thereby providing improved feedback, reducing the number of inputs needed to perform an operation, performing an operation when a set of conditions has been met without requiring further input, and allowing the computer system to avoid burn-in of the display component

In some embodiments, displaying the third set of one or more representations (e.g., 906, 908, 910, 912, 914, 916, 918, 920, 922, 924, 926, 928, 930, 932, 934, and/or 936) corresponding to the new content includes including display of the third set of one or more representations in display of one or more of the first representations corresponding to the previous interaction (e.g., and/or the second representation corresponding to the previous interaction). In some embodiments, the third set of one or more representation corresponding to the new content is related (e.g., from the same conversation, the same type of highlight, that same category) and/or concern the same subject matter. Displaying of one or more of the first representations corresponding to the previous interaction as a part of displaying the third set of one or more representations allows the computer system to provide feedback to the user that the third set of one or more representations and the first set of one or more representations are related to each other and/or concern the same subject matter, thereby providing improved visual feedback and performing an operation when a set of conditions has been met without requiring further input.

In some embodiments, displaying the third set of one or more representations corresponding to the new content includes visually grouping the third set of one or more representations (e.g., 906, 908, 910, 912, 914, 916, 918, 920, 922, 924, 926, 928, 930, 932, 934, and/or 936) with one or more of the first representation corresponding to the previous interaction and the second representation corresponding to the previous interaction.

In some embodiments, displaying the third set of one or more representations (e.g., 906, 908, 910, 912, 914, 916, 918, 920, 922, 924, 926, 928, 930, 932, 934, and/or 936) corresponding to the new content does not include including display of the third set of one or more representations in display of one or more of the first set of one or more representations (e.g., 906, 908, 910, 912, 914, 916, 918, 920, 922, 924, 926, 928, 930, 932, 934, and/or 936) corresponding to the previous interaction and the second set of one or more representations corresponding to the previous interaction. In some embodiments, the third set of one or more representations corresponding to the new content is unrelated and/or does not concern subject matter of the first set of one or more representations corresponding to the previous interaction and the second set of one or more representations corresponding to the previous interaction. Not including display of the third set of one or more representations in display of the first set of one or more representations corresponding to the previous interaction and the second set of one or more representations corresponding to the previous interaction allows the computer system to provide feedback to the user that the third set of one or more representations is unrelated to each and/or concern the same subject matter as the first set of one or more representations corresponding to the previous interaction and the second set of one or more representations, thereby providing improved visual feedback and performing an operation when a set of conditions has been met without requiring further input.

In some embodiments, displaying the third set of one or more representations (e.g., 906, 908, 910, 912, 914, 916, 918, 920, 922, 924, 926, 928, 930, 932, 934, and/or 936) corresponding to the new content does not include visually grouping the third set of one or more representations with one or more of (and/or any of) the first representation corresponding to the previous interaction and the second representation corresponding to the previous interaction. In some embodiments, the third set of one or more representations is not visually grouped with the previous set of one or more representations (e.g., the first set or the second set). In some embodiments, the third set of one or more representations does not occupy the same portion of a user interface as the first set of one or more representations or the second set of one or more representations (e.g., the third set is in a third portion of the user interface different from the first portion of the user interface that corresponds to the first set of one or more representations and different from the second portion of the user interface that corresponds to the second set of one or more representations). In some embodiments, visually grouping one or more representations indicates that the one or more representations are in the same category and/or correspond to and/or relate to each other. In some embodiments, not visually grouping one or more representations indicates that the one or more representations are not in the same category and/or does not correspond to and/or do not relate to each other.

In some embodiments, in response to detecting the first request (e.g., 905h, 905i1, and/or 905j) corresponding to the previous interaction, the computer system outputs (e.g., via one or more output devices, such as speaker) third audio corresponding to the first set of one or more representations (e.g., 906, 908, 910, 912, 914, 916, 918, 920, 922, 924, 926, 928, 930, 932, 934, and/or 936) (e.g., while displaying the first summary or the second summary). In some embodiments, after outputting third audio content corresponding to the first set of one or more representations (e.g., with the determination that output corresponding to the first set of one or more representations is done), the computer system outputs (e.g., via one or more output devices, such as speaker) (e.g., automatically and/or without detecting additional input after outputting audio content corresponding to the first set of one or more representations and/or after detecting a request corresponding to the previous interaction) fourth audio corresponding to the second set of one or more representations (e.g., 906, 908, 910, 912, 914, 916, 918, 920, 922, 924, 926, 928, 930, 932, 934, and/or 936) (e.g., as described above at FIGS. 9I-9J). Outputting third audio corresponding to the first set of one or more representations and then outputting fourth audio corresponding to the second set of one or more representations enables the computer system to give auditory feedback to the user and automatically go through the summary as each representation is discussed, thereby providing improved feedback, reducing the number of inputs needed to perform an operation and performing an operation when a set of conditions has been met without requiring further input.

In some embodiments, after (and/or in conjunction with) outputting an initial portion (e.g., a start portion and/or a beginning portion) of the third audio corresponding to the first set of one or more representations (e.g., 906, 908, 910, 912, 914, 916, 918, 920, 922, 924, 926, 928, 930, 932, 934, and/or 936) (e.g., with the determination that output corresponding to the first set of one or more representations is done) and before outputting (e.g., via one or more output devices, such as speaker) (e.g., automatically and/or without detecting additional input after outputting audio content corresponding to the first set of one or more representations and/or after detecting the request corresponding to the previous interaction) a terminal portion (e.g., an end portion and/or a terminal portion) of the fourth audio corresponding to the second set of one or more representations (e.g., 906, 908, 910, 912, 914, 916, 918, 920, 922, 924, 926, 928, 930, 932, 934, and/or 936) (e.g., while displaying the first set of one or more representations and the second set of one or more representations), the computer system ceases to display the first set of one or more representations. In some embodiments, after outputting (e.g., via one or more output devices, such as speaker) (e.g., automatically and/or without detecting additional input after outputting audio content corresponding to the first set of one or more representations and/or after detecting a request corresponding to the previous interaction) the fourth audio corresponding to the second set of one or more representations (e.g., 906, 908, 910, 912, 914, 916, 918, 920, 922, 924, 926, 928, 930, 932, 934, and/or 936) (e.g., while displaying the second set of one or more representations), the computer system ceases to display the second set of one or more representations (e.g., as described above at FIGS. 9I-9J). Ceasing to display the first set of one or more representations before outputting a terminal portion of the fourth audio and ceasing to display the second set of one or more representations after outputting the fourth audio enables the computer system to reduce visual distractions in the user interface as the representations are discussed, thereby providing improved feedback, reducing the number of inputs needed to perform an operation, performing an operation when a set of conditions has been met without requiring further input, and allowing the computer system to avoid burn-in of the display component.

In some embodiments, after (and/or in conjunction with) outputting audio content corresponding to the first set of one or more representations (e.g., 906, 908, 910, 912, 914, 916, 918, 920, 922, 924, 926, 928, 930, 932, 934, and/or 936) (e.g., while displaying the first set of one or more representations and, in some embodiments, the second set of one or more representations), the computer system continues to display the first set of one or more representations (and, in some embodiments, the second set of one or more representations). In some embodiments, after (and/or in conjunction with) outputting audio content corresponding to the second set of one or more representations (e.g., 906, 908, 910, 912, 914, 916, 918, 920, 922, 924, 926, 928, 930, 932, 934, and/or 936) (e.g., while displaying the second set of one or more representations), the computer system continues to display the second set of one or more representations (and, in some embodiments, the first set of one or more representations) (e.g., as described above at FIGS. 9I-9J).

In some embodiments, in response to detecting the first request (e.g., 905h, 905i1, and/or 905j) corresponding to the previous interaction and in accordance with a determination that the request includes new subject matter, the computer system outputs fifth audio (e.g., as described above in relation to process 1000) corresponding to (e.g., as described above in relation to process 1000) to new subject matter. In some embodiments, after outputting audio corresponding to the new subject matter (e.g., in accordance with a determination that that output corresponding to the first set of one or more representations is done and/or has been completed) (e.g., and in accordance with a determination that the request includes new subject matter), the computer system outputs (e.g., automatically outputs) (e.g., via one or more output devices, such as speaker) (e.g., automatically and/or without detecting additional input after outputting audio content corresponding to the first set of one or more representations and/or after detecting the request corresponding to the previous interaction) sixth audio content corresponding to the first set of one or more representations (e.g., 906, 908, 910, 912, 914, 916, 918, 920, 922, 924, 926, 928, 930, 932, 934, and/or 936) (e.g., as described above at FIGS. 9I-9J) (e.g., and/or the second set of one or more representations corresponding to the previous interaction) (e.g., without needing to detect a user input). Outputting fifth audio corresponding to the new content and then outputting sixth audio corresponding to the first set of one or more representations enables the computer system to automatically give auditory feedback to the user and indicate the new content first, thereby providing improved feedback, reducing the number of inputs needed to perform an operation, and performing an operation when a set of conditions has been met without requiring further input.

In some embodiments, in accordance with a determination that the previous interaction corresponds to first subject matter, the first set of one or more representations (e.g., 906, 908, 910, 912, 914, 916, 918, 920, 922, 924, 926, 928, 930, 932, 934, and/or 936) has a first number of one or more representations. In some embodiments, in accordance with a determination that the previous interaction corresponds to second subject matter, different from the first subject matter, the first set of one or more representations (e.g., 906, 908, 910, 912, 914, 916, 918, 920, 922, 924, 926, 928, 930, 932, 934, and/or 936) has a second number of one or more representations different from the first number one or more representations (e.g., as described above at FIGS. 9I-9J). In some embodiments, in accordance with a determination that the previous interaction includes a first number of previous interactions, the second set of one or more representations has a third number of one or more representations. In some embodiments, in accordance with a determination that the previous interaction includes a second number of previous interactions, different from the first number of previous interactions, the second set of one or more representations has a fourth number of one or more representations different from the third number one or more representations. In some embodiments, the number of previous representations displayed is dependent on the user of the previous interaction. In some embodiments, the number of previous representations displayed is dependent on the number of previous interactions corresponding to the previous interaction.

Note that details of the processes described above with respect to process 1200 (e.g., FIG. 12) are also applicable in an analogous manner to the methods described below/above. For example, process 1300 optionally includes one or more of the characteristics of the various methods described above with reference to process 1200. For example, the computer system can use one or more techniques of process 1300 to increase the size of objects based on inputs using one or more techniques of process 1200. For brevity, these details are not repeated below.

FIG. 13 is a flow diagram illustrating a method for increasing the size of an object using a computer system in accordance with some embodiments. Process 1300 is performed at a computer system (e.g., 100, 200, and/or 900). Some operations in process 1300 are, optionally, combined, the orders of some operations are, optionally, changed, and some operations are, optionally, omitted.

As described below, process 1300 provides an intuitive way for increasing the size of an object. The method reduces the cognitive burden on a user for increasing the size of an object, thereby creating a more efficient human-machine interface. For battery operated computing devices, enabling a user to increase the size of an object faster and more efficiently conserves power and increases the time between battery charges.

In some embodiments, process 1300 is performed at a computer system (e.g., 900) that is in communication with one or more output devices (e.g., a speaker, a haptic output device, a display screen, a projector, and/or a touch-sensitive display) including a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, hydraulic actuator and/or an electric actuator), a movable base, a rotatable component, and/or a rotatable base).

The computer system displays (1302), via the display component, visual content (e.g., as described above in relation process 1000) that includes a first group of one or more items (e.g., 906, 908, 910, 912, 914, 916, 918, 920, 922, 924, 926, 928, 930, 932, 934, and/or 936) (e.g., one or more representations as described above in relation process 1000), a second group of one or more items (e.g., 906, 908, 910, 912, 914, 916, 918, 920, 922, 924, 926, 928, 930, 932, 934, and/or 936) (e.g., one or more representations as described above in relation process 1000) different from the first group of items, and an avatar (e.g., 904) (e.g., a representation of a character and/or user) closer to the first group of items than the second group of items (e.g., as described above at FIGS. 9B-9D, 9G-9H, and 9J). In some embodiments, the system avatar is generated based on one or more characteristics and/or a description of a particular character.

While displaying the visual content that includes the first group of items, the second group of items, and the avatar (e.g., 904) closer to the first group of items (e.g., 906, 908, 910, 912, 914, 916, 918, 920, 922, 924, 926, 928, 930, 932, 934, and/or 936) than the second group of items (e.g., 906, 908, 910, 912, 914, 916, 918, 920, 922, 924, 926, 928, 930, 932, 934, and/or 936), the computer system outputs (1304), via the one or more output devices, content (e.g., audio content and/or haptic content) corresponding to the first group of items.

While outputting the content corresponding to the first group of items (e.g., 906, 908, 910, 912, 914, 916, 918, 920, 922, 924, 926, 928, 930, 932, 934, and/or 936) and displaying the avatar (e.g., 904) closer to (and/or relative to, next to, adjacent to, on top of, and/or overlaid on) the first group of items (e.g., 906, 908, 910, 912, 914, 916, 918, 920, 922, 924, 926, 928, 930, 932, 934, and/or 936) than the second group of items, the computer system detects (1306) that content corresponding to the second group of items will be output (and/or is being output).

In response to detecting that content corresponding to the second group of items (e.g., 906, 908, 910, 912, 914, 916, 918, 920, 922, 924, 926, 928, 930, 932, 934, and/or 936) will be output, the computer system displays (1308), via the display component, the avatar (e.g., 904) positioned closer to the second group of items than the first group of items (e.g., 906, 908, 910, 912, 914, 916, 918, 920, 922, 924, 926, 928, 930, 932, 934, and/or 936) (e.g., as described above at FIGS. 9B-9D, 9G-9H, and 9J). In some embodiments, in response to detecting that content corresponding to the second group of items will be output, moving the avatar from a first location corresponding to the first group of items to a second location corresponding to the second group of items. Outputting the content corresponding to the first group of items while displaying the avatar closer to the first group of items than the second group of items and displaying the avatar positioned closer to the second group of items than the first group of items in response to detecting that content corresponding to the second group of items will be output allows the computer system to provide visual feedback of which group of items is being outputted, thereby providing improved feedback, reducing the number of inputs needed to perform an operation, and performing an operation when a set of conditions has been met without requiring further input.

In some embodiments, in response to detecting that content corresponding to the second group of items (e.g., 906, 908, 910, 912, 914, 916, 918, 920, 922, 924, 926, 928, 930, 932, 934, and/or 936) will be output, the computer system changes display of the avatar (e.g., 904), such that the avatar is visually directed to (e.g., looking at, pointing toward and/or in a direction of, facing toward and/or in the direction of, and/or animating toward) the second group of items. In some embodiments, in response to detecting that content corresponding to the second group of items will be output, the computer system changes the avatar from being directed to a first location (and/or group of items) to a second location (and/or a different group of times), different form the first location. Changing display of the avatar positioned such that the avatar is visually directed to the second group of items in response to detecting that content corresponding to the second group of items will be output allows the computer system to provide visual feedback to the user that the output is changing to content corresponding to the second group of items, thereby providing improved feedback, reducing the number of inputs needed to perform an operation, and performing an operation when a set of conditions has been met without requiring further input.

In some embodiments, while displaying the avatar (e.g., 904), such that the avatar (e.g., 904) is visually directed to the second group of items (e.g., 906, 908, 910, 912, 914, 916, 918, 920, 922, 924, 926, 928, 930, 932, 934, and/or 936) (e.g., and, in some embodiments, while displaying the avatar positioned closer to the first group of items than the second group of items) and in accordance with a determination that a predetermined period (e.g., 0-60 seconds and/or period of time the computer system need to output content corresponding to the second group of items) of time has passed, the computer system changes display of the avatar, such that the avatar is visually directed away from (e.g., looking away from, pointing away from and/or away from a direction of, facing away from and/or away from a direction of, and/or animating away from) the second group of items. Changing display of the avatar such that the avatar is visually directed away from the second group of items and in accordance with a determination that a predetermined period of time has passed, allows the computer system to automatically change the avatar and provides visual feedback to the user, thereby providing improved feedback, reducing the number of inputs needed to perform an operation, and performing an operation when a set of conditions has been met without requiring further input.

In some embodiments, after changing display of the avatar (e.g., 904), such that the avatar is visually directed away from the second group of items (e.g., 906, 908, 910, 912, 914, 916, 918, 920, 922, 924, 926, 928, 930, 932, 934, and/or 936), the avatar is visually directed to (e.g., corresponding to and/or at) a first user (e.g., a person, an animal, and/or an object) detected in a first field-of-detection (e.g., a field-of-view and/or a field-of-sound detection) of the computer system (e.g., 900) (e.g., field-of-detection that is established by detection capabilities and/or zones of the one or more input devices).

In some embodiments, after changing display of the avatar (e.g., 904), such that the avatar is visually directed away from the second group of items (e.g., 906, 908, 910, 912, 914, 916, 918, 920, 922, 924, 926, 928, 930, 932, 934, and/or 936), the avatar is directed to (e.g., corresponding to and/or at) a first physical environment (e.g., in an environment (e.g., a physical, virtual, or mixed-reality environment) including the user) (e.g., field of detection) (e.g., outside of the content of the one or more input devices).

In some embodiments, after changing display of the avatar (e.g., 904), such that the avatar is visually directed away from the second group of items (e.g., 906, 908, 910, 912, 914, 916, 918, 920, 922, 924, 926, 928, 930, 932, 934, and/or 936), the avatar is not directed to (e.g., corresponding to and/or at) the first group of items (e.g., 906, 908, 910, 912, 914, 916, 918, 920, 922, 924, 926, 928, 930, 932, 934, and/or 936).

In some embodiments, in response to detecting that content corresponding to the second group of items (e.g., 906, 908, 910, 912, 914, 916, 918, 920, 922, 924, 926, 928, 930, 932, 934, and/or 936) will be output, the computer system changes display of the avatar (e.g., 904), such that the avatar changes from being visually directed to the first group of items (e.g., 906, 908, 910, 912, 914, 916, 918, 920, 922, 924, 926, 928, 930, 932, 934, and/or 936) to not being visually directed to (e.g., corresponding to and/or at) the first group of items. In some embodiments, changing display of the avatar occurs before displaying the avatar position closer to the second group. In some embodiments, changing display of the avatar occurs after displaying the avatar position closer to the second group. In some embodiments, changing display of avatar occurs while displaying the avatar position closer to the second group.

In some embodiments, in response to detecting that content corresponding to the second group of items (e.g., 906, 908, 910, 912, 914, 916, 918, 920, 922, 924, 926, 928, 930, 932, 934, and/or 936) will be output, the computer system changes display of the avatar (e.g., 904), such that the avatar changes from being visually directed to a second user detected in a second field-of-detection (e.g., a field-of-view and/or a field-of-sound detection) to not being visually directed to (e.g., corresponding to and/or at) the second user detected in the second field-of-detection. In some embodiments, changing display of the avatar occurs before displaying the avatar position closer to the second group. In some embodiments, changing display of the avatar occurs after displaying the avatar position closer to the second group. In some embodiments, changing display of the avatar occurs while displaying the avatar position closer to the second group.

In some embodiments, in response to detecting that content corresponding to the second group of items (e.g., 906, 908, 910, 912, 914, 916, 918, 920, 922, 924, 926, 928, 930, 932, 934, and/or 936) will be output, the computer system changes display of the avatar (e.g., 904), such that the avatar changes from being visually directed to a second physical environment to not being visually directed to (e.g., corresponding to and/or at) the second physical environment (e.g., in an environment (e.g., a physical, virtual, or mixed-reality environment) including the user) (e.g., field of detection) (e.g., outside of the content of the one or more input devices). In some embodiments, changing display of the avatar occurs before displaying the avatar position closer to the second group. In some embodiments, changing display of the avatar occurs after displaying the avatar position closer to the second group. In some embodiments, changing display of the avatar occurs while displaying the avatar position closer to the second group.

In some embodiments, in response to detecting that content corresponding to the second group of items (e.g., 906, 908, 910, 912, 914, 916, 918, 920, 922, 924, 926, 928, 930, 932, 934, and/or 936) will be output (e.g., or the first group, the environment, or the direction of the user), the computer system moves the avatar (e.g., 904) from a first position to a second position different from the first position. In some embodiments, while moving the avatar (e.g., 904) from a first position to a second position, the computer system displays, via the display component, the avatar as being visually directed to (e.g., corresponding to and/or at) the second group of items (e.g., 906, 908, 910, 912, 914, 916, 918, 920, 922, 924, 926, 928, 930, 932, 934, and/or 936) (and not visually directed to the first group of items). In some embodiments, the avatar moves from the first position to the second position while transition to look in the direction of the second group of items. In some embodiments, the computer system changes the avatar from not being visually directed to the second group of items (and/or being visually directed to the first group of items) to being visually directed to the second group of items while moving the avatar from the first position to the second position.

In some embodiments, in response to detecting that content corresponding to the second group of items (e.g., 906, 908, 910, 912, 914, 916, 918, 920, 922, 924, 926, 928, 930, 932, 934, and/or 936) will be output (e.g., or the first group, the environment, or the direction of the user), the computer system moves the avatar (e.g., 904) from a third position to a fourth position different from the third position. In some embodiments, after moving the avatar (e.g., 904) from a third position to a fourth position different from the third position, the computer system displays, via the display component, the avatar as being visually directed to (e.g., corresponding to and/or at) the second group of items (e.g., 906, 908, 910, 912, 914, 916, 918, 920, 922, 924, 926, 928, 930, 932, 934, and/or 936). In some embodiments, the computer system changes the avatar from not being visually directed to the second group of items (and/or being visually directed to the first group of items) to being visually directed to the second group of items after moving the avatar from the third position to the fourth position.

In some embodiments, in response to detecting that content corresponding to the second group of items (e.g., 906, 908, 910, 912, 914, 916, 918, 920, 922, 924, 926, 928, 930, 932, 934, and/or 936) will be output (e.g., or the first group, the environment, or the direction of the user), the computer system moves the avatar (e.g., 904) from a fifth position to a sixth position different from the third position. In some embodiments, before moving the avatar (e.g., 904) from a fifth position to a sixth position different from the third position, the computer system displays, via the display component, the avatar as being directed to (e.g., corresponding to and/or at) the second group of items (e.g., 906, 908, 910, 912, 914, 916, 918, 920, 922, 924, 926, 928, 930, 932, 934, and/or 936). In some embodiments, the computer system changes the avatar from not being visually directed to the second group of items (and/or being visually directed to the first group of items) to being visually directed to the second group of items before moving the avatar from the fifth position to the sixth position.

In some embodiments, the visual content includes a third group of items (e.g., 906, 908, 910, 912, 914, 916, 918, 920, 922, 924, 926, 928, 930, 932, 934, and/or 936) different from the first group of items (e.g., 906, 908, 910, 912, 914, 916, 918, 920, 922, 924, 926, 928, 930, 932, 934, and/or 936) and the second group of items (e.g., 906, 908, 910, 912, 914, 916, 918, 920, 922, 924, 926, 928, 930, 932, 934, and/or 936). In some embodiments, the third group of items and at least one of the first group of items and the second group of items are visually grouped together (e.g., as described above in relation to process 1000). In some embodiments, the first group of items overlaps a portion of the second group of items. In some embodiments, the first group of items overlaps the second group of items vertically (e.g., a portion of the first group of items overlaps below or above a portion of the second group of items). In some embodiments, the first group of items overlaps the second group of items horizontally (e.g., a portion of the first group of items overlaps on the right or left of the second group of items). In some embodiments, the one or more items of the first group are visually grouped together. In some embodiments, the one or more items of the second group are visually grouped together. Displaying the third group of items and at least one of the first group of items and the second group of items as being visually grouped together enables the computer system to provide feedback to the user that the third group of items and at least one of the first group of items and the second group of items are related to each other and/or concern the same subject matter, thereby providing improved visual feedback and performing an operation when a set of conditions has been met without requiring further input.

In some embodiments, the avatar (e.g., 904) is displayed on a first portion (e.g., side and/or edge) (e.g., right, left, bottom, and/or top) of the first group of items (e.g., 906, 908, 910, 912, 914, 916, 918, 920, 922, 924, 926, 928, 930, 932, 934, and/or 936) while the avatar is displayed closer to the first group of items than the second group of items (e.g., 906, 908, 910, 912, 914, 916, 918, 920, 922, 924, 926, 928, 930, 932, 934, and/or 936). In some embodiments, the avatar (e.g., 904) is displayed on a second portion (e.g., side and/or edge) (e.g., right, left, bottom, and/or top) of the second group of items (e.g., 906, 908, 910, 912, 914, 916, 918, 920, 922, 924, 926, 928, 930, 932, 934, and/or 936) while the avatar is displayed closer to the second group of items than the first group of items (e.g., 906, 908, 910, 912, 914, 916, 918, 920, 922, 924, 926, 928, 930, 932, 934, and/or 936). In some embodiments, the first portion is different from the second portion. Displaying the avatar on a first portion of the first group of items while the avatar is displayed closer to the first group of items than the second group of items and displaying the avatar on a second portion of the second group of items while the avatar is displayed closer to the second group of items than the first group of items enables the computer system to give improved visual feedback about the content that is outputted or will be outputted next, thereby providing improved visual feedback and performing an operation when a set of conditions has been met without requiring further input.

Note that details of the processes described above with respect to process 1300 (e.g., FIG. 13) are also applicable in an analogous manner to the methods described below/above. For example, process 1400 optionally includes one or more of the characteristics of the various methods described above with reference to process 1300. For example, the computer system can use one or more techniques of process 1400 to display an avatar close to a particular group of items using one or more techniques of process 1300. For brevity, these details are not repeated below.

FIG. 14 is a flow diagram illustrating a method for displaying an avatar closer to a group of items using a computer system in accordance with some embodiments. Process 1400 is performed at a computer system (e.g., 100, 200, and/or 900). Some operations in process 1400 are, optionally, combined, the orders of some operations are, optionally, changed, and some operations are, optionally, omitted.

As described below, process 1400 provides an intuitive way for displaying an avatar closer to a group of items. The method reduces the cognitive burden on a user for displaying an avatar closer to a group of items, thereby creating a more efficient human-machine interface. For battery operated computing devices, enabling a user to display an avatar closer to a group of items faster and more efficiently conserves power and increases the time between battery charges.

In some embodiments, process 1400 is performed at a computer system (e.g., 900) that is in communication with a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component, a speaker, a haptic output device, a display screen, a projector, and/or a touch-sensitive display). In some embodiments, the computer system is in communication with a movable component (e.g., an actuator (e.g., a pneumatic actuator, hydraulic actuator and/or an electric actuator), a movable base, a rotatable component, and/or a rotatable base).

While displaying, via the display component, a first user interface object (e.g., 906, 908, 910, 912, 914, 916, 918, 920, 922, 924, 926, 928, 930, 932, 934, and/or 936) (e.g., text, a symbol, a button, a selectable user interface object, an image, a video, media, a chart, a drawing a representation of a face, and/or an avatar), the computer system detects (1402), via the one or more input devices, an input (e.g., 905h) (e.g., one or more words and/or sounds) (e.g., first input) corresponding to subject matter (e.g., first subject matter) (e.g., a topic, theme, content, idea, and/or field).

In response to (1104) detecting the input (e.g., 905h) corresponding to the subject matter, in accordance with a determination that a respective portion (e.g., a subset and/or the entirety) of the input (e.g., 905h) is associated with a level of confidence corresponding to the input (and/or corresponding to the subject matter) that is below a threshold (e.g., 0-100, 0%-100%, and/or 0.01-1 level of confidence) (and/or below a first threshold), the computer system forgoes increasing (1406) the size of the first user interface object (e.g., 906, 908, 910, 912, 914, 916, 918, 920, 922, 924, 926, 928, 930, 932, 934, and/or 936).

In response to (1104) detecting the input corresponding to the subject matter, in accordance with a determination that the respective portion of the input (e.g., 905h) is associated with a level of confidence corresponding to the input (and/or corresponding to the subject matter) that is above the threshold (and/or above a second threshold that is higher than the first threshold), the computer system increases (1408) the size of the first user interface object (e.g., 906, 908, 910, 912, 914, 916, 918, 920, 922, 924, 926, 928, 930, 932, 934, and/or 936) (e.g., as described above at FIGS. 9H-9G). In some embodiments, the computer system continues to update the display of the first user interface object, irrespective of whether the level of confidence corresponding to the input is above/below the threshold (e.g., changing one or more color characteristics (e.g., hue, saturation, tone, and/or brightness), using lighting effects, using visual effects (e.g., Computer Generated Imagery (CGI) and/or practical effects), using animated text, and/or using animations and/or transitions). In some embodiments, the computer system ceases to update the first user interface object in accordance with a determination that the respective portion of the input is associated with the level of confidence corresponding to the input that is below the threshold. In some embodiments, ceasing to update the first user interface object includes a transition and/or animation. In some embodiments, the computer system continues to update the first user interface object in accordance with a determination that the respective portion of the input is associated with the level of confidence corresponding to the input that is below the threshold. In some embodiments, instead of and/or in addition to increasing the size of the first user interface object to communicate that the system understands the input, the computer system can increase the emphasis of the first user interface object by making the first user interface object more visible (e.g., increasing the amount of highlighting (e.g., creating a halo effect), bolding, using drop shadow and/or border, changing the color (e.g., darkening and/or lighting, increasing saturation and/or contrast), using dead space to isolate the object to make it appear more important, and/or decreasing the amount of transparency). In some embodiments, instead of and/or in addition to increasing the size of the first user interface object to communicate that the system understands the input, the computer system can increase the emphasis of the first user interface object by deemphasizing the background of the first user interface object (e.g., blurring, changing the color (e.g., darkening and/or lighting, decreasing saturation and/or contrast), decluttering (e.g., removing other user interface objects in the background), and/or using a contrasting color from the first user interface object). Forgoing increasing the size of the first user interface object in accordance with a determination that a respective portion of the input is associated with a level of confidence corresponding to the input that is below a threshold allows the computer system to (1) enhance user experience by maintaining the consistency of the first user interface object and (2) ensuring uninterrupted user engagement when feedback on the user's input regarding a subject matter is not feasible, thereby providing improved visual feedback to the user, reducing the number of inputs needed to perform an operation, and performing an operation when a set of conditions has been met without requiring further user input. Increasing the size of the first user interface object in accordance with a determination that the respective portion of the input is associated with a level of confidence corresponding to the input that is above the threshold allows the computer system to (1) increase user engagement and (2) improve accessibility by visually signaling its active engagement with the user regarding a subject matter, thereby providing improved visual feedback to the user, reducing the number of inputs needed to perform an operation, providing additional control options without cluttering the user interface with additional displayed controls, and performing an operation when a set of conditions has been met without requiring further user input.

In some embodiments, the input (e.g., 905h) is an audible (e.g., verbal, speech, auditory, and/or voice) input. In some embodiments, audible input includes spoken words and/or linguistic details, such as content and logical structure of a verbal communication. In some embodiments, the verbal input is detected via the one or more input devices, such as a microphone. Having the input include audible input provides the computer system with (1) increased flexibility and/or accessibility in receiving communication from a user and/or (2) enables the computer system to perform an operation based on audio, thereby reducing the number of inputs needed to perform an operation, providing additional control options without cluttering the user interface with additional displayed controls, and performing an operation when a set of conditions has been met without requiring further user input.

In some embodiments, in response to detecting the input (e.g., 905h) corresponding to the subject matter, in accordance with a determination that the respective portion of the input (e.g., 905h) is associated with the level of confidence corresponding to the input that is below the threshold, the computer system decreases the size of the first user interface object (e.g., as described above at FIGS. 9H-9G). In some embodiments, after displaying the first user interface object at a first size; in response to detecting the input corresponding to the subject matter and in accordance with a determination that the respective portion of the input is associated with the level of confidence corresponding to the input that is below the threshold, the computer system displays the first user interface object at a second size smaller than the first size. Decreasing the size of the first user interface object in accordance with a determination that the respective portion of the input is associated with the level of confidence corresponding to the input that is below the threshold allows the computer system to enhance user engagement and optimize its output for clarity by signaling its lack of understanding of the user's input regarding a subject matter, thereby providing improved visual feedback to the user, and performing an operation when a set of conditions has been met without requiring further user input.

In some embodiments, the first user interface object is displayed at a first size. In some embodiments, in response to detecting the input (e.g., 905h) corresponding to the subject matter, in accordance with a determination that the respective portion of the input (e.g., 905h) is associated with the level of confidence corresponding to the input that is below the threshold, the computer system continues displaying the first user interface object (e.g., system avatar, image, video, control (button), text, chart, drawing, object and/or representation of a face, etc.) at the first size (e.g., as described above at FIGS. 9H-9G). In some embodiments, in accordance with a determination that the respective portion of the input is associated with the level of confidence corresponding to the input that is below the threshold, the computer system does not increase the size of the first user interface object and does not decrease the size of the first user interface object. Continuing displaying the first user interface object at the first size in accordance with a determination that the respective portion of the input is associated with the level of confidence corresponding to the input that is below the threshold allows the computer system to enhance user experience by maintaining the consistency of the first user interface feedback on the user's input regarding a subject matter is not feasible, thereby providing improved visual feedback to the user, and performing an operation when a set of conditions has been met without requiring further user input.

In some embodiments, a second user interface object, different from the first user interface object, is displayed at a third size before detecting the input (e.g., 905h) corresponding to the user. In some embodiments, in response to detecting the input (e.g., 905h) corresponding to the subject matter, in accordance with a determination that the respective portion of the input (e.g., 905h) is associated with the level of confidence corresponding to the input that is above the threshold, the computer system increases a size of the second user interface object from a fourth size that is greater than the third size (e.g., as described above at FIGS. 9H-9G). In some embodiments, in accordance with a determination that the respective portion of the input is associated with the level of confidence corresponding to the input that is above the threshold, the computer system displays the second user interface object at the fourth size. In some embodiments, in accordance with a determination that the respective portion of the input is associated with the level of confidence corresponding to the input that is above the threshold, the computer system concurrently increases the size of the first user interface object and the second user interface object. In some embodiments, in accordance with a determination that the respective portion of the input is associated with the level of confidence corresponding to the input that is below the threshold, the computer system does not increase the size of the second user interface object and/or decreases the size of the first user interface object. Increasing a size of the second user interface object from a fourth size that is greater than the third size in accordance with a determination that the respective portion of the input is associated with the level of confidence corresponding to the input that is above the threshold allows the computer system to enhance user experience by signaling its active engagement with the user regarding a subject matter by adapting other user interface objects, thereby providing improved visual feedback to the user, and performing an operation when a set of conditions has been met without requiring further user input.

In some embodiments, a third user interface object, different from the first user interface object, is displayed at a fifth size. In some embodiments, in response to detecting the input (e.g., 905h) corresponding to the subject matter, in accordance with a determination that the respective portion of the input (e.g., 905h) is associated with the level of confidence corresponding to the input that is above the threshold, the computer system continues displaying the third user interface object at the fifth size (e.g., as described above at FIGS. 9H-9G). In some embodiments, in accordance with a determination that the respective portion of the input is associated with the level of confidence corresponding to the input that is below the threshold, the computer system continues to display the third user interface object at the fifth size. Continuing displaying the third user interface object at the fifth size in accordance with a determination that the respective portion of the input is associated with the level of confidence corresponding to the input that is above the threshold allows the computer system to provide a stable user experience by preserving consistency of other user interface objects, thereby providing improved visual feedback to the user, and performing an operation when a set of conditions has been met without requiring further user input.

In some embodiments, the input (e.g., 905h) is a first input. In some embodiments, the computer system detects a second input (e.g., 905h) (e.g., one or more words and/or sounds) (e.g., different from the input or the same as the input) corresponding to the subject matter. In some embodiments, in response to detecting the second input (e.g., 905h) corresponding to the subject matter, in accordance with a determination that the respective portion (e.g., a subset and/or the entirety) of the second input (e.g., 905h) is associated with the level of confidence corresponding to the input (e.g., 905h) (and/or corresponding to the subject matter) that is above the threshold (e.g., 0-100, 0%-100%, and/or 0.01-1 level of confidence) (and/or below a first threshold), the computer system forgoes increasing the size of the first user interface object. In some embodiments, in response to detecting the second input corresponding to the subject matter, in accordance with a determination that the respective portion (e.g., a subset and/or the entirety) of the second input (e.g., 905h) is associated with the level of confidence corresponding to the input (e.g., 905h) (and/or corresponding to the subject matter) that is below the threshold (e.g., 0-100, 0%-100%, and/or 0.01-1 level of confidence) (and/or below a first threshold), the computer system forgoes increasing the size of the first user interface object. Forgoing increasing the size of the first user interface object when a determination is made that the respective portion of the second input is associated with the level of confidence corresponding to the input that is above the threshold and forgoing increasing the size of the first user interface object when a determination is made that the respective portion of the second input is associated with the level of confidence corresponding to the input that is below the threshold allows the computer system to ensure a consistent user experience as it continues engaging with a user regarding a subject matter, thereby providing improved visual feedback to the user, reducing the number of inputs needed to perform an operation, and performing an operation when a set of conditions has been met without requiring further user input.

In some embodiments, while displaying, via the display component, a fourth interface object (e.g., text, a symbol, a button, a selectable user interface object, an image, a video, media, a chart, a drawing, a representation of a face, and/or an avatar) (e.g., concurrently while displayed the first user interface object), the computer system detects, via the one or more input (e.g., 905h) devices, a third input (e.g., 905h) (e.g., one or more words and/or sounds) (e.g., different from the input or the same as the input) corresponding to second subject matter (e.g., a topic, theme, content, idea, and/or field) (e.g., different from or the same as the subject matter). In some embodiments, in response to detecting the third input (e.g., 905h) corresponding to the second subject matter, in accordance with a determination that the third input (e.g., 905h) corresponds to (e.g., is about, concerns, and/or causes to be displayed) the fourth user interface object and the respective portion of the third input corresponding to the fourth user interface object is associated with a level of confidence corresponding to the portion of the third input that is above a second threshold (e.g., the same as the threshold or different from the threshold), the computer system increases the size of the fourth user interface object. In some embodiments, in response to detecting the third input corresponding to the second subject matter, in accordance with a determination that the third input (e.g., 905h) does not correspond to the fourth user interface object and the respective portion of the third input (e.g., 905h) corresponding to the fourth user interface object is associated with the level of confidence corresponding to the portion of the third input that is above the second threshold, the computer system forgoes increasing the size of the fourth user interface object (e.g., as described above at FIGS. 9H-9G).

In some embodiments, in accordance with a determination that the third input corresponds to the fourth user interface object and that the respective portion of the third input corresponding to the fourth user interface object is associated with a level of confidence corresponding to the portion of the third input that is below the second threshold, the computer system does not increase the size of the fourth user interface object. In some embodiments, in accordance with a determination that the third input does not correspond to the fourth user interface object and that the respective portion of the third input corresponding to the fourth user interface object is associated with the level of confidence corresponding to the portion of the third input that is below the second threshold, the computer system does not increase the size of the fourth user interface object. Increasing the size of the fourth user interface object when a determination is made that the third input corresponds to the fourth user interface object and the respective portion of the third input corresponding to the fourth user interface object is associated with a level of confidence corresponding to the portion of the third input that is above a second threshold allows the computer system to continually (1) increase user engagement and (2) improve accessibility by visually signaling its active engagement with the user regarding a one or more subject matters, thereby providing improved visual feedback to the user, reducing the number of inputs needed to perform an operation, and performing an operation when a set of conditions has been met without requiring further user input. Not increasing the size of the fourth user interface object when a determination is made that the third input does not correspond to the fourth user interface object and the respective portion of the third input corresponding to the fourth user interface object is associated with the level of confidence corresponding to the portion of the third input that is above the second threshold allows the computer system to (1) enhance user experience by maintaining the consistency of the fourth user interface object and (2) ensuring uninterrupted user engagement when feedback on the user's third input regarding a subject matter is not feasible, thereby providing improved visual feedback to the user, reducing the number of inputs needed to perform an operation, and performing an operation when a set of conditions has been met without requiring further user input.

Note that details of the processes described above with respect to process 1400 (e.g., FIG. 11) are also applicable in an analogous manner to the methods described below/above. For example, process 1000 optionally includes one or more of the characteristics of the various methods described above with reference to process 1400. For example, the computer system can use one or more techniques of process 1000 to group content using categories of content using one or more techniques of process 1400. For brevity, these details are not repeated below.

FIGS. 15A-15D illustrate exemplary user interfaces for displaying an overlay in accordance with some embodiments. The user interfaces in these figures are used to illustrate the processes described below, including the processes in FIG. 16.

FIGS. 15A-15D illustrate computer system 1500 displaying different user interfaces as a smart phone. It should be recognized that computer system 1500 can be other types of computer systems such as a tablet, a smart watch, a laptop, a communal device, a smart speaker, an accessory, a personal gaming system, a desktop computer, a fitness tracking device, and/or a head-mounted display (HMD) device. In some embodiments, computer system 1500 includes and/or is in communication with one or more sensors (e.g., one or more cameras, one or more LiDAR detectors, one or more motion sensors, one or more infrared sensors, and/or one or more microphones). In some embodiments, computer system 1500 includes and/or is in communication with one or more output devices (e.g., a display screen, a projector, a touch-sensitive display, and/a speaker). In some embodiments, computer system 1500 includes and/or is in communication with one or more movement components (e.g., an actuator, a moveable base, a rotatable component, and/or a rotatable base). In some embodiments, computer system 1500 includes one or more components and/or features described above in relation to computer system 100 and/or electronic device 200.

FIGS. 15A-15D illustrate a scenario where computer system 1500 displays an overlay on a media item and moves the overlay, such that the overlay does not occlude and/or is not displayed on top of certain objects in the media item. In the examples provided in FIGS. 15A-15D, computer system 1500 initiates playback of a previously recorded and/or generated video, where the overlay is not a part of the previously recorded video. Importantly, the previously recorded video is not being generated and/or dynamically created as the video is being played back. Thus, the computer system does not simply playback a video with an overlay that moves because the video includes the overlay moving within the video. Rather, computer system 1500 processes and analyzes a video (e.g., in real-time) and moves the overlay based on one or more determinations concerning objects within the video that are being presented. In some embodiments, computer system 1500 generates the video along with displaying the overlay. In some embodiments, computer system 1500 uses one or more techniques described below to display the overlay on other types of media, such as animations, gifs, live photos, and/or live feeds.

As illustrated in FIG. 15A, computer system 1500 displays user interface 1502, which includes avatar 1504. In some embodiments, avatar 1504 represents a digital and/or system assistant. In some embodiments, computer system 1500 updates avatar 1504 to indicate to the user that computer system 1500 is interacting with one or more users in the environment. For example, computer system 1500 can update avatar 1504, such that avatar 1504 appears to be looking at, looking away from, talking to, nodding at, and/or motioning to one or more users in the environment. In FIG. 15A, avatar 1504 is a face having one or more human characteristics. In some embodiments, avatar 1504 has a different appearance (e.g., different colors (e.g., sets of colors, flesh tones, reds, oranges, yellows, greens, blues, and/or purples), textures (e.g., skin, hair, fur, scales, plastic, glass, feathers, and/or wood), accessories (e.g., hat, glasses, monocle, wand, book, collar, bow, wings, halo, and/or crown), and/or face types (e.g., human, animal, anthropomorphized object, alien, non-descript face, fantasy creature, and/or a collection of objects that resemble a face)). At FIG. 15A, computer system 1500 detects verbal input 1505a (e.g., “Play the car video at example.com”).

As illustrated in FIG. 15B, in response to detecting verbal input 1505a, computer system 1500 retrieves the car video from example.com and displays video user interface 1506. While displaying video user interface 1506, computer system 1500 plays back the retrieved car video. At FIG. 15B, video user interface 1506 includes a frame of the car video, where the frame of the car video includes road object 1508 (e.g., a road) and grass object 1510 (e.g., a field of grass). Additionally, computer system 1500 has shrunk avatar 1504 from the size that it was at FIG. 15A to the size that it is displayed at FIG. 15B. At FIG. 15B, avatar 1504 is displayed in the top left corner of the car video and does not overlap with road object 1508 and grass object 1510. At FIG. 15B, computer system 1500 displays avatar 1504 in the top left corner of the car video because computer system 1500 has determined that the portion of the video in the top left corner is less important than road object 1508 and grass object 1510 (e.g., a less important portion of the video, a less interesting portion of the video, and/or a less relevant portion of the video to the subject matter of the video).

As illustrated in FIG. 15C, computer system 1500 displays car object 1512 (e.g., a car) as entering the video from the top left corner. While and/or before displaying car object 1512 entering the video from the top left corner, computer system 1500 makes a determination that avatar 1504 will occlude car object 1512 if avatar 1504 remained in the position of avatar 1504 at FIG. 15B. As illustrated in FIG. 15C, because of this determination, computer system 1500 moves avatar 1504 to the top right corner of the video, so that car object 1512 is not occluded within the car video. Here, computer system 1500 has determined that the portion of the video in the top right corner is less important and/or relevant to the car video than car object 1512. In some embodiments, a portion of the video is determined to be more important and/or relevant when a determination is made that one or more users should focus on a portion. In some embodiments, a determination is made that portions of the video that are moving and/or that are being interacted with are more important than other portions of the video.

As illustrated in FIG. 15D, computer system 1500 displays car object 1512 moved further to the right (e.g., the car travelled along the road in the video). In response to the change in position of car object 1512, computer system 1500 displays avatar 1504 in the middle of the bottom of video user interface 1506, which covers grass object 1510. Here, computer system 1500 deems grass object 1510 to be less important than car object 1512, which is why avatar 1504 is displayed on top of grass object 1510 instead of car object 1512.

It should be recognized that the example provided in FIGS. 15A-15D is merely an example and techniques described herein are different across different videos and/or visual media types. For example, computer system 1500 will move avatar 1504 differently while playing back different videos. In some embodiments, computer system 1500 will move avatar 1504 differently while playing back the same video (e.g., because computer system 1500 is processing the video in real-time).

In some embodiments, computer system 1500 can modify avatar 1504 based on the video being played back. In some embodiments, computer system 1500 changes the avatar to display different facial expression based on the video and/or changes the appearance of the avatar, such as changing color and/or size of avatar 1504. For example, if a displayed video is a comedy routine, computer system 1500 change the appearance of avatar 1504 such that avatar 1504 appears to be laughing. As another example, if a frame of the video is a dark blue color, computer system 1500 can change the appearance of avatar such that the avatar is a color that can be seen easier on top of the dark blue color.

In some embodiments, avatar 1504 can change based on a user. For example, if computer system 1500 detects that a user is sad, computer system 1500 can change the appearance of avatar 1504, such that avatar 1504 appears to be empathetic while playing back a video. In another instance, if computer system 1500 detects that a user has moved, computer system 1500 can move avatar 1504 to match the position of the user. In another instance, avatar 1504 can change between users (e.g., through preconfigured settings and/or via user input). In some embodiments, avatar 1504 can change based on the detected physical environment. For example, if computer system 1500 detects that a user is in a brighter environment, computer system 1500 can adjust the tone of avatar 1504.

FIG. 16 is a flow diagram illustrating a method for displaying an overlay using a computer system in accordance with some embodiments. Process 1600 is performed at a computer system (e.g., 100, 200, and/or 1500). Some operations in process 1600 are, optionally, combined, the orders of some operations are, optionally, changed, and some operations are, optionally, omitted.

As described below, process 1600 provides an intuitive way for displaying an overlay. The method reduces the cognitive burden on a user for displaying an overlay, thereby creating a more efficient human-machine interface. For battery operated computing devices, enabling a user to display an overlay faster and more efficiently conserves power and increases the time between battery charges.

In some embodiments, process 1600 is performed at a computer system (e.g., 1500) that is in communication with a display component (e.g., a display screen, a projector, and/or a touch-sensitive display) and one or more input devices (e.g., a camera, a depth sensor, and/or a microphone). In some embodiments, the computer system is a watch, a phone, a tablet, a fitness tracking device, a processor, a head-mounted display (HMD) device, a communal device, a media device, a speaker, a television, and/or a personal computing device. In some embodiments, the computer system is in communication with one or more output devices (e.g., a display component, an audio generation component (e.g., smart speaker, home theater system, soundbar, headphone, earphone, earbud, speaker, television speaker, augmented reality headset speaker, audio jack, optical audio output, Bluetooth audio output, HDMI audio output, and/or audio sensor), a speaker, a haptic output device, a display screen, a projector, and/or a touch-sensitive display). In some embodiments, the computer system is in communication with a movement component (e.g., an actuator (e.g., a pneumatic actuator, hydraulic actuator, and/or an electric actuator), a movable base, a rotatable component, and/or a rotatable base).

The computer system detects (1602), via the one or more input devices, a request (e.g., an input (e.g., a tap input and/or a non-tap input (e.g., a verbal input, an audible request, an audible command, an audible statement, a swipe input, a hold-and-drag input, a gaze input, an air gesture, and/or a mouse click)) directed to a user interface object and/or a selection of a representation of a media item) to display an animation (e.g., 1505a) (e.g., multiple frames and/or images, a video, and/or one or more moving user-interface elements) (e.g., as described above with respect to FIG. 15A).

In response to detecting the request to display the animation (e.g., 1505a), the computer system initiates (1604) (e.g., causes and/or starts), via the display component, playback of (and/or the computer system displays at least a portion of) the animation (e.g., 1506, 1508, and/or 1510) (e.g., as described above with respect to FIGS. 15A-15B).

While playing back (and/or displaying) the animation (e.g., 1506, 1508, and/or 1510) and displaying, via the display component, an overlay (e.g., 1504) (e.g., a user interface object, a user-interface element, a representation of a software application, an avatar, a system avatar, a menu, and/or a button) at a first location (e.g., location of 1504 at FIG. 15B) (e.g., overlaid or not overlaid on the animation), the computer system detects (1606) that an object (e.g., 1506) (e.g., a user-interface element, a portion of the animation, a representation of a car, a representation of a user, and/or text) (e.g., a first object) in the animation will be displayed within a distance of (e.g., zero or more pixels, centimeters, and/or inches from) the first location while displaying a first frame (e.g., 1506, 1508, and/or 1510 at FIG. 15B) (e.g., a current frame or a future frame) of the animation (e.g., as described above with respect to FIG. 15B). In some embodiments, the overlay is displayed above and/or over the animation.

In response to detecting that the object (e.g., 1506) in the animation (e.g., 1506, 1508, and 1510) will be displayed within the distance of the first location (e.g., location of 1504 at FIG. 15B) while displaying the first frame (e.g., 1506, 1508, and 1510 at FIG. 15B) of the animation, the computer system displays (1608), via the display component, the overlay (e.g., 1504) at a second location (e.g., location of 1504 at FIG. 15C) (e.g., inside a frame of the animation and/or outside of a frame of the animation) different from the first location (e.g., before, after, and/or when the first frame of the animation is displayed), wherein the second location was selected (e.g., established, generated, determined, and/or found) after initiating playback of the animation (e.g., as described above with respect to FIGS. 15B-15C). In some embodiments, detecting that the object in the animation will be displayed within the distance of the location includes a determination that the object is at a third location moving towards the first location. In some embodiments, in response to detecting that the object in the animation will not be displayed within the distance of the first location while displaying the first frame of the animation, the computer system does not display the overlay at the second location (and/or the computer system maintains the overlay at the first location). In some embodiments, the computer system moves concurrently with moving the overlay. Moving display of the overlay to a second location in response to detecting that the object in the animation will be displayed within the distance of the first location while displaying the first frame of the animation enables the computer system to playback the animation while displaying the overlay without obstructing the view of the object with the overlay, thereby performing an operation when a set of conditions has been met without requiring further user input, reducing the number of inputs needed to perform an operation, and/or providing improved visual feedback to the user.

In some embodiments, the overlay (e.g., 1504) includes (and/or is) a representation of a face (e.g., as described above with respect to FIGS. 15A-15D). In some embodiments, the face is of a character and/or a system avatar. In some embodiments, the character is an entity exhibiting various movement patterns. In some embodiments, the representation of the face includes one or more eyes, a mouth, and/or a nose. In some embodiments, the overlay includes a representation of a body (e.g., one or more hands, one or more feet, one or more arms, one or more legs, and/or a torso).

In some embodiments, before initiating playback of the animation (e.g., 1506, 1508 and/or 1510) (and/or before displaying, via the display component, the animation), the computer system displays, via the display component, (e.g., initiates displaying) the overlay (e.g., 1504) (e.g., as described above with respect to FIG. 15A). In some embodiments, the computer system continues displaying the overlay from before initiating playback of the animation to after initiating playback of the animation. In some embodiments, the computer system displays the overlay before a user interface element corresponding to the animation is displayed. In some embodiments, the computer system displays the overlay without displaying a user interface element corresponding to the animation. Displaying the overlay before initiating playback of the animation enables the computer system to provide the overlay in circumstances other than playing back the animation to allow a user to interact with the overlay irrespective of whether the animation is playing back, thereby reducing the number of inputs needed to perform an operation and/or providing improved visual feedback to the user.

In some embodiments, while playing back the animation (e.g., 1506, 1508 and/or 1510), the computer system displays, via the display component, the overlay (e.g., 1504), at a third location (e.g., location of 1504 at FIGS. 15B-15D) (e.g., the first location, the second location, or another location different from the first location and the second location), with: in accordance with a determination that a second frame (e.g., 1506, 1508, and 1510 at FIG. 15B-15D) of the animation includes first content (e.g., a first type of content and/or content that includes particular content), a first appearance (e.g., appearance of 1504 at FIGS. 15B-15D) (e.g., a user interface element, a user interface object, a color, a size, a location of one or more user interface elements and/or objects, and/or an orientation) (e.g., as described above with respect to FIGS. 15B-15D); and in accordance with a determination that the second frame (e.g., 1506, 1508, and 1510 at FIGS. 15B-15D) of the animation includes second content different from the first content, a second appearance different than the first appearance (e.g., as described above with respect to FIGS. 15B-15D). In some embodiments, the determination that the second frame of the animation includes respective content (e.g., the first content and/or the second content) is based on detecting, via the one or more input devices (e.g., a camera and/or a microphone), the respective state of the user in the environment. In some embodiments, the overlay includes a representation of a face. In some embodiments, the first appearance is a first facial expression of the representation of the face. In some embodiments, the second appearance is a second facial expression of the representation of the face. In some embodiments, the second facial expression is different from the first facial expression. In some embodiments, an appearance of the overlay is based on content (e.g., current and/or future content) of the animation. In some embodiments, an appearance of the overlay changes based on content (e.g., current and/or future content) of the animation. In some embodiments, an appearance of the overlay is in accordance with content (e.g., current and/or future content) of the animation. Displaying the overlay, while playing back the animation, at the third location with the first appearance in accordance with the determination that the second frame of the animation includes first content, and the second appearance in accordance with the determination that the second frame of the animation includes second content enables the computer system to automatically change the appearance of an overlay when the animation includes certain content, thereby performing an operation when the set of conditions has been met without requiring further user input, reducing the number of inputs needed to perform an operation, and/or providing improved visual feedback to the user.

In some embodiments, while playing back the animation (e.g., 1506, 1508, and/or 1510), the computer system displays, via the display component, the overlay (e.g., 1504), at a fourth location (e.g., location of 1504 at FIGS. 15B-15D) (e.g., the first location, the second location, or another location different from the first location and the second location), with: in accordance with a determination that a user in a first environment (e.g., a physical or a virtual environment) is in a first state (e.g., a physical position (e.g., location or orientation), a body position, performing an activity, and/or within a threshold distance of an object (e.g., the computer system or another object different from the computer system)), a third appearance (e.g., as described above with respect to FIGS. 15B-15D); and in accordance with a determination that the user in the first environment is in a second state different from the first state, a fourth appearance different from the third appearance (e.g., as described above with respect to FIGS. 15B-15D). In some embodiments, the determination that the user in the first environment is in a respective state (e.g., the first state and/or the second state) is based on detecting, via the one or more input devices (e.g., a camera and/or a microphone), the respective state of the user in the first environment. In some embodiments, the third appearance is a third facial expression of the representation of the face. In some embodiments, the fourth appearance is a fourth facial expression of the representation of the face. In some embodiments, the fourth facial expression is different from the third facial expression. In some embodiments, an appearance of the overlay is based on the user in the first environment. In some embodiments, an appearance of the overlay changes based on the user in the first environment. In some embodiments, an appearance of the overlay is in accordance with the user in the first environment. Displaying the overlay, while playing back the animation, at the fourth location with the third appearance in accordance with the determination that the user in the first environment is in the first state, and the fourth appearance in accordance with the determination that the user in the first environment is in the second state, enables the computer system to automatically change the appearance of an overlay based on a state of the user, thereby performing an operation when a set of conditions has been met without requiring further user input, reducing the number of inputs needed to perform an operation, and/or providing improved visual feedback to the user.

In some embodiments, while playing back the animation (e.g., 1506, 1508, and/or 1510), the computer system displays, via the display component, the overlay (e.g., 1504), at a fifth location (e.g., the first location, the second location, or another location different from the first location and the second location), with: in accordance with a determination that a second environment is in a first state (and/or a first condition) (e.g., an amount of light, a temperature, and/or a time of day), a fifth appearance (e.g., a first color and/or orientation) (e.g., as described above with respect to FIGS. 15B-15D); and in accordance with a determination that the second environment is in a second state different from the first state, a sixth appearance different from the fifth appearance (e.g., as described above with respect to FIGS. 15B-15D). In some embodiments, the determination that the second environment is in a respective state (e.g., the first state and/or the second state) is based on detecting, via one or more sensors (e.g., in communication with the computer system) (e.g., a camera, a microphone, a thermometer, a gyroscope, and/or a humidity sensor), the respective state of the second environment. In some embodiments, the fifth appearance is a fifth facial expression of the representation of the face. In some embodiments, the sixth appearance is a sixth facial expression of the representation of the face. In some embodiments, the sixth facial expression is different from the fifth facial expression. In some embodiments, an appearance of the overlay is based on a condition and/or state of the second environment. In some embodiments, an appearance of the overlay changes based on a condition and/or state of the second environment. In some embodiments, an appearance of the overlay is in accordance with a condition and/or state of the second environment. Displaying the overlay, while playing back the animation, at the fifth location with a fifth appearance in accordance with the determination that the second environment is in the first state, and with a sixth appearance in accordance with the determination that the second environment is in the second state, enables the computer system to display different overlays based on a state of an environment, thereby performing an operation when a set of conditions has been met without requiring further user input, reducing the number of inputs needed to perform an operation, and/or providing improved visual feedback to the user.

In some embodiments, the distance is a first distance. In some embodiments, while playing back the animation (e.g., 1506, 1508, and/or 1510), after displaying the overlay (e.g., 1504) at the second location, and while displaying the overlay at a sixth location, the computer system detects that a second object (e.g., 1506) (e.g., the object and/or another object different from the object) in the animation will be displayed within a second distance of the sixth location while displaying a third frame, different from the first frame and the second frame, of the animation (e.g., as described above with respect to FIGS. 15B-15C). In some embodiments, the sixth location is different from the first location. In some embodiments, in response to detecting that the second object (e.g., 1506) in the animation will be displayed within the second distance of the sixth location while displaying the third frame of the animation (e.g., 1506, 1508, and 1510 at FIG. 15D), the computer system displays, via the display component, the overlay (e.g., 1504) at a seventh location different from the sixth location (e.g., as described above with respect to FIGS. 15C-15D) (and/or the first location, the second location, the third location, the fourth location, and/or the fifth location). Moving display of the overlay to the seventh location in response to detecting that the second object in the animation will be displayed within the second distance of the sixth location while displaying the third frame of the animation enables the computer system to playback the animation while displaying the overlay without obstructing the view of the object with the overlay, thereby performing an operation when a set of conditions has been met without requiring further user input, reducing the number of inputs needed to perform an operation, and/or providing improved visual feedback to the user.

In some embodiments, while playing back the animation (e.g., 1506, 1508, and/or 1510) and displaying the overlay (e.g., 1504), in accordance with a determination that the animation (e.g., 1506, 1508, and/or 1510) includes third content (e.g., a second type of content and/or content that includes particular content) (e.g., a media) (and/or that the overlay needs to move to avoid obstructing a portion (e.g., an object and/or a physics element (e.g., wind and/or rain)) of the third content), the computer system performs a first set of one or more operations to move the overlay (e.g., 1504) to an eleventh location (e.g., different from the first location (and/or the second location)) (e.g., as described above with respect to FIGS. 15B-15D). In some embodiments, while playing back the animation and displaying the overlay, in accordance with a determination that the animation (e.g., location of 1504 at FIGS. 15C-15D) includes fourth content (and/or that the overlay needs to move to avoid obstructing a portion (e.g., an object and/or a physics element (e.g., wind and/or rain)) of the fourth content), different from the third content (e.g., a third type of content different from the second type of content and/or content that includes particular content), the computer system performs a second set of one or more operations to move the overlay to the eleventh location, wherein the second set of one or more operations are different from the first set of one or more operations (e.g., a visual path corresponding to the second set of one or more operations is different from a visual path corresponding to the first set of one or more operations) (e.g., a speed and/or acceleration of movement corresponding to the second set of one or more operations is different from a speed and/or acceleration of movement corresponding to the first set of one or more operations) (e.g., as described above with respect to FIGS. 15B-15D). Performing the first set of one or more operations to move the overlay to the eleventh location in accordance with the determination that the animation includes third content and performing the second set of one or more operations to move the overlay to the eleventh location in accordance with the determination that the animation includes fourth content enables the computer system to move objects differently based on the content of the animation, thereby performing an operation when a set of conditions has been met without requiring further user input, reducing the number of inputs needed to perform an operation, and/or providing improved visual feedback to the user.

In some embodiments, the animation (e.g., 1506, 1508, and/or 1510) includes (and/or is) a video (e.g., as described above with respect to FIGS. 15B-15D). Moving display of the overlay to a second location in response to detecting that the object in the animation will be displayed within the distance of the first location while displaying the first frame of the animation that includes a video enables the computer system to place the overlay without obstructing the view of the object in the video with the overlay, thereby performing an operation when a set of conditions has been met without requiring further user input, reducing the number of inputs needed to perform an operation, and/or providing improved visual feedback to the user.

In some embodiments, the animation (e.g., 1506, 1508. and/or 1510) includes (and/or is) previously recorded content (e.g., content recorded before detecting the request to display the animation) (e.g., as described above with respect to FIGS. 15B-15D). In some embodiments, the previously recorded content is content recorded on the computer system. In some embodiments, the computer system analyzes the location of the object in the previously recorded content rather than placing the overlay on static content and/or dynamically generated content. In some embodiments, where the previously recorded content was recorded on the computer system, the content is not pre-programmed with identifications of the content so the computer system analyzes the location of the object to place the overlay. Moving display of the overlay to a second location in response to detecting that the object in the animation will be displayed within the distance of the first location while displaying the first frame of the animation that includes previously recorded content enables the computer system to place the overlay without obstructing the view of one or more objects in the previously recorded video content, thereby performing an operation when a set of conditions has been met without requiring further user input, reducing the number of inputs needed to perform an operation, and/or providing improved visual feedback to the user.

In some embodiments, the animation (e.g., 1506, 1508, and/or 1510) is generated before detecting the request to display the animation (e.g., 1505a) (e.g., as described above with respect to FIGS. 15B-15D). In some embodiments, before detecting the request to display the animation, the computer system generates (e.g., records, receives, processes, and/or creates) the previously recorded content. In some embodiments, the animation is generated in response to and/or after detecting the request to display the animation. In some embodiments, the animation is not dynamically generated. In some embodiments, the animation is dynamically generated. In some embodiments, the computer system does not generate the animation (e.g., the animation is not generated by the computer system). Moving display of the overlay to a second location in response to detecting that the object in the animation will be displayed within the distance of the first location while displaying the first frame of the animation that is generated before detecting the request to display the animation enables the computer system to place the overlay without obstructing the view of the object in the animation that was generated, thereby performing an operation when a set of conditions has been met without requiring further user input, reducing the number of inputs needed to perform an operation, and/or providing improved visual feedback to the user.

In some embodiments, the animation (e.g., 1506, 1508, and/or 1510) is a first animation. In some embodiments, the computer system detects, via the one or more input devices, a request to display a second animation different from the first animation. In some embodiments, in response to detecting the request to display the second animation, the computer system initiates, via the one or more output devices, playback of the second animation. In some embodiments, while playing back the second animation and displaying, via the display component, the overlay (e.g., 1504) (e.g., at an eighth location (e.g., different from the first location, the second location, and/or another location different from the first location and the second location)), in accordance with a determination that the second animation (and/or an animation different from the second animation) is a first type of animation (e.g., a movie type animation, a television type animation, and/or a comic type animation) (e.g., and/or in response to detecting that an object in the second animation will be displayed within a third distance of a ninth location different from the eighth location (and/or different from the first location and/or the second location) while displaying a first frame of the second animation), the computer system moves, via the display component, the overlay (e.g., 1504) to a new location (e.g., the computer system displays the overlay at a tenth location (e.g., inside a frame of the second animation and/or outside of a frame of the second animation) different from the eighth location (e.g., before, after, and/or when the first frame of the animation is displayed)) (e.g., as described above with respect to FIGS. 15B-15D). In some embodiments, while playing back the second animation and displaying, via the display component, the overlay, in accordance with a determination that the second animation is a second type of animation different from the first type of animation (and/or detecting that the second object in the second animation will be displayed within the third distance of the ninth location while displaying the first frame of the second animation), the computer system forgoes moving, via the display component, the overlay to the new location (e.g., as described above with respect to FIGS. 15B-15D) (e.g., the computer system does not display the overlay at the tenth location). In some embodiments, while playing back the second animation, displaying, via the display component, the overlay, and in accordance with a determination that the second animation is the second type of animation and that the second object in the second animation will be displayed within the third distance of the ninth location while displaying the first frame of the second animation, the computer system maintains a current location of the overlay (e.g., does not move the overlay based on content of the animation when the animation is the second type of animation). Moving the overlay to a new location in accordance with the determination that the second animation is the first type of animation and forgoing moving the overlay to the new location in accordance with the determination that the second animation is the second type of animation enables the computer system to move the overlay for specific types of animations and not other types of animations, thereby performing an operation when a set of conditions has been met without requiring further user input, reducing the number of inputs needed to perform an operation, and/or providing improved visual feedback to the user

In some embodiments, the computer system (e.g., 1500) does not detect an input (e.g., 1505a) (e.g., an input (e.g., a tap input and/or a non-tap input (e.g., a verbal input, an audible request, an audible command, an audible statement, a swipe input, a hold-and-drag input, a gaze input, an air gesture, and/or a mouse click)) directed to a user interface object and/or a selection of a representation of a media item) while playing back the animation (e.g., 1506, 1508, and/or 1510) (e.g., as described above with respect to FIGS. 15A-15D).

The description above has been described with reference to specific examples for the purpose of explanation. Such specific examples can be in the form of textual description above and/or in the accompanying drawings. However, such examples should not be interpreted as being exhaustive or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

What is claimed is:

1. A method, comprising:
at a computer system that is in communication with one or more input devices and one or more output devices:
detecting, via the one or more input devices, an input corresponding to a request to review one or more previous interactions with an agent; and
in response to detecting the input corresponding to the request to review one or more previous interactions with the agent:
in accordance with a determination that a first set of one or more criteria is satisfied, outputting, via the one or more output devices, a first representation of a first previous interaction with the agent; and
in accordance with a determination that a second set of one or more criteria is satisfied, forgoing outputting, via the one or more output devices, the first representation of the first previous interaction with the agent.

2. The method of claim 1, wherein the agent is a virtual assistant.

3. The method of claim 1, wherein a first portion of the agent is executing on the computer system, wherein a second portion of the agent is executing on another computer system different from the computer system, and wherein the second portion is different from the first portion.

4. The method of claim 3, wherein the agent is configured to use a large language model (LLM) to provide output.

5. The method of claim 1, further comprising:
in response to detecting the input corresponding to the request to review one or more previous interactions with the agent and in accordance with a determination that the first set of one or more criteria is satisfied, outputting, via the one or more output devices, a second representation of a second previous interaction with the agent, wherein the second representation is different from the first representation.

6. The method of claim 5, wherein the first representation corresponds to a first type of content, and wherein the second representation corresponds to a second type of content different from the first type of content.

7. The method of claim 1, wherein the first representation corresponds to a first application, and wherein the second representation corresponds to a second application different from the first application.

8. The method of claim 1, wherein the first representation corresponds to a first media item, and wherein the second representation corresponds to a second media item different from the first media item.

9. The method of claim 1, further comprising:
in response to detecting the input corresponding to the request to review one or more previous interactions with the agent and in accordance with a determination that the first set of one or more criteria is satisfied, outputting, via the one or more output devices, a third representation of a third previous interaction with the agent, wherein the third representation is different from the first representation and the second representation, wherein the second representation is visually grouped with the first representation, wherein the second representation is not visually grouped with the third representation, and wherein the third representation is not visually grouped with the first representation.

10. The method of claim 1, wherein at least a portion of content of the first representation was not included in the first previous interaction.

11. The method of claim 1, wherein the first previous interaction is from a conversation with the agent.

12. The method of claim 1, wherein the first representation includes a suggestion provided by the agent during the first previous interaction.

13. The method of claim 1, wherein the first previous interaction includes a natural language input from a user.

14. The method of claim 1, wherein the first representation includes a visual input provided during the first previous interaction.

15. The method of claim 1, wherein the first representation includes a graphical image.

16. The method of claim 1, wherein the first representation includes text from the first previous interaction.

17. The method of claim 1, wherein the first representation includes a summary of the first previous interaction, and wherein the summary was not provided during the first previous interaction.

18. The method of claim 1, further comprising:
while outputting, via the one or more output devices, the first representation of the first previous interaction, detecting, via the input device, an input corresponding to selection of the first representation; and
in response to detecting the input corresponding to selection of the first representation, outputting, via the one or more output devices, additional content corresponding to the first previous interaction.

19. The method of claim 1, wherein the input corresponding to the request to review one or more previous interactions with the agent is an implicit request to review one or more previous interactions with the agent.

20. The method of claim 1, wherein the input corresponding to the request to review one or more previous interactions with the agent is an explicit request to review one or more previous interactions with the agent.

21. The method of claim 1, wherein the input corresponding to the request to review one or more previous interactions with the agent includes an indication of time, and wherein the first set of one or more criteria includes a criterion that is satisfied when the first previous interaction corresponding to the indication of time.

22. The method of claim 1, wherein the input corresponding to the request to review one or more previous interactions with the agent includes an indication of a topic, and wherein the first set of one or more criteria includes a criterion that is satisfied when the first previous interaction includes content corresponding to the topic.

23. A non-transitory computer-readable storage medium storing one or more programs configured to be executed by one or more processors of a computer system that is in communication with one or more input devices and one or more output devices, the one or more programs including instructions for:
detecting, via the one or more input devices, an input corresponding to a request to review one or more previous interactions with an agent; and
in response to detecting the input corresponding to the request to review one or more previous interactions with the agent:
in accordance with a determination that a first set of one or more criteria is satisfied, outputting, via the one or more output devices, a first representation of a first previous interaction with the agent; and
in accordance with a determination that a second set of one or more criteria is satisfied, forgoing outputting, via the one or more output devices, the first representation of the first previous interaction with the agent.

24. A computer system that is in communication with one or more input devices and one or more output devices, the computer system comprising:
one or more processors; and
memory storing one or more programs configured to be executed by the one or more processors, the one or more programs including instructions for:
detecting, via the one or more input devices, an input corresponding to a request to review one or more previous interactions with an agent; and
in response to detecting the input corresponding to the request to review one or more previous interactions with the agent:
in accordance with a determination that a first set of one or more criteria is satisfied, outputting, via the one or more output devices, a first representation of a first previous interaction with the agent; and
in accordance with a determination that a second set of one or more criteria is satisfied, forgoing outputting, via the one or more output devices, the first representation of the first previous interaction with the agent.
